SEQUENCE LISTING (6 sequences)

SEQ ID NO: 1 - DNA, 20 bp, Artificial
  DNA hairpin used in antibody experiments as a control.
gtcgaacgttttcgttcgac

SEQ ID NO: 2 - DNA, 22 bp, Artificial
  DNA hairpin used in antibody experiments as a control.
tttcgaacgttttcgttcgaaa

SEQ ID NO: 3 - DNA, 22 bp, Artificial
  DNA hairpin used in antibody experiments as a control.
gttcgaacgttttcgttcgaac

SEQ ID NO: 4 - DNA, 22 bp, Artificial
  DNA hairpin used in antibody experiments as a control.
cttcgaacgttttcgttcgaag

SEQ ID NO: 5 - DNA, 22 bp, Artificial
  DNA hairpin used in antibody experiments as a control.
attcgaacgttttcgttcgaat

SEQ ID NO: 6 - protein, 8 aa, Artificial
  Synthetic peptide to which the antibodies may be represented.
EYYEYEEY

(19) United States
(12) Patent Application Publication
(10) Pub. No.: US 2013/0071837 A1
(43) Pub. Date: Mar. 21, 2013

(54) Method and System for Characterizing or Identifying Molecules and Molecular Mixtures

(71) Applicants: Stephen N. Winters-Hilt, Mandeville, LA (US); Robert L. Adelman, Santa Cruz, CA (US)

(72) Inventors: Stephen N. Winters-Hilt, Mandeville, LA (US); Robert L. Adelman, Santa Cruz, CA (US)

(21) Appl. No.: 12/855,635

(22) Filed: Aug. 12, 2010

Related U.S. Application Data
(63) Continuation-in-part of application No. 11/576,723, filed on Apr. 5, 2007.
(60) Provisional application No. 60/616,274, filed on Oct. 6, 2004.
(60) Provisional application No. 60/616,275, filed on Oct. 6, 2004.
(60) Provisional application No. 60/616,276, filed on Oct. 6, 2004.
(60) Provisional application No. 60/616,277, filed on Oct. 6, 2004.

(51) Int. Cl. G01N 27/26

(52) U.S. Cl. CPC G01N 27/26; B82Y 15/00
USPC 435/6.11; 435/287.2; 435/6.1; 702/27; 977/932

(57) ABSTRACT

A system and method for identifying a material passing through a nanopore filter wherein an electrical signal is detected as a result of the passage and that signal is processed in real-time using mathematical and statistical tools to identify the molecule. A carrier molecule is preferably attached to one or more molecule(s) under consideration using a non-covalent bond and the pore in the nanopore filter is sized so that the molecule rattles around in the pore before being discharged without passing through the filter pore. The present invention includes not only a method and system for identifying the molecule(s) under consideration but also a kit for setting up the filter as well as mathematical tools for analyzing the signals from the sensing circuitry for the molecule(s) under consideration.

### CROSS REFERENCE TO RELATED PATENTS

The present invention is related to the following patents:

The present invention is a continuation-in-part of parent U.S. patent application Ser. No. 11/576,723 filed Apr. 5, 2007 for “Channel Current Cheminformatics and Bioengineering Antibody Characterization and Antibody-Antigen Efficacy Screening”, published as US 2009/0054919 A2 on Feb. 26, 2009. This patent, which is sometimes called the “Parent Patent” in this document, claims priority to PCT patent application Serial Number PCT/US05/35933 filed Oct. 6, 2005 and provisional patent application Ser. Nos. 60/616,274, 60/616,275, 60/616,276 and 60/616,277, all of which provisional patent applications were filed Oct. 6, 2004.

The present patent also claims the benefit of provisional patent applications:

Ser. No. 61/233,721 filed Aug. 13, 2009 for “Post-Translational Protein Modification Assaying and Transient Complex Characterization”, sometimes referred to herein as the “First Provisional Patent” or the “CPGA Patent”;

Ser. No. 61/233,728 filed Aug. 13, 2009 for “Biosensing Processes with Substrates, Both Immobilized (Immuno-Absorbant Matrices) and Free (Enzyme Substrate): Transducer Efficient Self-Tuning Explicit and Adaptive HMM with Duration Algorithm”, sometimes referenced herein as the “Second Provisional Patent” or the “TERISA Patent”.

Ser. No. 61/233,732 filed Aug. 13, 2009 entitled “A Hidden Markov Model with Binned Duration Algorithm” and refilled as Ser. No. 61/234,885 on Aug. 18, 2009 for “Efficient Self-Tuning Explicit and Adaptive HMM with Duration Algorithm”, sometimes referred to herein as the “Third Provisional Patent” or the “HMMBD Patent”.

Ser. No. 61/097,709 filed Sep. 29, 2009 for “Nanopore Transduction Detection based Methods for: (I) electrophoresis-separation based on nanopore acquisition rate and . . .”, sometimes referred to herein as the “Fourth Provisional Patent” or the “NTD-add Patent”.

Ser. No. 61/097,712 filed Sep. 29, 2009 for “Pattern Recognition Informed Nanopore Detection for Sample Boosting”, sometimes referred to herein as the “Fifth Provisional Patent” or the “PRI Patent”.

Ser. No. 61/302,678 filed Feb. 9, 2010 for “Hidden Markov Model Based Structure Identification using (I) HMM-with-duration with positionally dependent emissions and Incorporation of Side-Information into an HMMD via the Ratio of Cumulants Method”, sometimes referred to herein as the “Sixth Provisional Patent” or the “Meta-HMM Patent”.

Ser. No. 61/302,693 filed Feb. 9, 2010 for “Nanopore Transduction of DNA Sequencing via Simultaneous, Single Molecule Discrimination of dsDNA Terminus Identification and dsDNA Strand Length . . .”, sometimes referred to herein as the “Seventh Provisional Patent” or the “NTD-end length Patent”.

Ser. No. 61/302,688 filed Feb. 9, 2010 for “Nanopore Transduction of DNA Sequence Information Using Enzymes Covalently Bound to Channel Modulators”, sometimes referred to herein as the “Eighth Provisional Patent” or the “NTD-Enzyme Patent”.

The specifications and drawings for each of the patents and applications listed above are specifically incorporated herein by reference. Applicants claim the benefit herein of each of these patents and patent applications listed above under the provisions of Title 35 of the United States Code, especially sections 119-121, as appropriate.

### RIGHTS IN THE INVENTION

Portions of the inventions described in this patent application may have been made with United States Government funding under grants from DARPA, DOE and/or other United States government agencies. To the extent that the inventions claimed in this patent have been funded by the United States Government, the United States Government may have certain rights in those inventions.

### TERMINOLOGY

The present patent application uses the terms “channel” and “pore” synonymously unless the context requires or suggests a different interpretation. The present patent also uses the term “conductive medium” as describing a fluid which is capable of conducting an ionic flow.

### SEQUENCE LISTINGS

A sequence listing which lists the sequences identified by Sequence ID Number, corresponding to the Sequence Number used herein, accompanies this disclosure and is incorporated herein by reference.

### BACKGROUND OF THE INVENTION

1. Field of Invention

The present invention relates to the use of a nanopore filter and a nanopore transduction detection platform for the purpose of identifying specific molecules and/or molecular mixtures and sensing one or more characteristics of those molecules and/or mixtures using sensing circuitry, with application in biotechnology, immunology, biodefense, DNA sequencing, and drug discovery. The present invention includes a kit for making a system for the detection of such molecules and/or mixtures. The present invention includes improved mathematical and statistical tools, and their implementations, for analyzing the signals from the sensing circuitry.

2. Background Art

Others have suggested using a nanopore filter (or channel detection device) to detect one or more molecules of interest through unique signals on a nanopore blockage current. One example of such systems has been referred to as a Coulter Counter, and the Coulter Counter has been used to count pulses to measure the bacterial cells passing through the aperture using hydrostatic pressure.

Often the molecule of interest in a channel detection device of the prior art systems is attached to another molecule (a carrier molecule) through a chemical bond. The carrier molecule and the molecule to which it is attached then are sensed as they pass together as a single unit through a channel or pore in a filter system.

Some of the detection systems in the prior art involve using a pore or channel which is large enough to allow the molecule of interest and a carrier molecule to pass completely through the pore and measure signals as a result of that passage, with the passage through the pore being referred to as a translocation. Such translocations often occur very quickly and do not provide signal with enough information to indicate the structure of the molecules translocating.

Molecules passing through a passage often go through quickly or at a rate which is not easily controlled. Further, the characteristics of a molecule may be difficult to determine if the molecule goes through quickly or in a random orientation.

Accordingly, the prior art systems for detecting molecules in a nanopore transducer or filter arrangement have disadvantages and limitations. It is desirable to overcome (in the present invention) at least some of these disadvantages and limitations in sensing molecules involved with a nanopore transducer and to sense the presence of a molecule (or a series of molecules) by having a transducer molecule captured in the nanopore, exhibiting molecular dynamics which include transient chemical bonds to the nanopore channel, generating an electrical signal with stationary statistics which contains information on the disposition of the molecule being analyzed, before being discharged without, necessarily (or typically), passing through the filter.

Further, it is often difficult for a user to set up a nanopore transducer by assembling the right parts to create an electrical signal which can be captured and analyzed. Once the nanopore detection system creates a signal indicating that a molecule of interest has been sensed, it is difficult to analyze the signal and determine the characteristics of the molecule. This is particularly true when the molecules of interest are closely related or have similar characteristics (as is often the case with portions of a duplex DNA molecule).

Other disadvantages of the prior art systems will become apparent to those of ordinary skill in the art as well as advantages of the present invention in view of the following detailed description of the preferred embodiments and the best mode of carrying out the present invention.

Some prior art system for sensing and identifying molecules have covalently bonded a molecule in or around the molecule(s) under consideration to the channel, or used a fixed molecular construction, to the channel, to amplify or create a differential signal between molecules of interest.

However, all the prior art systems have limitations and/or disadvantages, making them each undesirable for accomplishing the sensing and identification of molecules and molecular mixtures.

### BRIEF DESCRIPTION OF THE DRAWINGS

FIG. 1.A. (a) The channel current blockade signals observed when selected DNA hairpins are disposed within the channel. The left panel shows five selected or illustrative DNA hairpins, with sample blockades, that were used to test the sensitivity of the nanopore device. The top right panel shows the power spectral density for signals obtained. The bottom right panel shows the dominant blockades, and their frequencies, for the different hairpin molecules. FIG. 1.A (b) is a graph showing the single-species classification prediction accuracy as the number of signal classification attempts increases (allowing increase in the rejection threshold). FIG. 1.A (c) is a graph showing the prediction accuracy on 3:1 mixture of 9TA to 9GC DNA hairpins.

FIG. 1.B. Open channel with carrier reference—that has no specific interaction with targets of interest, just a general interaction with environmental parameters, denoted as the black oval.

FIG. 1.C. A schematic for the U-tube, aperture, bilayer, and single channel, with possible S-layer modifications to the bi-layer.

FIG. 1.D. Translocation Information and Transduction Information. FIG. 1.D Left. Shows an Open Channel and a representative resultant electrical signal below. FIG. 1.D Center. Shows a channel blockade event with feature extraction that is typically dwell-time based and its representative resultant electrical signal below. This may represent a Single-molecule coulter counter. FIG. 1.D Right. Illustrates a single-molecule transduction detection is shown with a transduction molecule modulating current flow (typically switching between a few dominant levels of blockade, dwell time of the overall blockade is not typically a feature—many blockade durations will not translocate in the time-scale of the experiment, for example, active ejection control is often involved, where “active ejection control” is a systematic release of the molecule after a certain specified time or upon recognizing a certain condition.).

FIG. 1.E. Lipid bilayer (100) side-view with a simple ‘cut-out’ channel depicted (110).

FIG. 1.F. Diagram of patch-clamp amplifier (240) connected to positive electrode (244) and negative electrode (242), with negative electrode in the cis-chamber (210) of electrolyte solution and with the positive electrode in the trans-chamber (220) of electrolyte solution. The two electrolyte chambers have a conductance path via the U-tube (230) and via the aperture restriction feeding into the cis-chamber, where the bilayer is established (100).

FIG. 1.G. Cis-side of channel shown (110) embedded in a bilayer (100), with possible channel interactants or modulators shown in (320) and (310).

FIG. 1.H. The biotinylated (410) DNA hairpin (420) examined in proof-of-concept studies.

FIG. 2.A. Schematic diagram of the Nanopore Transduction Detector. FIG. 2.A. Left: shows the nanopore detector consists of a single pore in a lipid bilayer which is created by the oligomerization of the staphylococcal alpha-hemolysin toxin in the left chamber, and a patch clamp amplifier capable of measuring pico Ampere channel currents located in the upper right-hand corner. FIG. 2.A.Center: shows a biotinylated DNA hairpin molecule captured in the channel's cis-vestibule, with streptavidin bound to the biotin linkage that is attached to the loop of the DNA hairpin. FIG. 2.A. Right: shows the biotinylated DNA hairpin molecule (Bt-8gc) of FIG. 2.A.Center.

FIG. 2.B The various modes of channel blockade are shown, along with representative electrical signals as follows in FIG. 2.B: Example I. No channel—e.g., a Membrane (bilayer in Sec. II). Example II. Single Channel, Single-molecule Scale (a nanopore, shown open). Example III. Single-molecule blockade, a brief interaction or blockade with fixed-level with non-distinct signal—a non-modulatory nanopore epitope. IV. Single-molecule blockade, typical multi-level blockade with distinct signal modulations (typically obeying stationary statistics or shifts between phases of such). V. Single-molecule blockade, typical fixed-level blockade with non-distinct signal while not modulated, but under modulation can be awakened into distinct signal, with distinct modulations

FIG. 2.C. Nanopore Transduction Detector (NTD) Probe—a bifunctional molecule (A), one end channel-modulatory upon channel-capture (and typically long-lived), the other end multi-state according to the event detection of interest, such as the binding moieties (antibody and aptamer, schematically indicated in bound and unbound configurations in (B) and (C)), introduced in Sec. II experiments, to enable a biosensing and assaying capability.

FIG. 2.D. NTD assayed molecule (a protein, or other biomolecule, for example) Antibodies (proteins) are NTD assayed in the PofC Experiments, for example. Nanopore epitopes may arise from glyocprotein modifications and provide a means to measure surface features on heterogeneities mixture of protein glycoforms (such mixtures occur in blood chemistry, commercially available test on HbA1c glycosylation common, for example). A molecule may be examined via NTD sampling assay upon exposure to nanopore detector, (or molecular complex including molecule of interest).

FIG. 2.E. Probes shown: bound/unbound type and uncleaved/cleaved type.

FIG. 2.F. Nanopore epitope assay (of a protein, or a heterogenous mixture of related glycoprotein, for example, via glycosilation that need not be enzymatically driven, as occurs in blood, for example).

FIG. 2.G. Gel-shift mechanism. Electrophoretically draw molecules across a diffusionally resistive buffer, gel, or matrix (PEG-shift experiments in Sec. II). If medium in buffer, gel, or matrix is endowed with a charge gradient, or a fixed charge, or pH gradient, etc., isoelectric focusing effects, for example, might be discernable.

FIG. 2.H. Oriented modulator capture on protein (or other) with specific binding (an antibody for example).

FIG. 2.I. Oriented modulator capture on protein (or other) with enzymatic activity (lambda exonuclease for example).

FIG. 2.J (on Left). The Y-SNP transducer.

FIG. 2.K (on Right). Multichannel scenario, with only one blockade present (at low concentration, for example0.

FIG. 3, Right. Observations of individual blockade events are shown in terms of their blockade standard deviation (x-axis) and labeled by their observation time (y-axis). The standard deviation provides a good discriminatory parameter in this instance since the transducer molecules are engineered to have a notably higher standard deviation than typical noise or contaminant signals. At T=0 seconds, 1.0 μM Bt-8gc is introduced and event tracking is shown on the horizontal axis via the individual blockade standard deviation values about their means. At T=2000 seconds, 1.0 μM Streptavidin is introduced. Immediately thereafter, there is a shift in blockade signal classes observed to a quiescent blockade signal, as can be visually discerned. The new signal class is hypothesized to be due to (Streptavidin)-(Bt-8gc) bound-complex captures. Results in the Left Panel suggest that the new signal class is actually a racemic mixture of two hairpin-loop twist states. At T=4000 urea is introduced at 2.0 M and gradually increased to 3.5 M at T=8,100. FIG. 3, Left. As with the Right Panel on the same data, a marked change in the Bt-8gc blockade observations is shown immediately upon introducing streptavidin at T=2000 seconds, but with the mean feature we clearly see two distinctive and equally frequented (racemic) event categories. Introduction of chaotropic agents degrades first one, then both, of the event categories, as 2.0 M urea is introduced at T=4000 seconds and steadily increased to 3.5 M urea at T=8100 seconds.

FIG. 4. Left. The apparent Bt-8gc concentration upon exposure to Streptavidin. The vertical axis describes the counts on unbound Bt-8gc blockade events and the above-defined mapping to “apparent” concentration is used. In the dilution cases, a direct rescaling on the counts is done, to bring their “apparent” concentration to 1.0 μM concentration (i.e., the 0.5 μM concentration counts were multiplied by 2). For the control experiments with no biotin (denoted ‘*-8gc’), the *-8gc concentration shows no responsiveness to the streptavidin concentration. Right. The increasing frequency of the blockades of a type associated with the streptavidin-Bt-8gc bound complex. The background Bt-8gc concentration is 0.5 μM, and the lowest clearly discernible detection concentration is at 0.17 μM streptavidin.

FIG. 5. (Top) 5-base ssDNA unbound; (Bottom) 5-base ssDNA bound. Shows the modification to the toggler-type signal shortly after addition of 5-base ssDNA. The observed change is hypothesized to represent annealing by the complimentary 5-base ssDNA component, and thus detection of the 5-base ssDNA molecule. Each graph shows the level of current in picoamps over time in milliseconds.

FIG. 6.A. Left and Center Panels. Y-shaped DNA transducer with overhang binding to DNA hairpin with complementary overhang. Only a portion of a repetitive validation experiment is shown, thus time indexing starts at the 6000^{th} second. From time 6000 to 6300 seconds (the first 5 minutes of data shown) only the DNA hairpin is introduced into the analyte chamber, where each point in the plots corresponds to an individual molecular blockade measurement. At time 6300 seconds urea is introduced into the analyte chamber at a concentration of 2.0 M. The DNA hairpin with overhang is found to have two capture states (clearly identified at 2 M urea). The two hairpin channel-capture states are marked with the green and red lines, in both the plot of signal means and signal standard deviations. After 30 minutes of sampling on the hairpin+urea mixture (from 6300 to 8100 seconds), the Y-shaped DNA molecule is introduced at time 8100. Observations are shown for an hour (8100 to 11700 seconds). A number of changes and new signals now are observed: (i) the DNA hairpin signal class identified with the green line is no longer observed—this class is hypothesized to be no longer free, but annealed to its Y-shaped DNA partner; (ii) the Y-shaped DNA molecule is found to have a bifurcation in its class identified with the yellow lines, a bifurcation clearly discernible in the plots of the signal standard deviations. (iii) the hairpin class with the red line appears to be unable to bind to its Y-shaped DNA partner, an inhibition currently thought to be due to G-quadruplex formation in its G-rich overhang. (iv) The Y-shaped DNA molecule also exhibits a signal class (blue line) associated with capture of the arm of the ‘Y’ that is meant for annealing, rather than the base of the ‘Y’ that is designed for channel capture. In the Std. Dev. box are shown diagrams for the G-tetrad (upper) and the G-quadruplex (lower) that is constructed from stacking tetrads. The possible observation of G-quadruplex formation bodes well for use of aptamers in further efforts. Right Panel. The Y-annealing transducer.

FIG. 6.B. The Y-SNPtest complex is shown at the base-level specification and at the diagrammatic level in the leftmost two figures. The Y-SNP DNA probe (the dark lines) is to be examines in annealed conformation with the ^{˜}220 base targets indicated with the long gray curve. The Y-annealing transducer can have its ssDNA arm linked to an antibody (the Y-Ab labeled molecule), or simply have its ssDNA arm extend the ^{˜}70 bases needed to have an aptamer linked (rightmost diagram).

FIG. 7. A (Left) Channel current blockade signal where the blockade is produced by 9GC DNA hairpin with 20 bp stem. (Center) Channel current blockade signal where the blockade is produced by 9GC 20 bp stem with magnetic bead attached. (Right) Channel current blockade signal where the blockade is produced by c9GC 20 bp stem with magnetic bead attached and driven by a laser beam chopped at 4 Hz, in accordance with an embodiment of this invention. Each graph shows the level of current in picoamps over time in milliseconds.”

FIG. 7.B. Study molecule with externally-driven modulator linkage to awaken modulator signal.

FIG. 7.C. Study molecule with externally-driven modulator linkage to awaken modulator signal, with epitope-selection to obtain sleeping epitope, then determine its identity, and based on known modulator-activation driving signals, proceed with driving the system to obtain a modulator capture linkage.

FIG. 7.D. Same situation as in cases with linked-modulator, but more extensive range of external modulations explored, such that, in some situations, a sleeping nanopore epitope is ‘awakened’ (modulatory channel blockades produced), and the target molecule does not require a coupler attachment., e.g., using external modulations with no coupler, may be able to obtain ‘ghost’ transducers in some situations.

FIG. 7.E. ‘Sleeping’ Nanopore Ghost Epitope (coupled molecule not needed).

FIG. 7.F. External modulations with transducer with coupler, a trifunctional molecule.

FIG. 8. A flow diagram illustrating the signal processing architecture that was used to classify DNA hairpins in accordance with one embodiment of this invention: Signal acquisition was performed using a time-domain, thresholding, Finite State Automaton, followed by adaptive pre-filtering using a wavelet-domain Finite State Automaton. Hidden Markov Model processing with Expectation-Maximization was used for feature extraction on acquired channel blockades. Classification was then done by Support Vector Machine on five DNA molecules: four DNA hairpin molecules with nine base-pair stem lengths that only differed in their blunt-ended DNA termini, and an eight base-pair DNA hairpin. The accuracy shown is obtained upon completing the 15^{th} single molecule sampling/classification (in approx. 6 seconds), where SVM-based rejection on noisy signals was employed.

FIG. 9. A sketch of the hyperplane separability heuristic for SVM binary classification. An SVM is trained to find an optimal hyperplane that separates positive and negative instances, while also constrained by structural risk minimization (SRM) criteria, which here manifests as the hyperplane having a thickness, or “margin,” that is made as large as possible in seeking a separating hyperplane. A benefit of using SRM is much less complication due to overfitting (a problem with Neural Network discrimination approaches).”

FIG. 10. The Time-Domain Finite State. Automaton. Shows the architecture of the FSA employed in an embodiment of this invention. Tuning on FSA parameters was done using a variety of heuristics, including tuning on statistical phase transitions and feature duration cutoffs.

FIG. 11. The time-domain FSA shown in FIG. 10 is used to extract fast time-domain features, such as “spike” blockade events. Automatically generated “spike” profiles are created in this process. One such plot is shown here for a radiated 9 base-pair hairpin, with a fraying rate indicated by the spike events per second (from the lower level sub-blockade). Results: the radiated molecule has more “spikes” which are associated with more frequent “fraying” of the hairpin terminus—the radiated molecules were observed with 17.6 spike events per second resident in the lower sub-level blockade, while for non-radiated there were only 3.58 such events (shown in FIG. 12).

FIG. 12. Automatically generated “spike” profile for the non-radiated 9 base-pair hairpin. Results: the non-radiated molecule had a much lower fraying rate, judging from its much less frequent lower-level spike density (3.58 such events per LLsec).

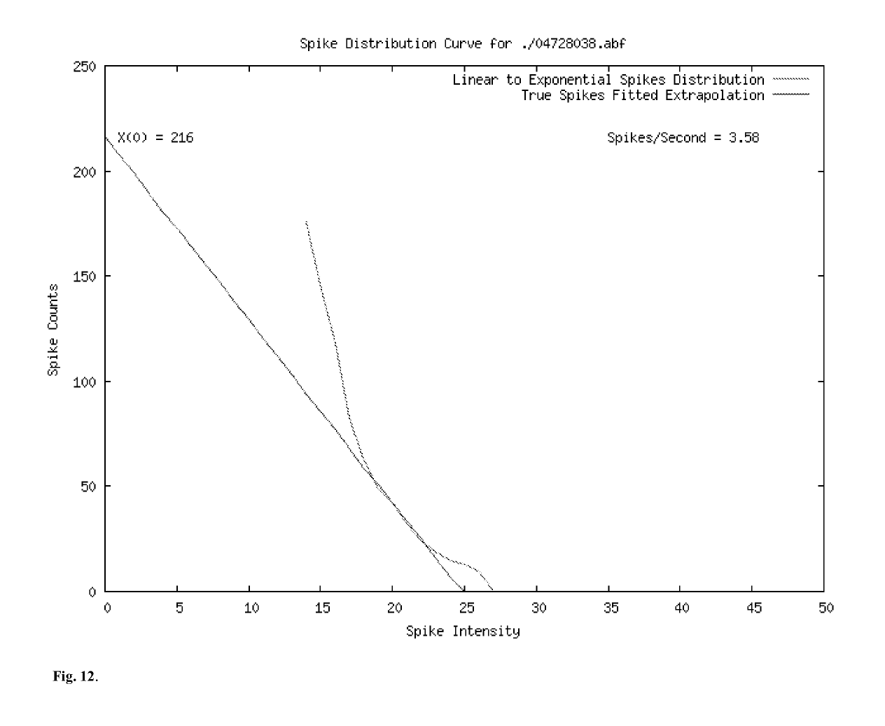

FIG. 13. This figure shows the blockade sub-level noise reduction capabilities of an HMM/EM×5 filter with gaussian parameterized emission probabilities. The sigma values indicated are multiplicative (i.e. the 1.1 case has standard deviation boosted to 1.1 times the original standard deviation). Sigma values greater than one blur the gaussians for the emission probabilities to greater and greater degree, as indicated for each resulting filtered signal trace in the figure. The levels are not preserved in this process, but their level transitions are highly preserved, now permitting level-lifetime information to be extracted easily via a simple FSA scan (that has minimal tuning, rather than the very hands-on tuning required for solutions purely in terms of FSAs).”

FIG. 14. The NTD biosensing approach facilitated by use of immuno-absorbant (or membrane immobilized) assays, such that a novel ELISA/nanopore platform results. The immune-absorbance, followed by a UV-release & nanopore detection process provides a significant boost in sensitivity.

FIG. 15. The Detection events involved in the ‘indirect’ NTD biosensing approaches: TERISA and E-phi Contrast TERISA.

FIG. 16.A. Schematic diagram of the nanopore with DNA-enzyme event transduction as a means to perform DNA sequencing. A Bt-8gc DNA hairpin captured in the channel's cis-vestibule, with lambda nuclease linked to the Bt-8gc modulator molecule as it enzymatically processes the duplex DNA molecule shown.

FIG. 16.B. A blunt-ended dsDNA molecule captured in the channel's cis-vestibule.

FIG. 17. NTD-based glycoform assays. Three NTD Glycoform assays are shown. Assay method (1) shows a protein with its post-translational modifications in orange (e.g., non-enzymatics glycations, glycosylizations, advanced glycation end products, and other modifications). Assay method (2) shows a protein of interest linked to a channel modulator. Direct channel interactions (blockades) with the protein modifications are still possible in this instance, but are expected to be dominated by the preferential capture of the more greatly charged modulator capture. Changes in that modulator signal upon antibody Fv interactions with targeted surface features provide an indirect measure of those surface feature. Assay method (3) shows an antibody Fv that is linked to modulator, where, again, a binding event is engineered to be transduced into a change of modulator signal.

FIG. 18. Multiple Antibody Blockade Signal Classes. Examples of the various IgG region captures and their associated toggle signals: the four most common blockade signals produced upon introduction of a mAb to the nanopore detector's analyte chamber (the cis-channel side, typically with negative electrode). Other signal blockades are observed as well, but less frequently or rarely.

FIG. 19. Nanopore cheminformatics & data-flow control architecture. Aside from the modular design with the different machine learning methods shown (HMMs, SVMs, etc.), recent augmentations to this architecture for real-time processing include use of a LabWindows Server to directly link to the patch-clamp amplifier, and the PRI architecture shown in FIG. 24.

FIG. 20. CCC Protocol Flowchart (part 1)

FIG. 21. CCC Protocol Flowchart (part 2)

FIG. 22. CCC Protocol Flowchart (part 3)

FIG. 23. SSA Protocol Flow topology

FIG. 24.A. PRI Sampling Control (see [29] for specific details). Labwindows/Feedback Server Architecture with Distributed CCC processing. The HMM learning (on-line) and SVM learning (off-line), denoted in orange, are network distributed for N-fold speed-up, where N is the number of computational threads in the cluster network.

FIG. 24.B. PRI Mixture Clustering Test with 4D plot. The vertical axis is the event observation time, and the plotted points correspond to the standard deviation and mean values for the event observed at the indicated event time. The radius of the points correspond to the duration of the corresponding signal blockade (the 4^{th} dimension). Three blockade clusters appear as the three vertical trajectories. The abundant 9TA events appear as the thick band of small-diameter (short duration, ^{˜}100 ms) blockade events. The 1:70 rarer 9GC events appear as the band of large-diameter (long duration, ^{˜}5 s) blockade events. The third, very small, blockade class corresponds to blockades that partially thread and almost entirely blockade the channel.

FIG. 25. In the figure we show state-decoding results on synthetic data that is representative of a biological-channel two-state ion-current decoding problem. Signal segment (a) (at the top) shows the original two-level signal as the dark line, while the noised version of the signal is shown in red. Signal segment (b) (at the bottom) shows the noised signal in red and the two-state denoised signal according to the HMMD decoding process (whether exact or adaptive), which is stable (97.1% accurate) allowing for state-lifetime extraction (with the concomitant chemical kinetics information that is thereby obtained in this channel current analysis setting).

FIG. 26. HMMD: when entered, state i will have a duration of d according to its duration density pᵢ(d), it then transits to another state j according to the state transition probability aᵢⱼ (self-transitions, aᵢᵢ, are not permitted in this formalism).

FIG. 27. Sliding-window association (clique) of observations and hidden states in the meta-state hidden Markov model, where the clique-generalized HMM algorithm describes a left-to-right traversal (as is typical) of the HMM graphical model with the specified clique window. The first observation, b0, is included at the leading edge of the clique overlap at the HMM's left boundary.

FIG. 28. Top. Maximum full exon meta-state HMM performance for data ALLSEQ. Bottom. Maximum base level meta-state HMM performance for data ALLSEQ

FIG. 29, F-view. Top. Full exon level accuracy for C. elegans with 5-fold cross-validation. Bottom. Base level accuracy for C. elegans with 5-fold cross-validation.

FIG. 30, M-view. Top. Full exon level accuracy for C. elegans 5-fold cross-validation. Bottom. Base level accuracy for C. elegans 5-fold cross-validation.

FIG. 31. HOHMM Gene-predictor code-base. _WindEx.pl (previously Window_Extractor.pl)—extracts windows around features defines according to GFF-annotated data (uses GFF.pm). signature_filter.pl—validation of annotation attributes can be performed or enforced. m852xx.pl→produces X_content.c, where X is a model-dependent set (given as sig173GC.c for the implementation shown in the diagram; which is the footprint F=8 model described in the model synopsis that follows). Profiler_C.pl→produces count.c and X_profile.c. Viterbi_driver has main( )→variants depending on strength of representation in dataset (m2, m5, m1 m3, m852) [part of the core HOHMM implementation]_newgff_output (previously gff_output.c) has output( ) which outputs results in a format such that it can be easily slurped up by BGscore.pm and other scoring algorithms)._X_transition.h [core HOHMM implementation; X is a model-dependent set given in sig173GC.c]. _inft2.c (previously initialization.c). sig173GC.c (the implementation for the footprint F=8 theoretical model described the synopsis that follows). Idfilter.c→calls length_dist.c (an approximate HMM with duration implementation). rho has rho( )→variants depending on use of possible approximations, re-estimations; main attribute, however, is a reduction of the HMM algorithm to a series of data table look-ups, where those data tables are produced carefully, in clear Perl meta-language code to produce the data-table C-code, and directly loaded into RAM as part of the core HMM C program. This is a highly optimized arrangement on most machines automatically, so permits hetergenous network distribution very easily when distributed Perl training and C HMM/Viterbi operations are performed. Bad_exon.pl→a bad exon filter. Cleaner.pl→a cleaned dataset creator according to specification on filters. (various datarun scripts).

FIG. 32. Three kinds of emission mechanisms: (1) position-dependent emission; (2) hash-interpolated emission; (3) normal emission. Based on the relative distance from the state transition point, we first encounter the position-dependent emissions (denoted as (1)), then the zone-dependent emissions (2), and finally, the normal state emissions (denoted as (3)).

FIG. 33 Top: Nucleotide level accuracy rate results with Markov order of 2, 5, 8 respectively for C. elegans, Chromosomes I-V. Bottom: Exon level accuracy rate results with Markov order of 2, 5, 8 respectively for C. elegans, Chromosomes I-V.

FIG. 34 Top: Nucleotide level accuracy rate results for three different kinds of settings. Bottom: Exon

FIG. 35 Top: Nucleotide (red) and Exon (blue) accuracy results for Markov models of order: 2, 5, and 8, using the 5-bin HMMBD (where the AC value of the five folds is averaged in what is shown). Bottom: Nucleotide (red) and Exon (blue) standard deviation results for Markov models of order: 2, 5, and 8, using the 5-bin HMMBD (where the standard deviation of the AC values of the five folds is shown).

FIG. 36. A de-segmentation test is shown.

FIG. 37. Training. We use the Baum-Welch Algorithm to build up Hidden Markov Model. That is to find the model parameters (transition and emission probabilities) that best explain the training sequences: (1) Initialize emission and transition probabilities: e&t. (M); (2) Distribute the whole data sequence to slave computers. Every two continuous sequences have an overlap, as shown in FIG. 1. (MASTER); (3) Calculate fₖ(i) and bₖ(i) using forward and backward algorithm. (SLAVES); (4) Calculate Aₖₗ: the number of transitions from state k to state l. By: Aₖₗ=Σᵢ fₖ(i)aₖₗ eₗ(Xᵢ₊₁)bₗ(i+1) (SLAVES). Calculate Eₖ(b): the number of emissions of b from state k. By: Eₖ(b)=Σ_{{|Xi=b}} fₖ(i)bₖ(i) (SLAVES); (5) Send Aₖₗ and Eₖₗ back to master. (SLAVES); (6) Sum respective Aₖₗs and Eₖₗs from different Slaves. That is: Aₖₗ=Σₛₗₐᵥₑₛ Aₖₗ and Eₖₗ=Σₛₗₐᵥₑₛ Eₖₗ (MASTER); (7) Update emission and transition probabilities (e&t). By: aₖₗ=Aₖₗ/Σ_{l′} A_{kl′} and eₖ(b)=Eₖ(b)/Σₖ(b′)(MASTER); (8) Sent new emission and transition probabilities to slaves. (M); (9) Stop if maximum number of iteration is exceeded or convergence happens.else goto step (3) (MASTER).

FIG. 38. Distributed HMM/EM-with-Duration processing. Stitching together independently computed segments of dynamic programming table can be accomplished with minimal constraints, even though all segments but the first have improperly initialized first columns. This is possible due to the Markov approximation by limited memory. By this means the computational time can be reduced by approximately the number of computational nodes in use.

FIG. 39. Viterbi column-pointer match de-segmentation rule. Table1 and Table2 are overlapped. And their blue columns have the same pointers. Then the index of this blue column become the joint. The black pointers form the final viterbi path.

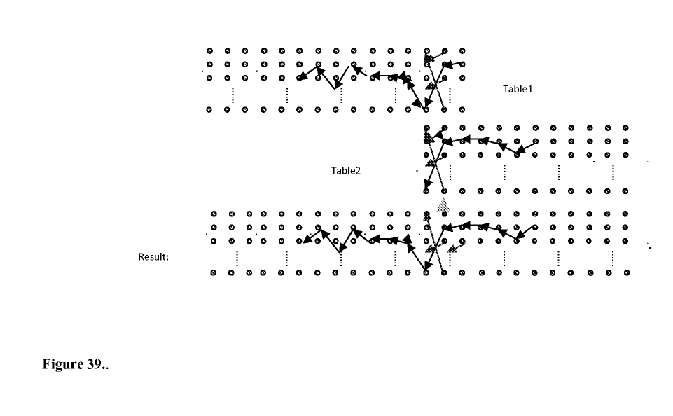

FIG. 40. Extended Viterbi Match de-segmentation rule. In an overlapped window size of L, try to find N continuous agreements (the yellow area). The yellow area becomes their join.

FIG. 41. Hyperplane Separability. A general hyperplane is shown in its decision-function feature-space splitting role, also shown is a misclassified case for the general nonseparable formalism. Once learned, the hyperplane allows data to be classified according to the side of the hyperplane in which it resides, and the ‘distance’ to that hyperplane provides a confidents parameter. The SVM approach encapsulates a significant amount of model-fitting information in its choice of kernel. The SVM kernel also provides a notion of distance in the neighborhood of the decision hyperplane. In Proof-of-Concept work (Sec. II), novel, information-theoretic, kernels were successfully employed for notably better performance over standard kernels.

FIG. 42. Clustering performance comparisons: SVM-external clustering compared with explicit objective function clustering methods. Nanopore detector blockade signal clustering resolution from a study of blockades due to individual molecular capture-events with 9AT and 9CG DNA hairpin molecules [18]. The SVM-external clustering method consistently out-performs the other methods. The optimal drop percentage on weakly classified data differed for the different methods for the scores shown: Our SVM relabel clustering with drop: 14.8%; Kernel K-means with drop: 19.8%; Robust fuzzy with drop: 0% (no benefit); Vapnik's Single-class SVM (internal) clustering: 36.1%.

FIG. 43. SVM-external clustering results. (a) and (b) show the boost in Purity and Entropy as a function of Number of Iterations of the SVM clustering algorithm. (c) shows that SSE, as an unsupervised measure, provides a good indicator in that improvements in SSE correlate strongly with improvements in purity and entropy. The blue and black lines are the result of running fuzzy c-mean and kernel k-mean (respectively) on the same dataset. In clustering experiments in (33), a data set consisting of 8GC and 9GC DNA hairpin data is examined (part of the data sets used in (38)).

FIG. 44. (left) Simulated annealing with constant perturbation, (right) Simulated annealing with variable perturbation. As shown in left, top panel, simulated annealing with a 10% initial label-flipping results in a local-optimum solution. In the right panel this is avoided by boosting the perturbation function depending on the number of iterations of unchanged SSE (right, top panel). These results were produced using an exponential cooling function, Tₖ₊₁=β^{k}Tₖ, with β=0.96 and T₀=10.

### DETAILED DESCRIPTION OF THE PREFERRED EMBODIMENTS

The present description represents the teaching of the present invention to one of ordinary skill in the relevant art. Of course, the person of ordinary skill in the art will appreciate that the teachings are representative of one mode for carrying out the present invention and that many modifications and adaptations are possible without departing from the spirit of the present invention which is limited solely by the claims which follow. Further, it will be appreciated by the reader that some of the features of the present invention can be used without the corresponding use of other features and that one of ordinary skill in the relevant art would know the modifications and deletions which can be made.

Nanopore transduction of events has been done in proof-of-concept experiments with a single-modulated-channel thin film, or membrane, device. The modulated-single-channel thin film is placed across a horizontal aperture, providing a seal such that a cis and trans chamber are separated by that modulated single-channel connection. An applied potential is used to establish current through that single, modulated, channel.

Methods and Devices, and Processes and Protocols, are Provided for Detecting, Assaying, and Characterizing Molecules and Molecular Mixtures Using the Nanopore Transduction Detection (NTD) Platform.

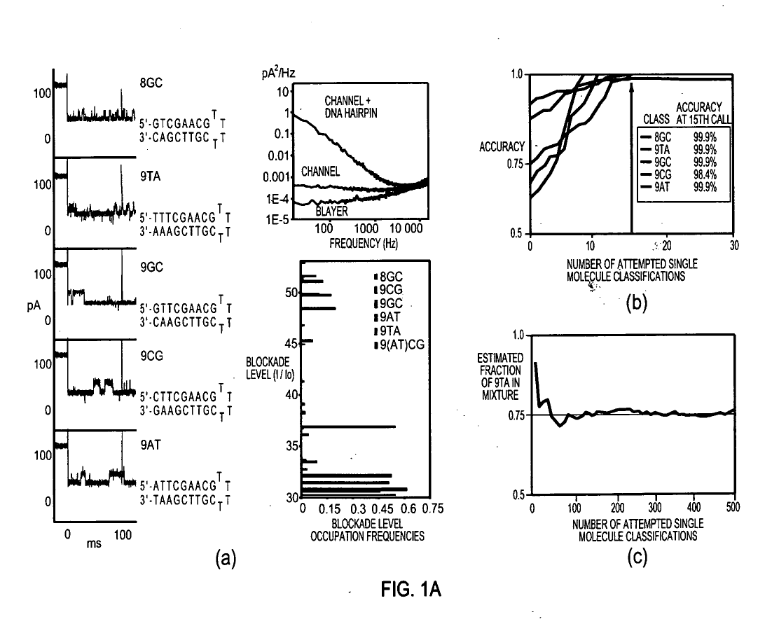

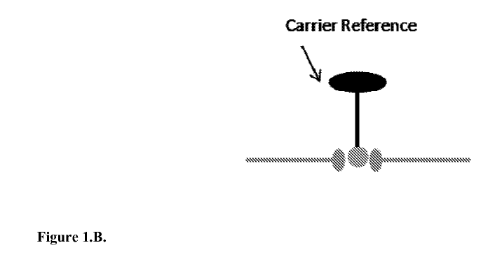

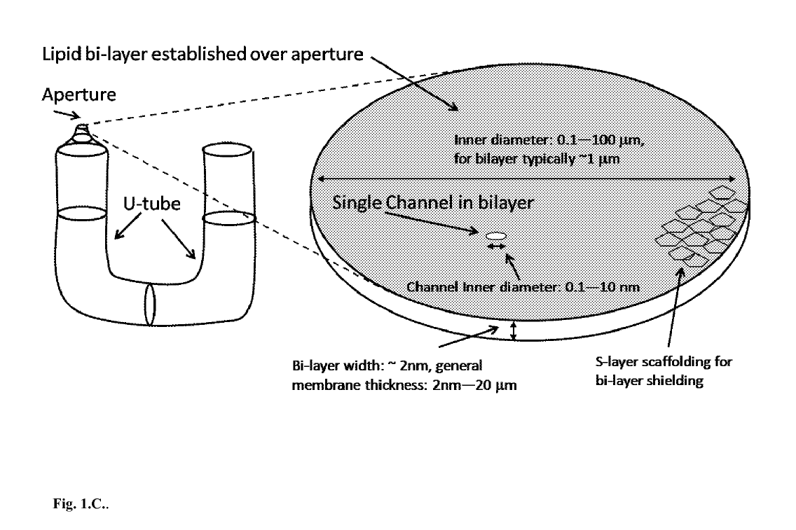

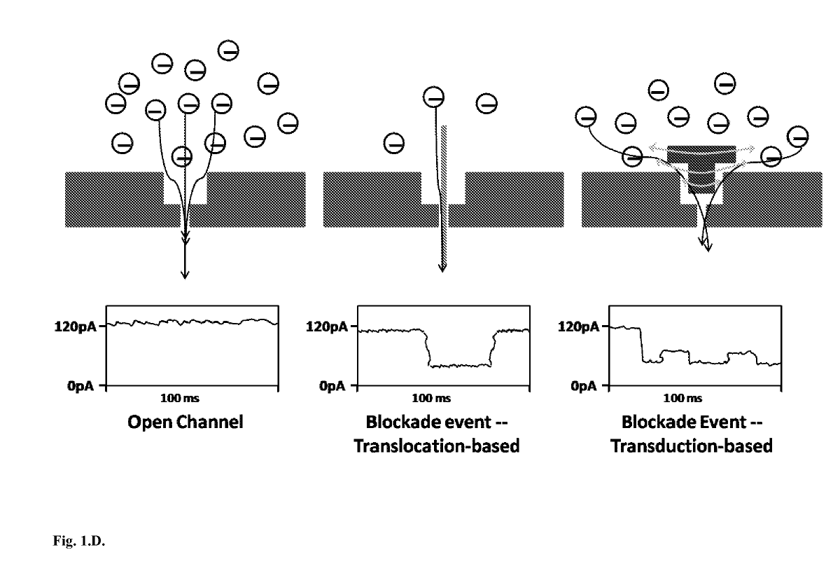

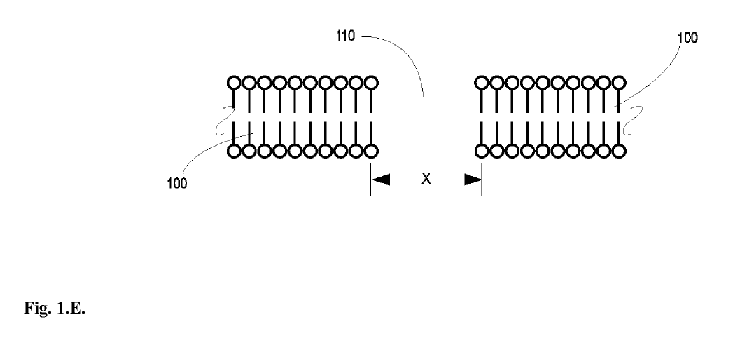

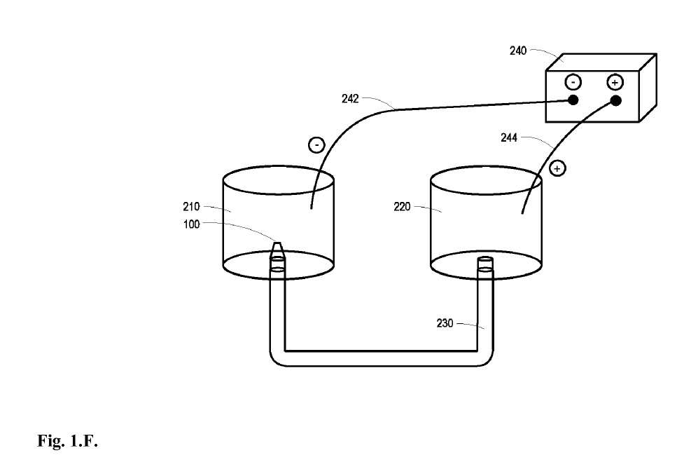

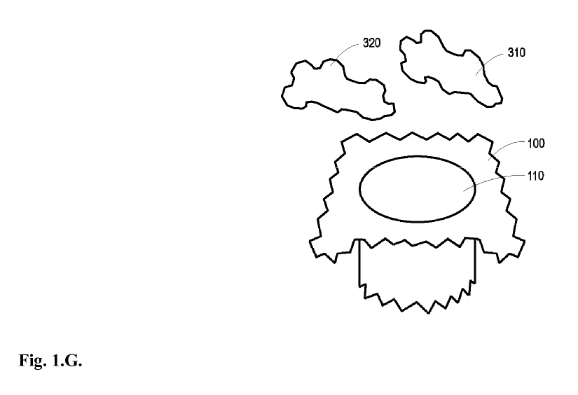

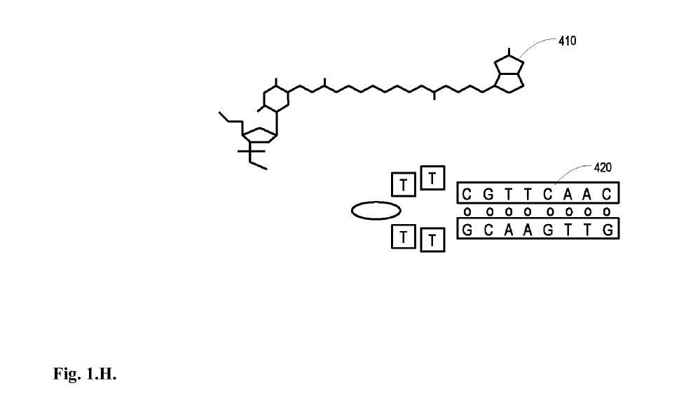

The components comprising the NTD platform in a preferred embodiment include an engineered molecule that can be drawn, by electrophoretic means (using an applied potential), into a channel that has inner diameter at the scale of that molecule, or one of its molecular-complexes, as well as the aforementioned nanopore, a means to establish a current flow through that nanopore (such as an ion flow under an applied potential), a means to establish the molecular capture for the timescale of interest (electrophoresis, for example), and the computational means to perform signal processing and pattern recognition. The channel is sized such that a transducer molecule, or transducer-complex, is too big to translocate, instead the transducer molecule is designed to get stuck in a ‘capture’ configuration that modulates the ion-flow in a distinctive way (see FIGS. 1.A-H & 2.A-J). The NTD modulators are engineered to be bifunctional in that one end is meant to be captured, and modulate the channel current, while the other, extra-channel-exposed end, is engineered to have different states according to the event detection, or event-reporting, of interest. Examples include extra-channel ends linked to binding moieties such as antibodies, antibody fragments, or aptamers. Examples also include ‘reporter transducer’ molecules with cleaved/uncleaved extra-channel-exposed ends, with cleavage by, for example, UV or enzymatic means. By using signal processing to track the molecular states engineered into the transducer molecules, a biosensor or assayer is thereby enabled. By tracking transduced states of a coupled molecule undergoing conformational changes, such as an antibody, or a protein with a folding-pathway associated with disease, direct examination of co-factor, and other, influences on conformation can also be assayed at the single-molecule level.

The Stochastic Sequential Analysis (SSA) Protocol and the Classification and Clustering (C&C) Methods,

Described in what follows, provide a robust and efficient means to make a device or process as smart as it can usefully be, with possible enhancement to device (or process) sensitivity and productivity and efficiency, as well as possibly enabling new capabilities for the device or process (via transduction coupling, for example, as with the nanopore transduction detector (NTD) platform). The SSA Protocol and C&C Methods can work with existing device or process information flows, or can work with additional information induced via modulation or introduction via transduction couplings (comprising carrier references that will be described below). Hardware device-awakening and process-enabling may be possible via introduction of modulations or transduction couplings, when used in conjunction with the SSA Protocol and C&C Methods when implemented to operate on the appropriate timescales to enable real-time experimental control (with numerous examples of the latter in Sec. II Proof-Concept Experiments and the Sec. III descriptions below).

Channel Current Cheminformatics (CCC) Implementation of the Stochastic Sequential Analysis (SSA) Protocol.

The components for a stochastic signal analysis (SSA) protocol and a stochastic carrier wave (SCW) communications protocol are described in what follows. NTD, with the channel current cheminformatics (CCC) implementation of the SSA protocol, provides proof-of-concept examples of the SSA methods utilization, and can be used as a platform for finite state communication. From the CCC/NTD starting point I will convey the unique signal boosting capabilities when working with real-time capable HMMBD signal processing [see the HMMBD Patent] and other SSA methods. From recognition of stationary statistics transitions we can generalize to full-scale encoding/decoding in terms of stationary statistics ‘phases’, i.e., stochastic phase modulation, a form of stochastic carrier-wave (SCW) communications. Many of the Proof-of-concept experiments listed in Sec. II involve SSA applications, in a CCC implementation or context for the NTD platform. The SSA Protocol is a general signal processing paradigm for characterizing stochastic sequential data; and the SVM-based classification and clustering methods are a general signal processing paradigm for performing classification or clustering.

NTD ‘Binary’ Event Communication, a Precursor to Stochastic ‘Phase’ Modulation (SPM).

In the Nanopore Transduction Detector (NTD) experiments the molecular dynamics of a (single) captured transducer molecule provides a unique stochastic reference signal with stable statistics on the observed, single-molecule blockade, channel current, somewhat analogous to a carrier signal in standard electrical engineering signal analysis. Changes in transient blockade statistics, coupled to SSA signal processing protocols, enables the means for a highly detailed characterization of the interactions of the transducer molecule with binding cognates in the surrounding (extra-channel) environment (see Proof-of-Concept listing, Part II, below, for details).

The transducer molecule is specifically engineered to generate distinct signals depending on its interaction with the target molecule. Statistical models are trained for each binding mode, bound and unbound, for example, by exposing the transducer molecule to zero or high concentrations of the target molecule. The transducer molecule is engineered so that these different binding states generate distinct signals with high resolution. Once the signals are characterized, the information can be used in a real-time setting to determine if trace amounts of the target are present in a sample through a serial, high-frequency sampling process.

### Part I. Description of NTD Setup, Operation, Signal Processing, and Deployment.

The nanopore transduction detection approach introduces a novel modification in the design and use of auxiliary molecules to enhance the nanopore detector's utility. The auxiliary molecule is engineered such that it can be individually ‘captured’ in the channel with blockade signal that is generally NOT at an approximately fixed blockade level, but now typically consists of a telegraph-like blockade signal with stationary statistics, or approximately stationary statistics. One scenario is to have the transducer signal be telegraph-like with clearly discernible channel modulation for its detection event, and non-modulatory when not in a detection conformation (when unbound, or uncleaved, for example). The longer the observation window sought to make a stronger decision on state classification, the more the signal associated with that state must have stationary statistics. If the event to observe is a particular target molecule, a biosensing setting for example, then NTD transducers can be introduced such that upon binding of analyte to the auxiliary molecule the toggling signal is greatly altered, to one with different transition timing and different blockade residence levels. The change in the channel blockade pattern, e.g. change in the modulatory signals statistics, is then identified using machine learning pattern recognition methods.

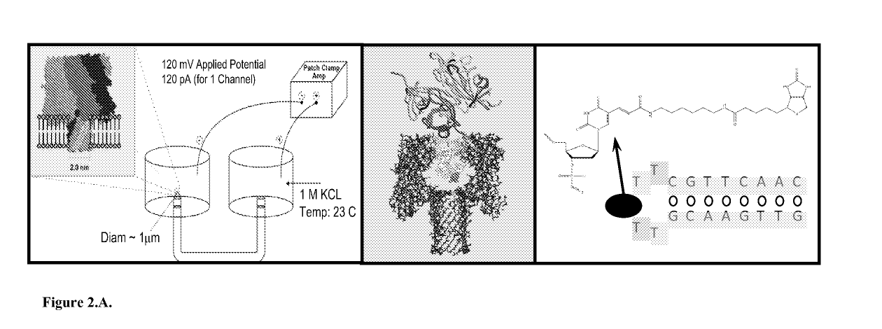

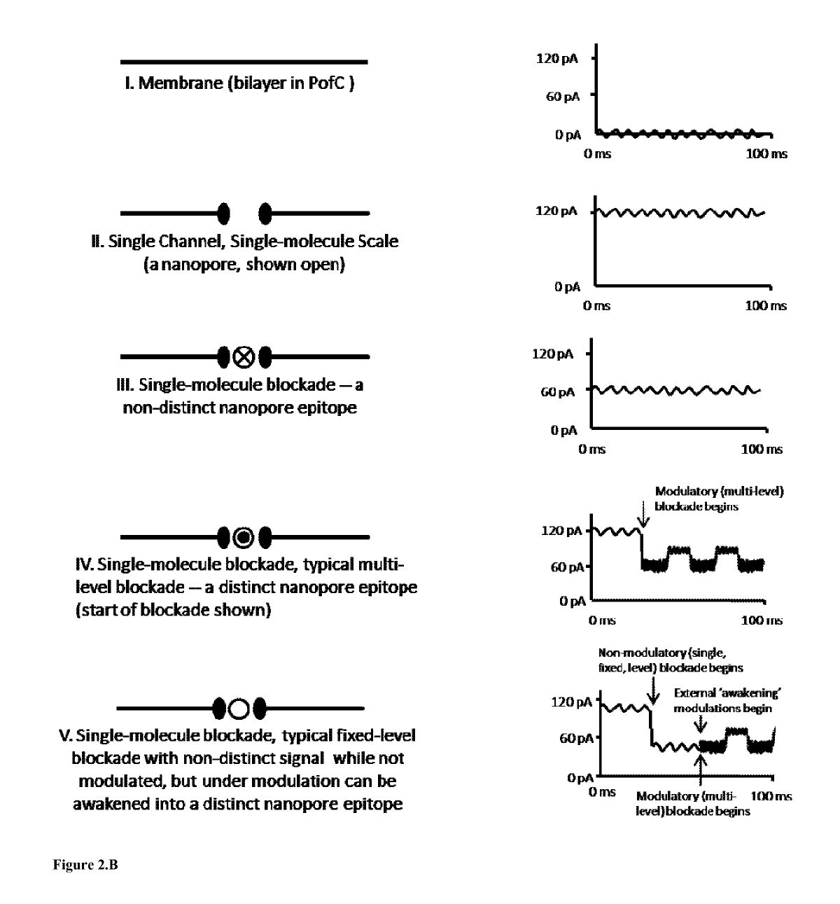

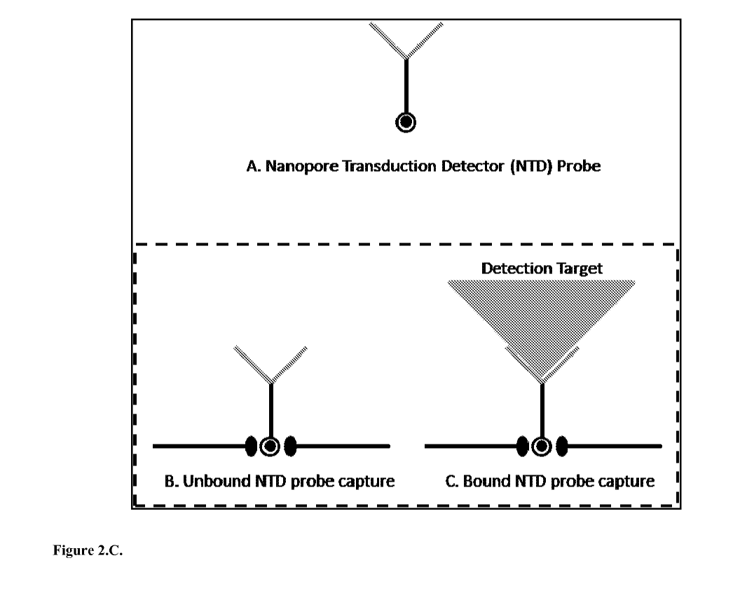

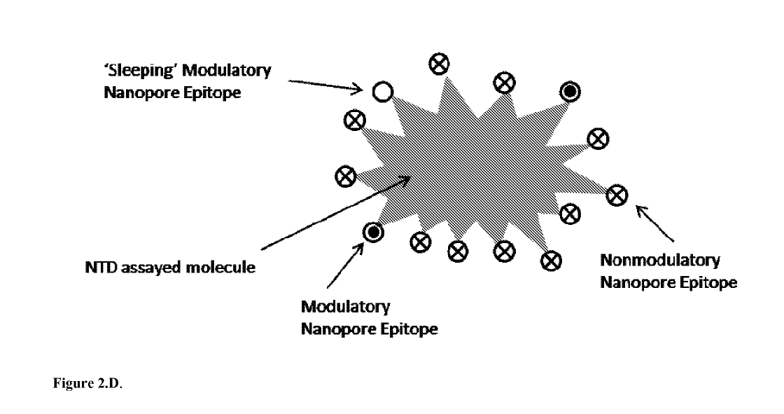

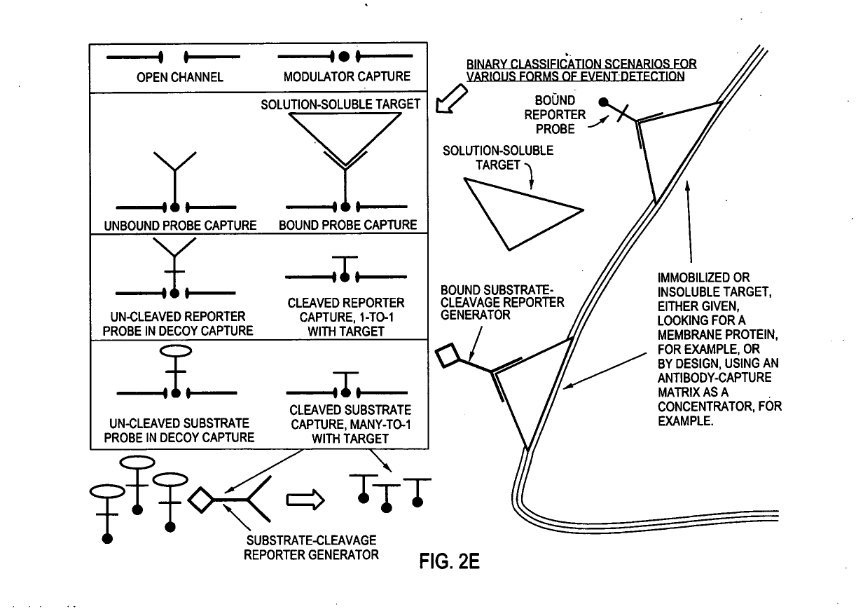

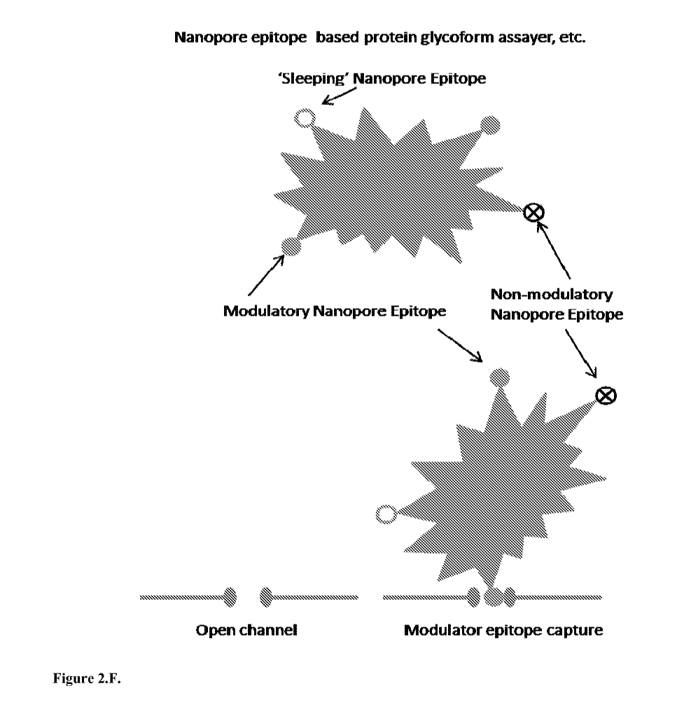

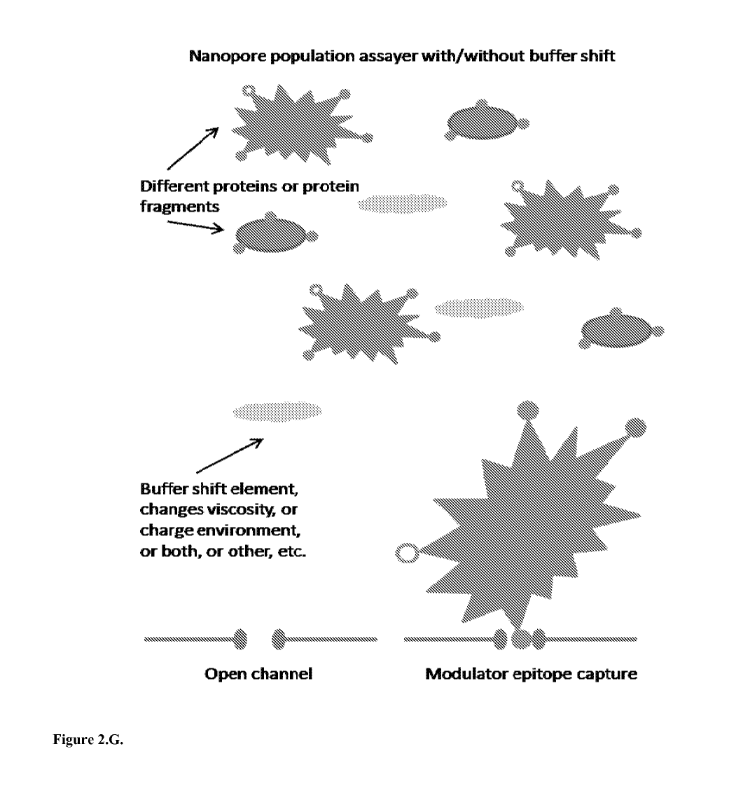

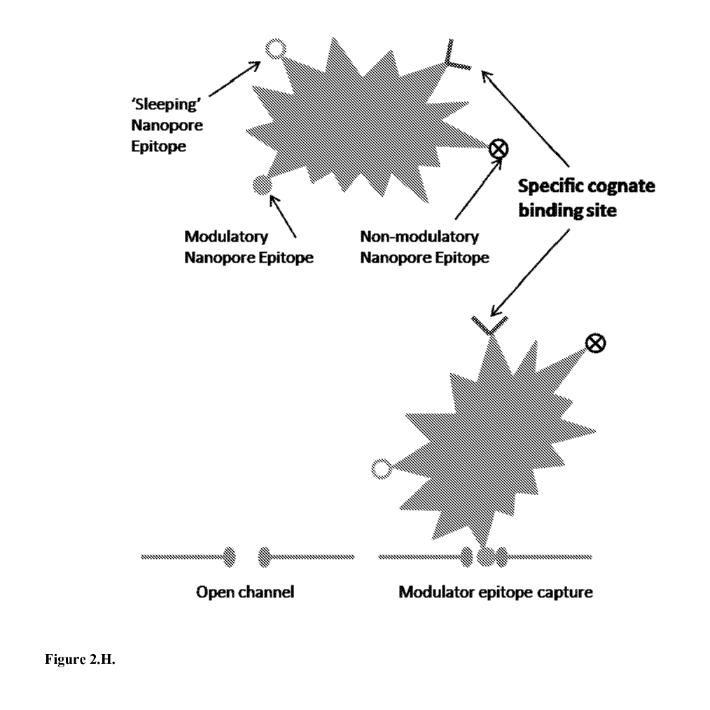

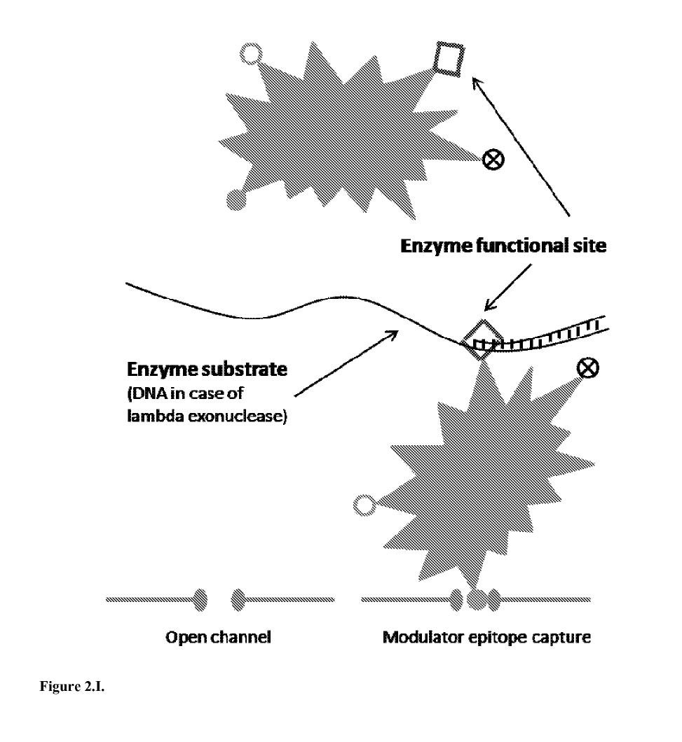

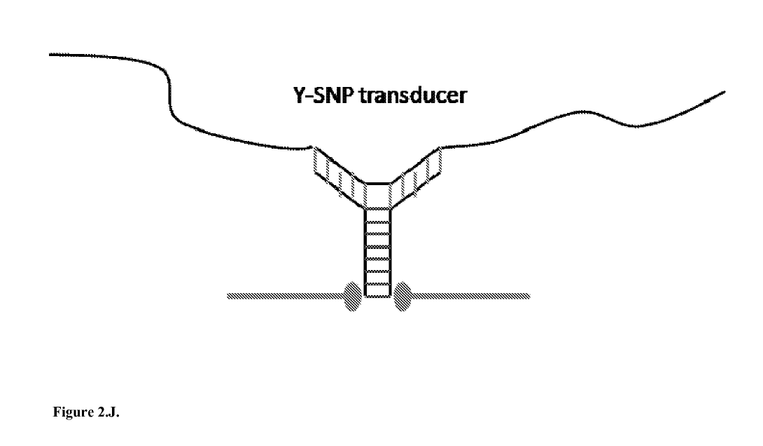

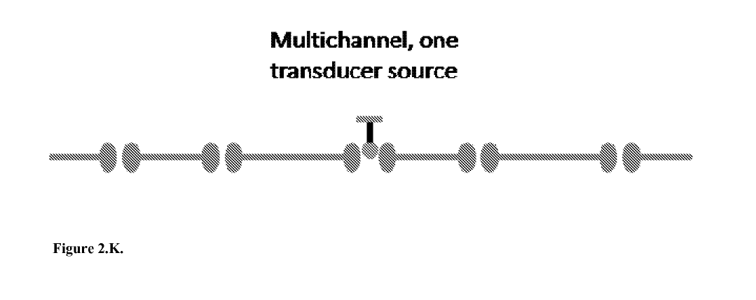

In FIGS. 2.A-2.J a nanopore transduction detector is shown in schematic and diagrammatic forms, as used in some of the Proof-of-Concept experiments (See Sec. II, below), in the configuration where the target analyte is streptavidin (a toxin) and biotin is used as the binding moiety (the fishing ‘lure’) at the transducer. In the absence of a transducer molecule and its target analyte, a base blockade electrophoretic current flows through the nanopore channel. When the transducer molecule is added, it is captured in the nanopore and disrupts the blockade current in a unique and measurable way as a result of its transient binding to the internal walls of the channel. In short, the transducer molecule “rattles” around stochastically inside the nanopore channel, imprinting its transient channel-binding kinetics on the blockade current and generating a unique signal.

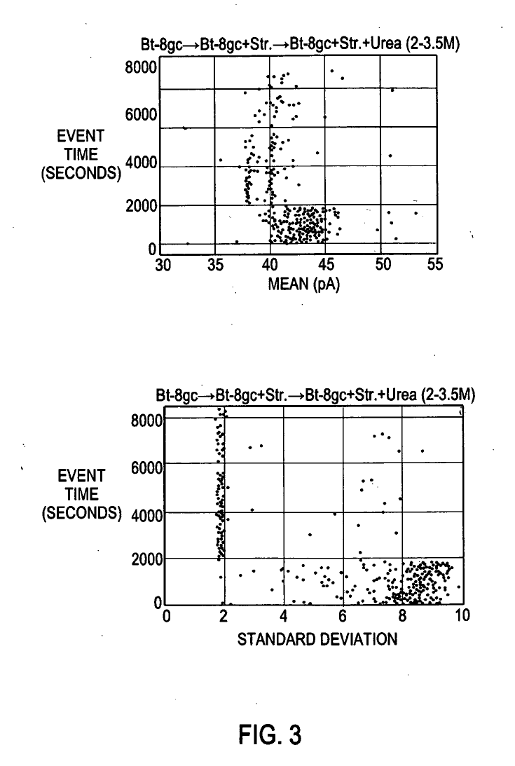

The transducer molecule in this embodiment is a bi-functional molecule; one end is captured in the nanopore channel while the other end is outside the channel. This extrachannel end is engineered to bond to a specific target: the analyte being measured. When the outside portion is bound to the target, the molecular changes (conformational and charge) and environmental changes (current flow obstruction geometry and electro-osmotic flow) result in a change in the channel-binding kinetics of the portion that is captured in the channel. This change of kinetics generates a change in the channel blockade current which represents a signal unique to the target molecule; the transducer molecule is a bi-functional molecule which is engineered to produce a unique signal change upon binding to its cognate. Some of the transducer molecule Proof-of-Concept results are shown in FIGS. 3 & 4, for a biotinylated DNA-hairpin that is engineered to generate two unique signals depending on whether or not a streptavidin molecule has bonded.

Nanopore transduction in this embodiment provides direct observation of the target molecule by measuring the binary changes in channel blockade current generated by a channel-captured transducer molecule as it interacts with a target molecule. In some respects, the NTD functions like an “artificial nose,” detecting the unique electrical signals created by subtle changes in the channel-binding kinetics of the captured transducer molecule.

In this NTD platform, sensitivity increases with observation time in contrast to translocation technologies where the observation window is fixed to the time it takes for a molecule to move through the channel. Part of the sensitivity and versatility of the NTD platform derives from the ability to couple real-time adaptive signal processing algorithms to the complex blockade current signals generated by the captured transducer molecule. If used with the appropriately designed NTD transducers, NTD can provide exquisite sensitivity and can be deployed in many applications where trace level detection is desired.

This NTD system, deployed as a biosensor platform, possesses highly beneficial characteristics from multiple technologies: the specificity of antibody binding, the sensitivity of an engineered channel modulator to specific environmental change, and the robustness of the electrophoresis platform in handling biological samples. In combination, the NTD platform can provide trace level detection for early diagnosis of disease as well as quantify the concentration of a target analyte or the presence and relative concentrations of multiple distinct analytes in a single sample.

The biosensing NTD platform, thus, has a basic mode of operation where NTD probes can be engineered to generate two distinct signals depending whether or not an analyte of interest is bound to the probe. A solution containing the probes could be mixed with a solution containing a target analyte and sampled in the NTD to determine the presence and concentration of the analyte. In a clinical setting, a nanopore transduction biosensing implementation might be accomplished by taking an antibody or other specifically-binding molecule (or molecular complex, e.g., an aptamer, or a small, functional chunk of molecularly imprinted polymer (MIP), as examples) and linking it to a transducer molecule via standard, well-established, covalent or cleavable linker chemistry. When an antigen is bound to the antibody, the nano-environmental changes due to the binding event may cause the transducer probe to undergo subtle, yet distinct changes in its kinetic interactions with the channel. These changes may result in a strong transduction signal in the presence of the antigen.

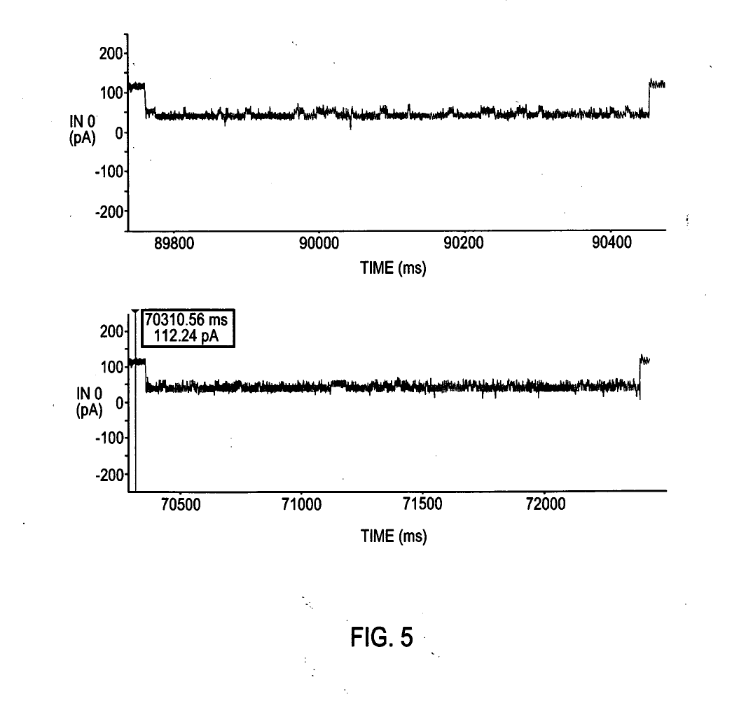

Proof of Concept experiments for DNA annealing were initially tested for detection of a specific 5-base ssDNA molecule (as shown in FIG. 5, see also the Parent Patent).

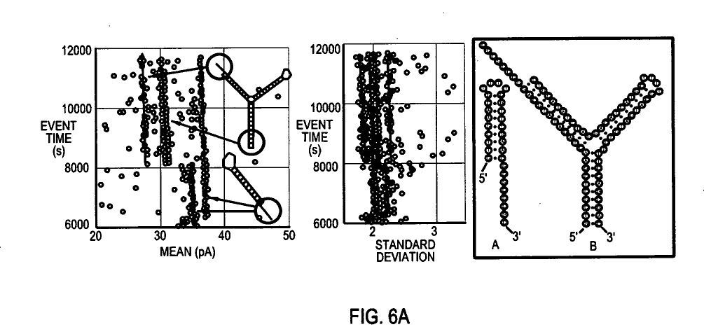

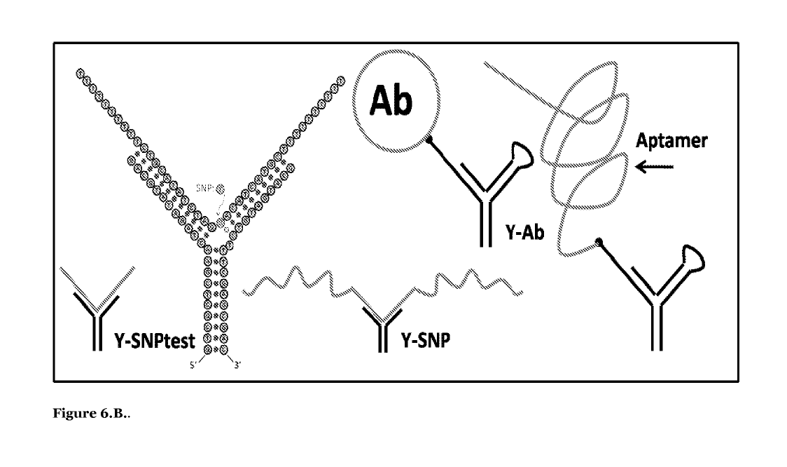

Subsequent tests of DNA annealing have been performed with a Y-shaped DNA transduction molecule engineered to have an eight-base overhang for annealing studies. A DNA hairpin with complementary 8 base overhang is used as the binding partner. FIG. 6 shows the binding results at the population-level (where numerous single-molecule events are sampled and identified). The effects of binding are clearly discernible in FIG. 6, as are potential isoforms, and the introduction of urea at 2.0 M concentration is easily tolerated, and even improves the resolution on collective binding events, such as with the 8-base annealing interaction.

The nanopore signal with the most utility and inherent information content is, thus, not the channel current signal for some static flow scenario, but one where that flow is modulated, at least in part, by the blockade molecule itself (with dynamic or non-stationary information, such as changing kinetic information). The modulated ion flow due to molecular motion and transient fixed positions (non-covalent bound states) is much more sensitive to environmental changes than a blockade molecule (or open channel flow) where the flow is at some fixed blockade value (the rate of toggle between blockade levels could change, for example, rather than an almost imperceptible shift in a blockade signals residing near a single blockade value). The technical difficulty is to find molecules whose blockades interact with the channel environment, via short time-scale binding to the channel, or via inherent conformational changes in its high force environment, and that do so at timescales observable given the bandwidth limitations of the device, to obtain a modulation signal. In the DNA-hairpin based experiments, the sensing moieties are bound to DNA hairpins selected to have very sensitive, rapidly changing, blockade signals due to their interaction kinetics with the channel environment.

Proof-of-Concept Experiments with Y-Annealing Transducer and Chaotropic Agents.

A preliminary test of DNA annealing has been performed with a Y-shaped DNA transduction molecule engineered to have an eight-base overhang for annealing studies. A DNA hairpin with complementary 8 base overhang is used as the binding partner. FIG. 5 shows the binding results at the population-level (where numerous single-molecule events are sampled and identified), where the effects of binding are discernible, as are potential isoforms, and the introduction of urea at 2.0 M concentration is easily tolerated.

The Y-SNP Transducer in Y-SNPtest Complex Detection, with Chaotropic Agents.

A preliminary test of DNA SNP annealing can be done with the Y-shaped DNA transduction molecule shown in FIG. 6.B, which is minimally altered from the Y-annealing transducer introduced in FIG. 6.A.

The NTD modulator is engineered, or selected, such that there is a clear change in the modulatory blockade signal it produces upon change of its state. Linking antibody to a channel-modulator in the NTD construction process, however, may be unnecessary for some antibodies as the antibodies themselves can directly interact with the channel and provide the sensitive “toggling blockade” signal needed. We then observe that binding of antigen by the antibody can be observed as a change in that “toggling,” (see Sec. II Proof of Concept Experiments). Further details on antibody linkage to modulator. or antibodies being modulators on their own, are given in the Parent Patent, and described in the Proof-of-Concept experiments listed in Sec. II below.

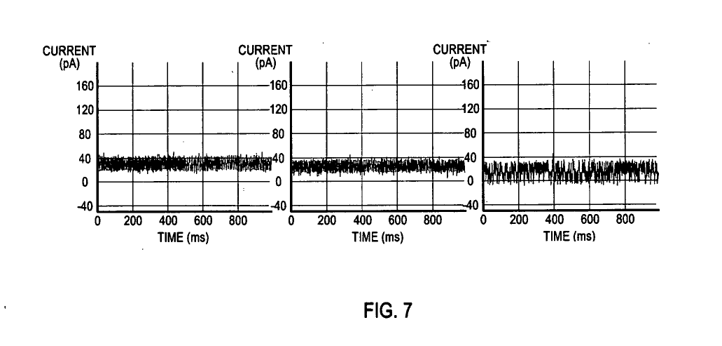

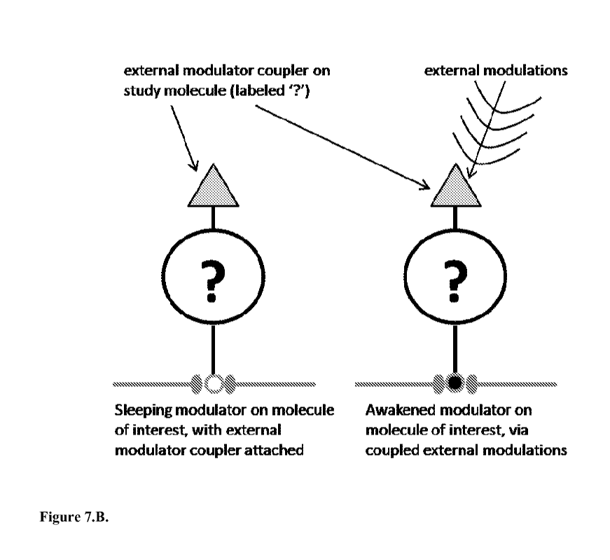

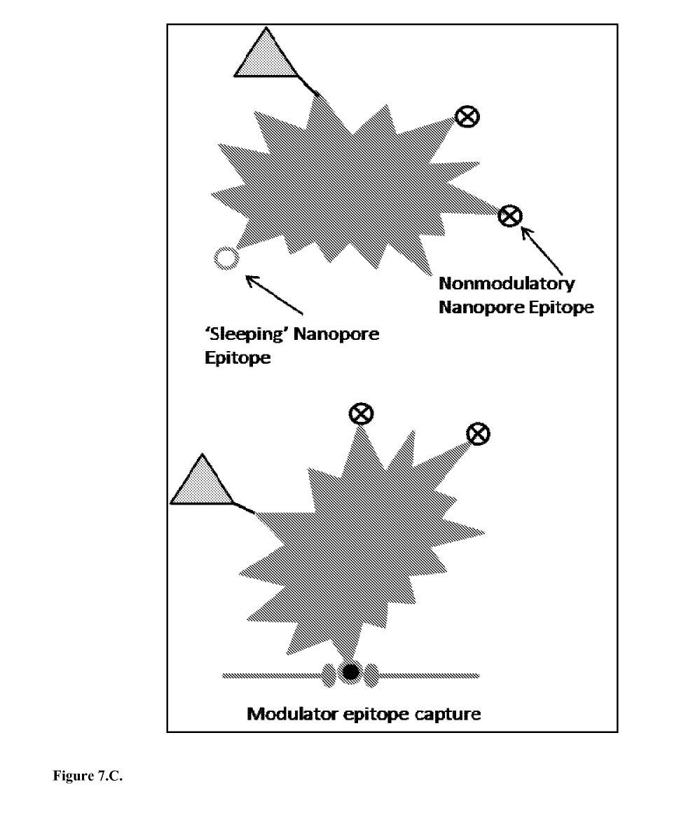

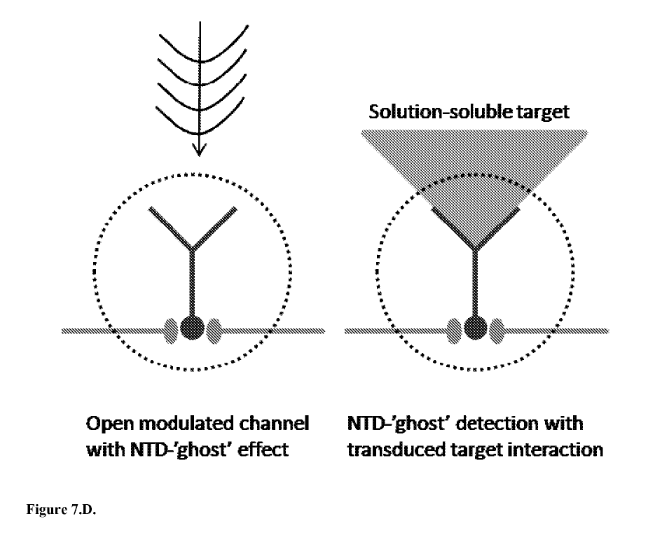

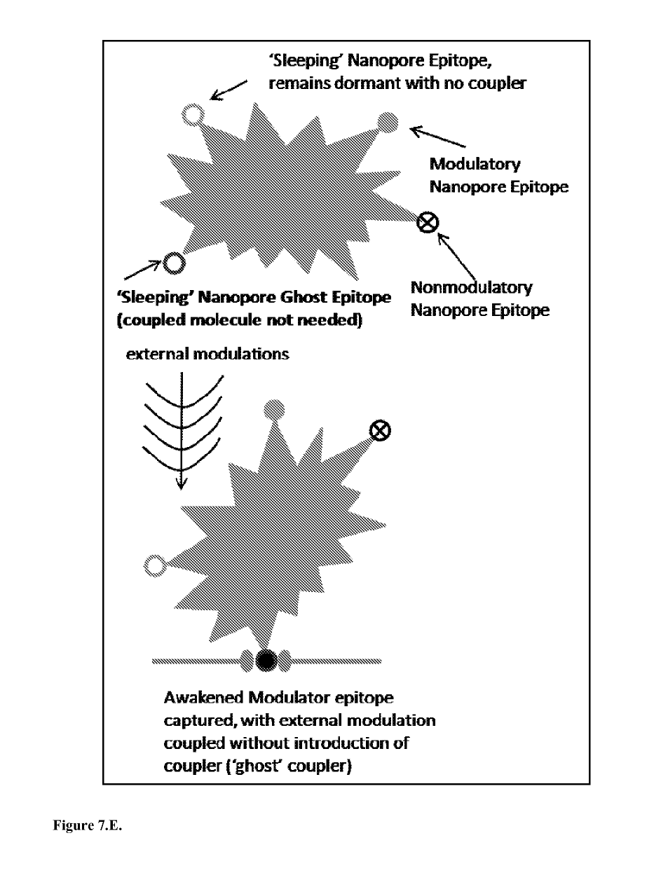

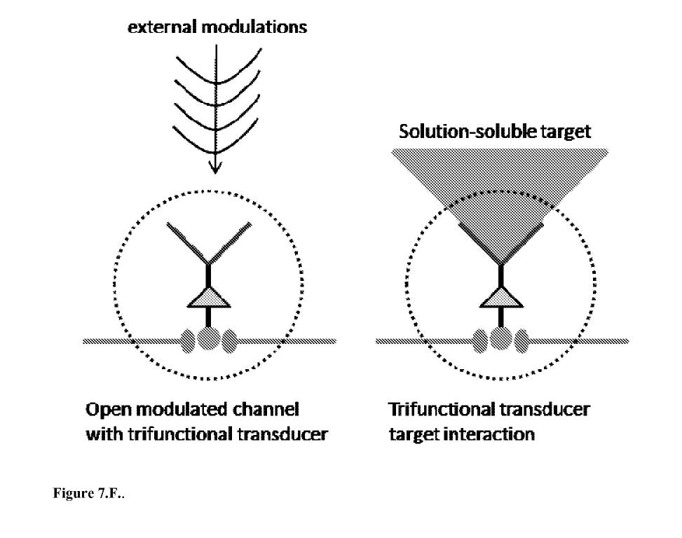

It is possible to probe higher frequency realms than those directly accessible at the operational bandwidth of the channel current based device, or due to the time-scale of the particular analyte interaction kinetics, by introducing modulated excitations. This can be accomplished by chemically linking the analyte or channel to an excitable object, such as a magnetic bead, under the influence of laser pulsations. In one configuration, the excitable object can be chemically linked to the analyte molecule to modulate its blockade current by modulating the molecule during its blockade. In another configuration, the excitable object is chemically linked to the channel, to provide a means to modulate the passage of ions through that channel. In a third experimental variant, the membrane is itself modulated (using sound, for example) in order to effect modulation of the channel environment and the ionic current flowing though that channel. Studies involving the first, analyte modulated, configuration (FIG. 7), indicate that this approach can be successfully employed to keep the end of a long strand of duplex DNA from permanently residing in a single blockade state. Similar study of magnetic beads linked to antigen may be used in the nanopore/antibody experiments if similar single blockade level, “stuck,” states occur with the captured antibody (at physiological conditions, for example). Likewise, this approach can be considered for increasing the antibody-antigen dissociation rate if it does occur on the time-scale of the experiment. It may be possible, with appropriate laser pulsing, or some other modulation, to drive a captured DNA molecule in an informative way even when not linked to a bead, or other macroscopic entity, to strongly couple in that laser (or other) modulation.

### NTD Operation:

There are, thus, two ways to functionalize measurements of the flow (of something) through a ‘hole’: (1) translocation functionalization; and (2) transduction functionalization. The translocation functionalizations in the literature are typically a form of a ‘Coulter Counter’ that measures molecules non-specifically via pulses in the current flow through a channel as each molecule translocates, where augmentations with auxiliary molecules have been introduced. The auxiliary molecules introduced in the published literature are typically covalently bound, or, if not, are designed to be relatively ‘fixed’ nonetheless, such that detection events consist of comparatively brief duration events typically at fixed blockade level. What we describe here is a transduction functionalization to the ‘hole’, where a nanometer-scale hole with transducer molecules is used to measures molecular characteristics indirectly, by using a reporter molecule that binds to certain molecules, with subsequent distinctive blockade by the bound, or unbound, molecule complex (or other, state-reporting configurations, in general). One example transducer, described in the Proof-of-Concept Section, is a channel-captured dsDNA “gauge” that is covalently bound to an antibody. The transducer is designed to provide a blockade shift upon antigen binding to its exposed antibody binding sites. The dsDNA-antibody transducer description then provides a general example for directly observing the single molecule antigen-binding affinities of any antibody in single-molecule focused assays, as well as detecting the presence of binding target in biosensing applications.

When the extra-channel states correspond to bound/unbound, there are two protocols for how to set up the NTD platform: (1) observe a sampling of bound/unbound states, each sample only held for the length of time necessary for a high accuracy classification. Or, (2), hold and observe a single bound/unbound system and track its history of bound/unbound states. The single molecule binding history in (2) has significant utility in its own right, especially for observation of critical conformational change information not observable by any other methods. The ensemble measurement approach in (1), however, is able to benefit from numerous further augmentations (see Sec. III and IV), and can be used with general transducer states, not just those that correspond to a bound/unbound extra-channel states.

In ensemble measurements, the pattern recognition informed (PRI) sampling on molecular populations provides a means to accelerate the accumulation of kinetic information in many situations. Furthermore, the sampling over a population of molecules is the basis for introducing a number of gain factors. In the ensemble detection with PRI approach [PRI], in particular, one can make use of antibody capture matrix and ELISA-like methods [see the TERISA Patent], to introduce two-state NTD modulators that have concentration-gain (in an antibody capture matrix) or concentration-with-enzyme-boost-gain (ELISA-like system, with production of NTD modulators by enzyme cleavage instead of activated fluorophore—further details in Sec. III). In the latter systems the NTD modulator can have as ‘two-states’, cleaved and uncleaved binding moieties. UV- and enzyme-based cleavage methods on immobilized probe-target can be designed to produce a high-electrophoretic-contrast, non-immobilized, NTD modulator, that is strongly drawn to the channel to provide a ‘burst’ NTD detection signal.

A multi-channel implementation of the NTD can be utilized if a distinctive-signature NTD-modulator on one of those channels can be discerned (the scenario for trace, or low-concentration, biosensing). In this situation, other channels bridging the same membrane (bilayer in case of alpha-hemolysin based experiment) are in parallel with the first (single) channel, with overall background noise growing accordingly. In the stochastic carrier wave encoding/decoding with HMMD, for example, we retain strong signal-to-noise, such that the benefits of a multiple-receptor gain in the multi-channel NTD platforms can be realized (see Proof-of-Concept in Sec. II, and Sec. III for further details).

### NTD Signal Processing:

In NTD signal processing we use the CCC implementation/application of the stochastic sequential analysis (SSA) protocol that is described in Part III.B, where it builds from the Parent Patent and the CCC augmentations indicated in [NTD-Add]. There are many implementations possible, the NTD operation, for example, could involve specially designed ‘carrier references’ [NTD-Add] and PRI sampling [PRI] for device stabilization during sampling processes. The SSA Protocol (see Sec. III.B and [CIP#2]) can be implemented as a server/database/machine-learning system in the CCC applications, for example, as has been done in proof-of-concept experiments (see Sec. II.B). The CCC applications use efficient database constructs and database-server constructs, comprising, among other things, the stochastic carrier and other HMMBD augmentations (see also the HMMBD Patent) to the CCC implementation.

In the NTD experiments the molecular dynamics of the captured transducer molecule is typically engineered to provide a unique stochastic reference signal for each of its states. In many implementations with the NTD platform the sensitivity increases with observation time, allowing for highly detailed signal characterizations. Changes in blockade statistics, coupled to sophisticated signal processing protocols, provides the means for a highly detailed characterization of the interactions of the transducer molecule with molecules in the surrounding (extra-channel) environment.

The adaptive machine learning algorithms for real-time analysis of the stochastic signal generated by the transducer molecule are critical to realizing the increased sensitivity of the NTD and offer a “lock and key” level of signal discrimination. The transducer molecule is specifically engineered to generate distinct signals depending on its interaction with the target molecule. Statistical models are trained for each binding mode, bound and unbound, by exposing the transducer molecule to high concentrations of the target molecule. The transducer molecule has been engineered so that these different binding states generate distinct signals with high resolution. The process is analogous to giving a bloodhound a distinct memory of a human target by having it sniff a piece of clothing. Once the signals are characterized, the information is used in a real-time setting to determine if trace amounts of the target are present in a sample through a serial, high frequency sampling process.

One advantageous signal processing algorithm for processing this information is an efficient, adaptive, Hidden Markov Model (AHMM) based feature extraction method that has generalized clique and interpolation, implemented on a distributed processing platform for real-time operation. For real-time processing, the AHMM is used for feature extraction on channel blockade current data while classification and clustering analysis are implemented using a Support Vector Machine (SVM). In addition, the design of the machine learning based algorithms allow for scaling to large datasets, real-time distributed processing, and are adaptable to analysis on any channel-based dataset, including resolving complex signals for different nanopore substrates (e.g. solid state configurations) or for systems based on translocation technology.

To provide enhanced, autonomous reliability, the NTD is self-calibrating: the signals are normalized computationally with respect to physical parameters (e.g. temperature, ph, salt concentration, etc.) eliminating the need for physical feedback systems to stabilize the device. In addition, specially engineered calibration probes have been designed to enable real-time self-calibration by generating a standard “carrier signal.” These probes are added to samples being analyzed to provide a run-by-run self-calibration. These redundant, self-calibration capabilities result in a device which may be operated by an entry level lab technician.

NTD Deployment:

Computational methods and deployment details shown here are also described in the Parent Patent. One CCC protocol is described in Sec. III.B of the present patent, with different implementations throughout and better results in some cases (see Proof-of-concept Results and improvements in Sec. II).

Although the nanopore transduction detector can be a self-contained ‘device’ in a lab, external information can be used, for example, to update and broaden the operational information on control molecules (‘carrier references’). For the general ‘kit’ user, carrier reference signals and other systemically-engineered constructs can be used, for example, for a wide range of thin-client arrangements (where they typically have minimal local computational resource and knowledge resource). The paradigm for both device and kit implementations involve system-oriented interactions, where the kit implementation may operate on more of a data service/data repository level and thus need ‘real-time’ (high bandwidth) system processing of data-service requests or data-analysis requests. Although not as system-dependent on database-server linkages, the more self-contained ‘device’ implementation will still typically have, for example, local networked (parallelized) data-warehousing, and fast-access, for distributed processing speedup on real-time experimental operations.

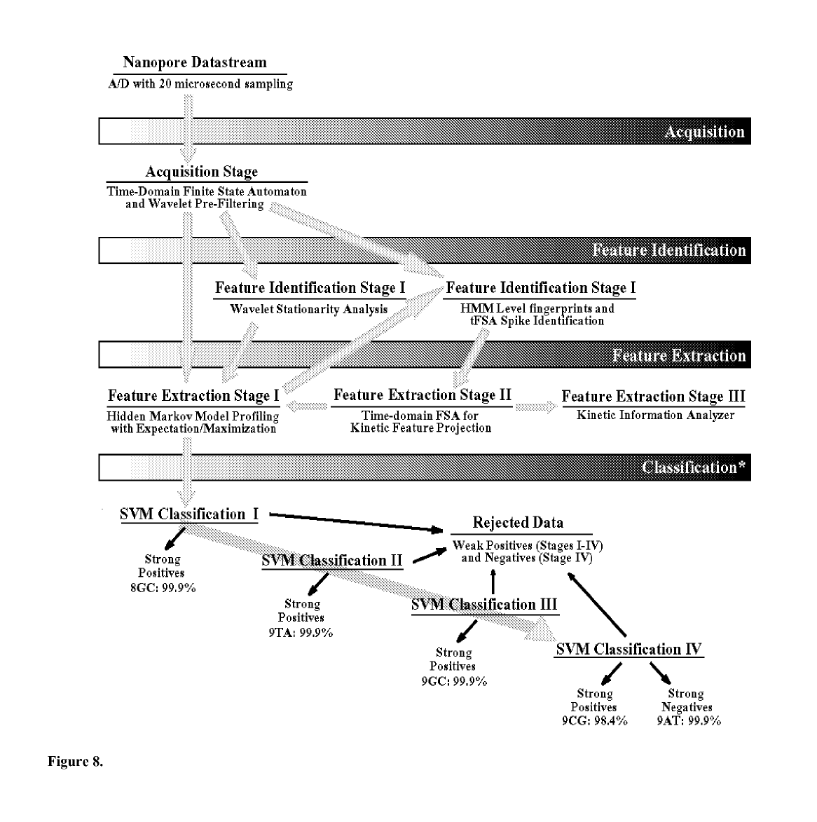

FIG. 8 shows a prototype signal processing architecture useful in the present invention. The processing is designed to rapidly extract useful information from noisy blockade signals using feature extraction protocols, wavelet analysis, Hidden Markov Models (s) and Support Vector Machines (SVMs). For blockade signal acquisition and simple, time-domain, feature-extraction, a Finite State Automaton (FSA) approach is used that is based on tuning a variety of threshold parameters. The utility of a time-domain approach at the front-end of the signal analysis is that it permits precision control of the acquisition as well as extraction of fast time-scale signal characteristics. A wavelet-domain FSA (wFSA) is then employed on some of the acquired blockade data, in an off-line setting. The wFSA serves to establish an optimal set of states for on-line HMM processing, and to establish any additional low-pass filtering that may be of benefit to speeding up the HMM processing.

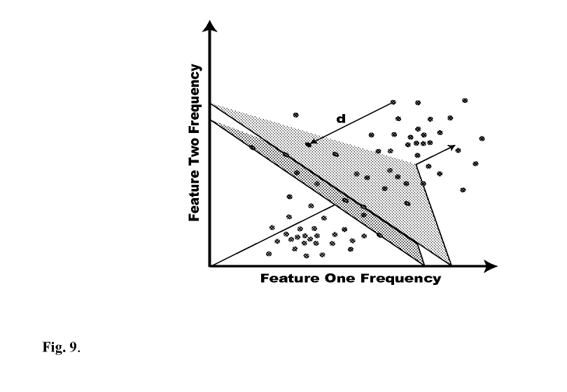

Classification of feature vectors obtained by the HMM (for each individual blockade event) is then done using SVMs, an approach which automatically provides a decision hyperplane (see FIG. 9) and a confidence parameter (the distance from that hyperplane) on each classification. SVMs are fast, easily trained, discriminators, for which strong discrimination is possible (without the over-fitting complications common to neural net discriminators).

Different tools may be employed at each stage of the signal analysis (as shown in FIG. 8) in order to realize a robust (and noise resistant) tools for knowledge discovery, information extraction, and classification. Statistical methods for signal rejection using SVMs are also be employed in order to reject extremely noisy signals. Since the automated signal processing is based on a variety of machine-learning methods, it is highly adaptable to any type of channel blockade signal. This enables a new type of informatics (cheminformatics) based on channel current measurements, regardless of whether those measurements derive from biologically based or a semiconductor based channels.

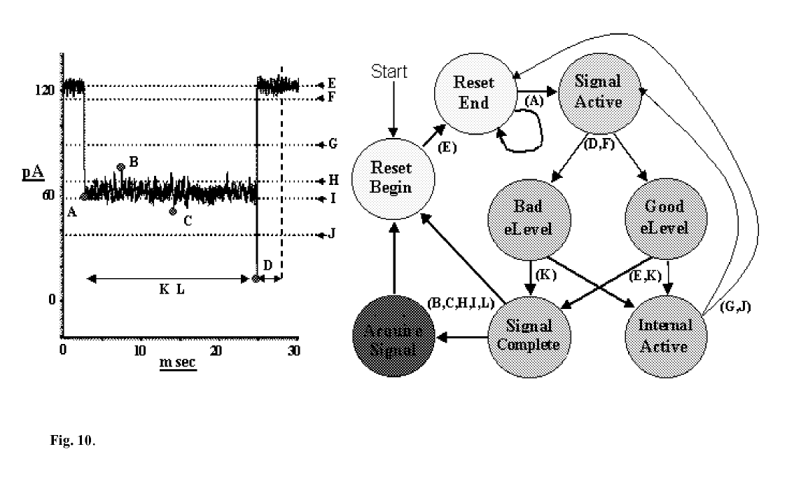

Extraction of kinetic information begins with identification of the main blockade levels for the various blockade classes (off-line). This information is then used to scan through already labeled (classified) blockade data, with projection of the blockade levels onto the levels previously identified (by the off-line stationarity analysis) for that class of molecule. A time-domain FSA performs the above scan and the general channel current blockade signal acquisition (FIG. 10), and uses the information obtained to tabulate the lifetimes of the various blockade levels.

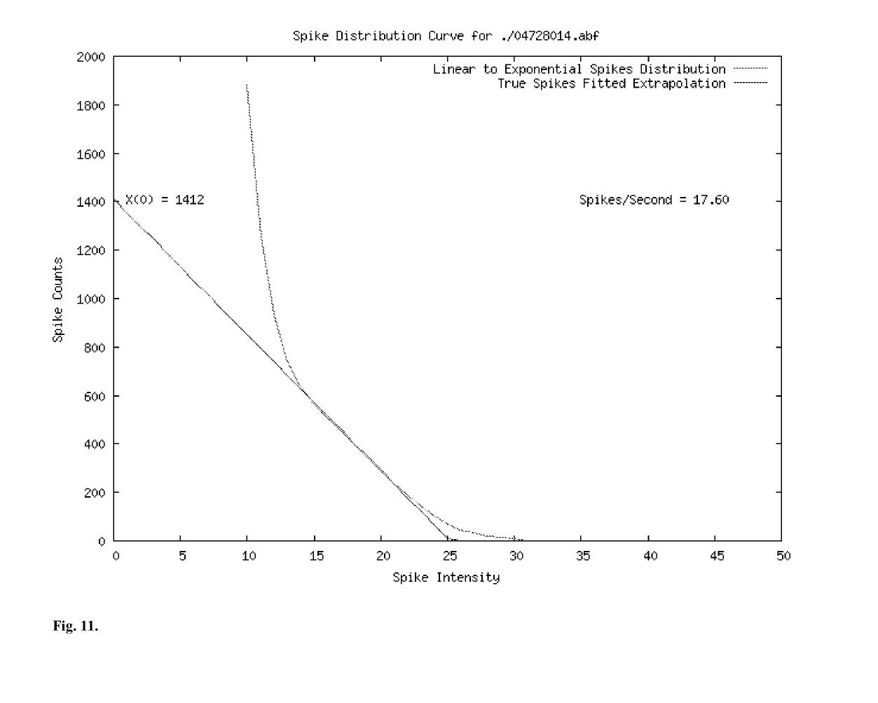

Once the lifetimes of the various levels are obtained, information about a variety of kinetic properties is accessible. If the experiment is repeated over a range of temperatures, a full set of kinetic data is obtained (including “spike” feature density analysis, as shown in FIGS. 11 & 12). This data may be used to calculate kₒₙ and k_{off} rates for binding events, as well as indirectly calculate forces by means of the van't Hoff Arrhenius equation.

In FIG. 1 and FIG. 8, each 100 ms signal acquired by the time-domain FSA consists of a sequence of 5000 sub-blockade levels (with the 20 μs analog-to-digital sampling). Signal preprocessing is then used for adaptive low-pass filtering. For the data sets examined, the preprocessing is expected to permit compression on the sample sequence from 5000 to 625 samples (later HMM processing then only required construction of a dynamic programming table with 625 columns). The signal preprocessing makes use of an off-line wavelet stationarity analysis.

With completion of preprocessing, an HMM is used to remove noise from the acquired signals, and to extract features from them (Feature Extraction Stage, FIG. 8). The HMM is, initially, implemented with fifty states in this embodiment, corresponding to current blockades in 1% increments ranging from 20% residual current to 69% residual current. The HMM states, numbered 0 to 49, corresponded to the 50 different current blockade levels in the sequences that are processed. The state emission parameters of the HMM are initially set so that the state j, 0<=j<=49 corresponding to level L=j+20, can emit all possible levels, with the probability distribution over emitted levels set to a discretized Gaussian with mean L and unit variance. All transitions between states are possible, and initially are equally likely. Each blockade signature is de-noised by 5 rounds of Expectation-Maximization (EM) training on the parameters of the HMM. After the EM iterations, 150 parameters are extracted from the HMM. The 150 feature vector components are extracted from parameterized emission probabilities, a compressed representation of transition probabilities, and use of a posteriori information deriving from the Viterbi path solution. This information elucidates the blockade levels (states) characteristic of a given molecule, and the occupation probabilities for those levels (FIG. 1.A a, lower right), but doesn't directly provide kinetic information. The resulting parameter vector, normalized such that vector components sum to unity, is used to represent the acquired signal during discrimination at the Support Vector Machine stages.

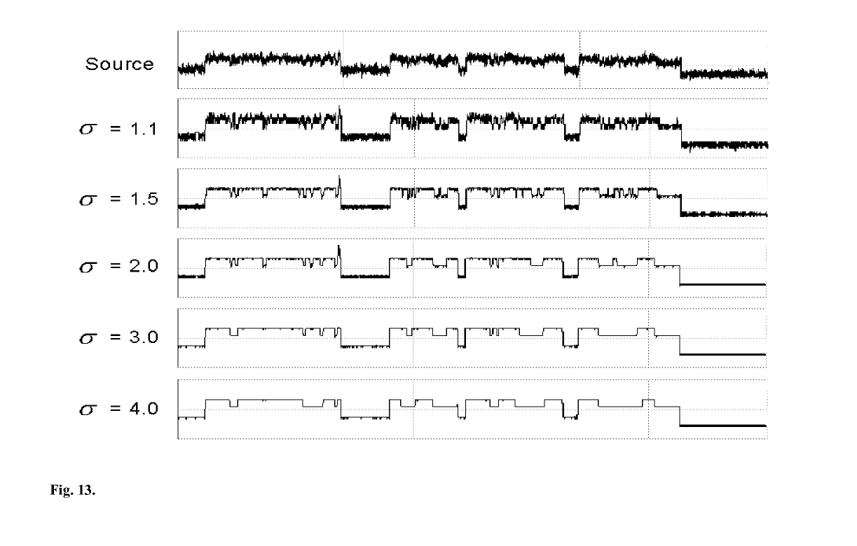

A combination HMM/EM-projection processing followed by time-domain FSA processing allows for efficient extraction of kinetic feature information (e.g., the level duration distribution). FIG. 13 shows how HMM/EM-projection might be used to expedite this process in one embodiment. One advantage of the HMM/EM processing is to reduce level fluctuations, while maintaining the position of the level transitions. The implementation uses HMM/EM parameterized with emission probabilities as gaussians, which, for HMM/EM-projection, is biased with variance increased by approximately one standard deviations (see results shown). This method is referred to as HMM/EM projection because, to first order, it does a good job of reducing sub-structure noise while still maintaining the sub-structure transition timing. One benefit of this over purely time-domain FSA approaches is that the tuning parameters to extract the kinetic information are now much fewer and less sensitive (self-tuning possible in some cases).

The classification approach is designed to scale well to multi-species classification (or a few species in a very noisy environment). The scaling is possible due to use of a decision tree architecture and an SVM approach that permits rejection on weak data. SVMs are usually implemented as binary classifiers, are in many ways superior to neural nets, and may be grouped in a decision tree to arrive at a multi-class discriminator. SVMs are much less susceptible to over-training than neural nets, allowing for a much more hands-off training process that is easily deployable and scalable. A multiclass implementation for an SVM is also possible—where multiple hyperplanes are optimized simultaneously. A (single) multiclass SVM has a much more complicated implementation, however, is more susceptible to noise, and is much more difficult to train since larger “chunks” are needed to carry all the support vectors. Although the “monolithic” multiclass SVM approach is clearly not scalable, it may offer better performance when working with small numbers of classes. The monolithic multiclass SVM approach also avoids a combinatorial explosion in training/tuning options that are encountered when attempting to find an optimal decision tree architecture. The SVM's rejection capability often leads to the optimal decision tree architecture reducing to a linear tree architecture, with strong signals skimmed off class by class. This would prevent the aforementioned combinatorial explosion if imposed on the search space.

Two important engineering tasks can be addressed in a practical implementation of a class Independent HMM to extract kinetic information from channel current data: (i) the software should require minimal tuning; and (ii) feature extraction should be accomplished in approximately the same 100 ms time span as the blockade acquisition. (The latter, approximate, restriction was successfully implemented for the 300 ms voltage-toggle duty cycle used in the prototype.) The feature extraction tools used to extract kinetic information from the blockade signals will include finite-state automata (FSAs), wavelets, as well as Hidden Markov Models (HMMs). Extraction of kinetic information from the blockade signals at the millisecond timescale for objectives (i) and (ii) are addressed by use of HMMs for level identification, HMM-Ems and HMMD/EVA for level projection, and time-domain FSAs for processing of the level-projected waveform.

Development of Class Dependent HMM/EM and NN algorithms to extract transient-kinetic information. If separate HMMs are used to model each species, the multi-HMM/EM processing can extract a much richer set of features, as well as directly provide information for blockade classifications. The multiple HMM/EM evaluations, however, on each unknown signal as it is observed, represent a critical non-scaling engineering trade-off. The single-HMM/EM approach is designed to scale well to multiple species classification (or a few species in a very noisy environment) because a single HMM/EM was used, and the entire discriminatory task was passed off to a decision tree of Support Vector Machines (SVMs). Another benefit of incorporating SVMs for discrimination at this stage is that they provided a robust method for rejecting weak data.

### Part II. Proof of Concept Experiments

### II.A. Nanopore Transduction Detection Proof-of-Concept Experiments

(1) Single-molecule, highly accurate (often>99.9%), classification of very similar molecules is established via discrimination between their different channel modulation signals, as shown in FIG. 1.

(2) Characterization of mixtures of very similar molecules (nine-base-pair-stem DNA-hairpin molecules, that only differ in their terminal base-pairs, in some of the experiments), is shown to inherit the accuracy of the individual classification strength. Highly accurate mixture evaluations are, thus, enabled once the single-molecule classification can be applied in a serial sampling process. This can be improved further with PRI-boosted sampling (see PRI listing in Sec. II and in Sec. III).

(3) Using the channel current cheminformatics (CCC) protocol (an application of the Stochastic Sequential analysis (SSA) protocol to channel current analysis), and inexpensive computational networking and computing hardware, a real-time actively managed NTD experiment was performed to enable the Pattern Recognition Informed (PRI) sampling experiments. This effectively has the channel minimally blocking on further inquiry, i.e., it's effectively always open. This can completely eliminate the limitation of single-channel operations (versus multi-channel), in many situations, including typical biosensing and assaying applications. Anything that enters is quickly identified and ejected, thus the channel is mostly in an acquisition mode. Even if challenged with high concentration of decoys, and short time-frame of response, a known PRI implementation is able to pick out the signal of interest and boost acquisition time on signal of interest almost 100-fold over that of other signals.

(4) The laser modulation experiments described in the Parent Patent, and shown in FIG. 7.A, shows how a fixed blockade signal can be externally driven (by a chopped laser beam in this example) such that channel modulations are ‘awakened’ in the fixed blockade signal in some situations. The awakened signals are not simply related to the driving frequency, but are found to have characteristics known for similar molecule with less ‘fixed’ blockade, and thus are indicative of the molecules interaction with the channel, not just the interaction with the external laser ‘driver’. The DNA hairpins are found to be good modulators stem length 9 or 10 in an embodiment, as the stem length goes from 9 to 11 base-pairs the ‘toggle’ frequency in their blockade signals slows, and when stem length is increased to 20 there is no longer any toggle, just one fixed level of blockade. This is the starting point of the experiments described in FIG. 7.A, where the 20 base-pair stem molecule had its toggle signal ‘reawakened’.

(5) PofC's (1)-(4) help lay the foundation for proof-of-concept on the information flows and signal processing capabilities available. What remains is to demonstrate that discernible signals exist on states of interest in a variety of scenarios by explicit design and testing of NTD-transducers. The first step was to link a DNA hairpin modulator to an antibody that had a large mass target. A DNA hairpin linkage to antibody that targeted a low-mass target is described in the art.

(6) A unique, linear-shaped, NTD-aptamer has been discussed in the art and described to some extent in the Parent Patent. One idea was to directly design the same molecule, entirely DNA-based, that had one end for capture/modulation, and the other end for annealing to other (target) DNA (with different modulation). By this means almost anything tagged with ssDNA, or ssDNA itself (such as for SNP regions, or regions around other single-point mutations), is now detectable via the NTD mechanism.

(7) A unique, Y-shaped, NTD-aptamer is described in the Proof-of-Concept example described in Sec. III. In this experiment a more stable modulator is established using a Y-shaped molecule that has as base the base-pair modulator, and where one arm is loop terminated (such that it can't be captured in the channel), leaving one arm with a ssDNA extension for annealing to complement target (see FIG. 6.A). Further elaboration on ongoing ‘Y-SNP’ DNA annealing experiments is given in FIG. 6.B.

(8) As noted in Sec. I, antibodies can be directly drawn to the channel and are found to interact with it, producing blockade signals of various types, with many of them endowed with useful modulatory structure. Thus, if an antibody can be selected for a particular ‘good modulation’ signal, that is also found to undergo notable change when the antibody's antigen binding target is present (and binding occurs), then we have a situation where we can select our transducer molecule rather than form its equivalent via complicated linker chemistry efforts. I.e., we solve a key aspect of the NTD transducer engineering problem in this scenario if we leverage our classification abilities and PRI selection capabilities to ‘make do’ with the antibodies as is. As a proof-of-concept it was necessary to identify a clear antibody blockade signal that was sufficiently common to be easily reproducible. The experiment was to selectively acquire the antibody capture producing the ‘nice’ toggle signal, and once acquired and a reasonable observation phase completed, to then introduce antigen and look for notable signal changes, where we see such notable changes in at least one embodiment.

(9) The multiple blockade signals seen for highly purified monoclonal antibody molecules, some with ‘good modulatory’ signal blockades (as utilized in (8), in the preceding paragraph), are known. The conceivable hypervariable loops, carboxy termini, and other surface structures that may serve as potential channel blockade sources are simply too few to account for the variety of channel blockade signals observed. If glycations and nitrosilations are thrown in, however, as these would occur naturally in serum blood setting of many of the proteins of interest and of the antibodies studied, then we could easily account for the multitude of signal seen, and how they appear to change—e.g., more complex heterogeneous mixtures of the molecular signal classes, and associated protein glycoforms, appear to result over time. What this indicates is that the nanopore assay of blockade signals provides a means to directly assay the protein glycoforms and other variants that are present. (This can be done directly, as described, or indirectly with introduction of binding intermediaries (the full NTD biosensing setup) for specialized glycoprotein features of interest (such as the HbA1c target site on glycated hemoglobin).)

(10) The NTD experiment with biotin as binding moiety, and streptavidin as binding target, is examined in the experiment described in connection with FIGS. 3 & 4 above. This Proof-of Concept result is also described in Sec. I of this document.

(11) Concentration experiments are explored for the biotinylated DNA hairpin. The proof-of-concept for linear increase in signal occurrence for linear increase in concentration, when at sufficiently low concentrations. This Proof-of Concept result is also described in Sec. I.

(12) Experiments have been performed over a range of applied voltages. A higher voltage leads to a higher rate of signal capture, and when captured, the modulatory signals are found to toggle at a faster toggle rate. Faster toggle rates are also observed for captures at higher temperatures as well. The proof-of-concept for the linear response regime of the modulatory signals has been seen in the Lab Data.

(13) Evidence of enzyme activity is explored in cases where a captured DNA molecule is designed to offer a consensus binding site (for HIV integrase, in one case, and a transcription factor in the other case).

(14) Evidence of the ability to observe single-molecule conformational changes, via changes in channel blockade modulatory signal analysis, has been seen.

(15) Application of the CCC signal processing tools in various settings has been done.

(16) The functioning of the channel-based detector in other buffer environments may also be relevant. The alpha-hemolysin detector is found to tolerate a wide range of chaotropic agents to high concentration (see Sec. I), and even more so if a modulator is resident in the channel. In the annealing data shown in FIG. 6 this is convenient as a 2M concentration of urea is found to benefit a more orderly, collective annealing response (with less local structure kinking).

(17) The NTD experimental setup sometimes results in two or three channels formed at the final setup step, not the one typically sought. On these occasions control molecules were typically introduced to examine the signal recognition capabilities that could be carried over to multi-channel. This is in the Lab Data but not prepared in any way. From looking at the single hairpin blockade on one of two (or three) channels present, it is clear that similar, simple, observation of appropriate toggle-frequency signals, with rescaling as necessary, can lead to signal resolution in situations with up to roughly 10 channels. Beyond 10 channels visual, and simple trigger-based acquisition, will no longer suffice, but HMM feature extraction may be able to, with sufficient observation time, and sufficiently stationary signal statistics overall.

(18) PEG (poly-ethylene glycol) is introduced with various lengths (molecular weights) so as to introduce viscosity and volume-displacement filtering effects. Then different species of DNA hairpins were introduced. In experiments referred to as the “PEG shift” experiments, the molecular mixture was observed under conditions where PEG was present, or not, and the detection-rate shift amounts for the different molecular species are ordered to provide a gel-like ordering of species according to mobility, etc. In the case of voltage change with PEG and other components, IEF-gel like shift experiments can be performed, as detailed in [NTD-Add], and in the Lab Data.

(19) The nucleic acid based biomolecular components the Proof-of-Concept experiments typically have strong charge and hydrophilic properties (under the operational buffer conditions), so stay clear of the bilayer, leading to little bi-layer degradation in typical nucleic acid based experiments. For the protein-based biomolecular components, on the other hand, such as antibodies, some lipophilic interactions exist, such that bi-layer degradation can occur. In nature, some bacteria introduce a sugar-based tiling (‘S-layer’) over their cellular ‘bi-layers’ (membranes) so as to shield and strengthen their bi-layer with a scaffolding of approximately ‘flat’ sugar molecular bridging over the strong lipid polar groups with their resonant ring structures. In order to test our abilities to tolerate very high molar concentration of a simple sugar for similar use in shielding during experimental operations, control molecule signals were sampled under conditions where sugar concentration was increased to 0.5 M sucrose, as shown in our Lab Data.

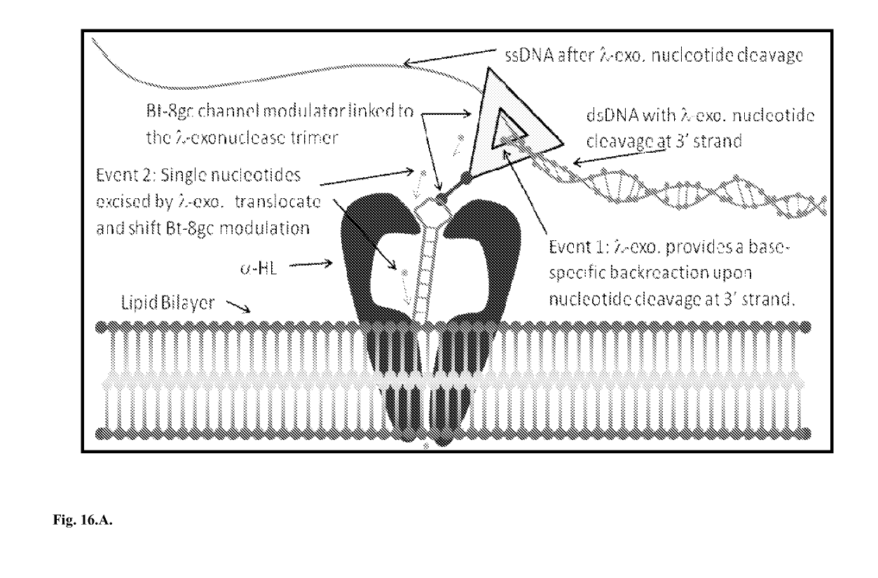

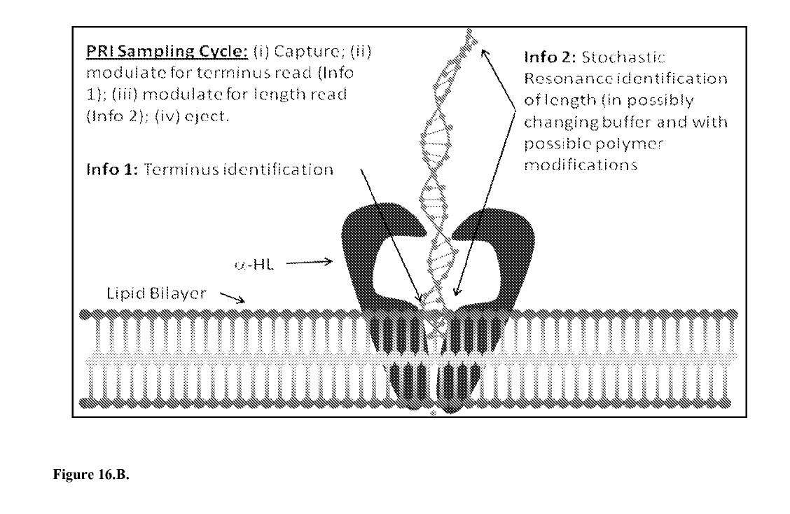

(20) A DNA hairpin channel modulator was examined in the presence of the different species of dNTP monomers as they were drawn to the channel and forced to translocate through that modulated channel (shown in our Lab Data). Some initial success appears to be established, but the use of blunt-ended DNA molecules, and shorter DNA modulators (for greater residual current, thus greater dynamic range on monomer signals during translocation), appear to be suggested. The initial Proof-of-concept for sequencing via a modulator attached to lambda-exonuclease is established (see FIG. 16.A, and the Enzyme Patent for details), where the lambda exonuclease acts upon a DNA strand by clipping off dNTP bases the prospect of detecting simultaneity of translocation-disruption and NTD event is now strengthen as we know we can discern individual translocation-disruption events.

(21) Numerous experiments in the Lab Data have been performed with references molecules mixed in, with their occasional capture blockades used to track the biosensor state itself, and possible need for calibration.

(22) Numerous different bi-layer constituents and mixtures have been attempted. Similarly for choices of channel or of buffer.

(23) Different aperture support areas were prepared, where there was observed to be a trade-off in bi-layer noise and channel formation rate at setup (as aperture diameter reduced), as well as diffusional cross-section flow decrease with decrease in aperture area, where the bilayer area is supported on the aperture.

### II.B. Channel Current Cheminformatics Proof-of-Concept Experiments

(1) The SSA protocol (SSAprotocol.ppt) is applied to CCC to setup the CCC/PRI NTD platform, as described in various forms in Sec. I.

(2) Have proof-of-concept for multichannel signal resolution capabilities from simulations involving high noise (such as that due to multi-channel background noise), resolution of one modulated-channel signal in one thousand (the thousand channel scenario) has been suggested in our Lab Data and the results of others.

(3) Have application of Emission Variance Amplification (EVA) implementation with HMM with duration model—it is found to help produce stronger feature vectors for SVM classification, especially if EVA is stabilized with HMMD (HMM too weak), to enable the results shown in [90], and is shown to aid kinetic feature extraction, among other things. See also the Meta-HMM Patent.

(4) Have application of Emission Inversion with HMM models (with or without duration modeling)—it is found to help produce stronger feature vectors for SVM classification. See also the Meta-HMM Patent.

(5) All implementations of the CCC software involved data schemas designed to lift training data sets, as indicated, directly into fast-memory access regions, and use cache-ing, as needed, at the algorithmic level (in the SVMs, for example), as seen in our Lab Data.

(6) A Proof-of-concept for HMM-template matching has been seen.

(7) An HMMBD implementation (see the HMMBD Patent) is done with pde and zde add-ons.

(8) A distributed processing implementation of an HMM Viterbi algorithm has been established on a variety of datasets to demonstrate proof-of-concept on distributed HMM/Viterbi speed-up capabilities, see [meta-HMM, Sec. (ii) CCC].

(9) Proof-of-concept, and the theoretical foundation, for linear memory HMM implementations are known. (Note: The HMMBD implementation is amenable to the linear memory approach as well, given its structure, so distributed HMMBD is also possible.)

(10) Results of HMM modeling enhancement with pMM/SVM boosting are described in the Meta-HMM Patent.

(11)The enhancement of HMM modeling, via incorporation of side information, is also described in the Meta-HMM Patent. Here the proof-of-concept is algorithmic and is accomplished by lifting duration information as ‘side-information’ via a particular mechanism, to arrive at an HMM-with-duration (HMMD) formalism in agreement with the most efficient, HSMM-based, derivation for the HMMD known. Lifting other types of side-information is now accomplished by ‘piggy-backing’ that side information with the duration side information.

(12) Proof of concept of the multi-track HMM feature extraction is shown in the data provided in the Meta-HMM Patent and has since been performed more comprehensively. There appears to be sufficient support for distinctive and sufficient statistics for an alternative-splice gene structure identifier.

(13) Holistic tuning on the FSA, similar to ORF length cut-off tuning, is performed and shown to be useful in the context of channel current data (see the Parent Patent). Details on the holistic tuning process are given in Sec. III of this document.

(14) Modified Adaboost methods are used in a proof-of-concept experiment on feature selection and ‘data’ (or feature) fusion methods that would inherit the strengths of Adaboost, but not its halting weakness, when halted early and used with a cut-off to retain only the strongest features.

(15) Proof-of-concept for Support Vector Machines (SVMs) with novel, information divergence based kernels, and minor algorithmic tuning at the software implementation level, allows for strong performance, as shown in the Parent Patent.

(16) Proof-of-concept for multiclass discrimination via a collection of binary SVM classifiers in a trained and tuned Decision Tree, where each tree node involves a binary SVM ‘decision’.

(17) Proof-of-concept for multiclass discrimination via a single, multiclass, SVM classifier.

(18) Proof-of-concept for SVM learning in noisy data (such as occurs in bag learning): an SVM training process is performed on strong confidence data, which is used as a classifier on remaining data, which in turn is used as a retraining basis on the classifier. This staged learning process ‘bootstraps’ into an optimal solution quickly in the presence of significant noise, and is used in numerous tests in our Lab Data.

(19) SVM learning occurs with parameter shattered sub-classes with multi-day/multi-detector data, as occurs in channel current analysis examined in the proof-of-concept data-analysis experiments described in the Parent Patent. A binary classification on two species, for example, might appear as two large clusters in feature space, more easily separable, when working with data from a single-operation/single-detector. When using multi-day/multi-detector data, the two species of blockade classes might still be strongly separable in feature space, but there may be clear sub-clustering within each class in association with data from different single-operation/single-detector experiments (seen in our Lab Data). The different single-operation/single-detector experiments have small variation in various buffer (pH, salt concentration, etc.), temperature, and noise isolation, etc., giving rise to the operational constraints on a robust statistical learning process, i.e., ‘training’, and use of data schemas to handle the training and staging of learning as indicated here.

(20) Distributed SVM learning is possible via chunking if care is taken in handling the support vectors distilled from each chunk, as well as other types of training data, that must be passed onto further rounds of chunked training in a reductive process that eventually arrives at only one training chunk, whose discriminating hyperplane classifier solution is taken as the overall classification solution for all chunks (or a strong seed for further bootstrap re-training). In essence, pure support vector passing is insufficient for good learning convergence and stability, where trace amounts of other SVM-identified feature vector types are also needed (analogous to needing vitamins in a healthy diet), and the discovery and identification of amounts of those ‘vitamins’ is what is examined in the preprint. A distributed SVM preprint [distSVM] is included by reference where the proof-of-concept experimental results are shown, as well as the ‘support vector reduction’ (SVR) method that can be employed to facilitate the chunking process.

(21) SVM-based clustering is bootstrapped from applying an SVM learning process to randomly labeled data. The SVM learning process is repeatedly attempted (with different random labeling on the data each time) until a convergence is achieved. After the first convergence labels are flipped according to criteria that, among other things, strengthens the convergence of the SVM on further iterations (such that convergence to solutions on repeated SVM learning on the label-flipped data sets is guaranteed to converge). Once the SVM re-label and re-train process arrives at a stable, highly separable, solution on the labels provided, a clustering solution has been effectively obtained. The proof-of concept for this approach has been seen for simple label-flipping rules. Pushing the forefront of capabilities of the single-convergence approach is then done in the SVM clustering preprint [clustSVM] and is included by reference. In that work SVM re-labeling schemes are driven by sophisticated genetic algorithm and simulated annealing tuning processes. A multiple-convergence approach is described elsewhere herein that may be an advantageous way to perform the SVM-clustering label-flipping protocols and clustering solutions.

(22) Data structures, schemas, and databases, are used to manage the raw data in the FSA, HMM, and SVM ‘learning’ processes, as well as related data extracts (such as the decision hyperplane that is ‘earned, etc.). Most of this work is unpublished but is pervasive in the design and implementation of the machine learning methods employed in our Lab Data Analysis.

(23) Proof-of-concept for the real-time signal processing needed in CCC applications, among others, uses efficient HMM design and implementation to advantage.

(24) Local data structure and distributed learning and overall client/server signal processing architecture is established in proof-of-concept experiments in our Lab Data Analysis.

(25) Web-interfaces to Data, Data Analysis tools, and Visualization tools, are established in proof-of-concept experiments in our Lab Data Analysis and in existing web-interfaces to core machine learning tools have been implemented.

### Part III. Specific Teachings

### Nanopore Transduction Detection—Specific Teachings

### III.A.1 NT-Biosensing Capabilities

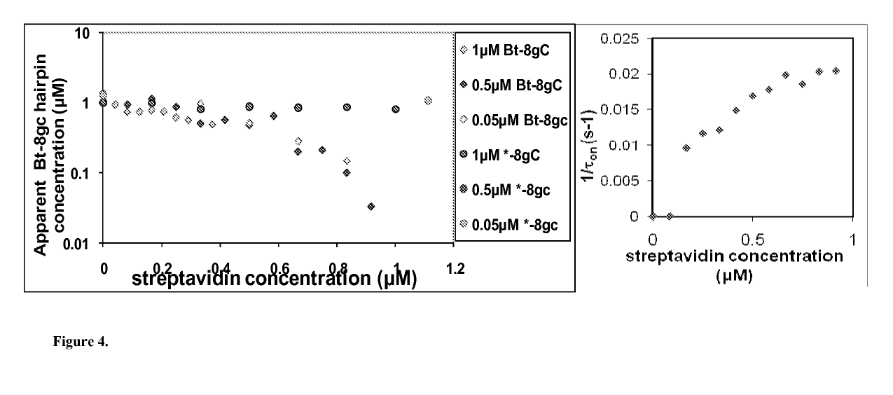

In FIG. 4a a 0.17 μM streptavidin sensitivity is demonstrated in the presence of a 0.5 μM concentration of detection probes, with only a 100 second detection window. The detection probe is the biotinylated DNA-hairpin transducer molecule (Bt-8gc) described in FIG. 1. In repeated experiments, the sensitivity limit ranges inversely to the concentration of detection probes (with PRI sampling) or the duration of detection window. The stock Bt-8gc has 1 mM concentration, so a 1.0 mM probe concentration is easily introduced. (Note: The higher concentrations of transducer probes need not be expensive on the nanopore platform because the working volume can be very small: cis chamber volume is 70 μL, and could be reduced to at least 1.0 μL by using simple microfluidics (e.g., some Teflon and the finest drill bit you can get).) In Table 1 below we show how the current NTD-based biosensing capability is improved, at various stages, with the completion of substrate refinements (immobilized: TARISA/TERISA; and free: E-phi contrast):

TABLE 1
Sensitivity Limits for Steptavidin detection as
Aims or other planned improvements are made.

| METHOD | SENSITIVITY |
|---|---|
| Direct, Low-probe concentration, | 100 nM streptavidin |
| 100 second obs. interval: | sensitivity |
| Direct, High probe intensity, | 100 pM streptavidin |
| 100 second obs. interval: | sensitivity |
| * Direct, High probe intensity, | 100 fM streptavidin |
| long observation interval (~1 dy): | sensitivity |
| Indirect, TARISA (concentration gain), | 100 fM sensitivity limit |
| High probe density, 100 second obs. | |
| ** Indirect, TERISA (enzyme gain), | 100 aM sensitivity limit |
| High probe-substrate density, 100 second obs. | |
| Electrophoretic contrast gain, 100 s | 1.0 aM sensitivity limit |
| *** Multichannel, E-phi contrast, TERISA, | 1.0 zM sensitivity limit |
| high probe-substrate, 100 seconds | |

* Have done 1-1.5 day long experiments in other contexts, but not longer. Thus, current capabilities, with no modifications to the NTD platform for specialization for biosensing, can achieve close to 100 fM sensitivity by pushing the device limits and the observation window.
** Only a slow enzyme turnover of 10 per second is assumed. Detection in the attomolar regime is critical for early discovery of type I diabetes destructive processes and for early detection of Hepatitis B. Early PSA detection currently has a 500 aM sensitivity
*** The limit assumes 1000 channels. The biological relevance of zeptomolar concentrations is known in a variety of situations, such as the trace amount of metals present (via metal-responsive transcriptional activators) and for enzyme toxins. For some toxins, their potency at trace amounts precludes their usage in the typical antibody-generation procedures (for mAb's that target that toxin). In this instance, however, aptamer-based methods can still be effective.
Note:
if we eventually reduce to a 1.0 μL analyte detection chamber (as mentioned above this table) then the above methods arrive at the highest sensitivity relevant because at 1.0 zM sensitivity we are able to detect approximately 1 molecule in a 1.0 μL volume.

### III.A.2 Antibody Capture (Also Aptamer-Capture, and MIP Capture) & TERISA

One idea is to couple NTD with antibody capture systems, or any specific-binding capture system (e.g., MIP-capture or aptamer-based capture systems could be used as well, for example) to report on the presence of the target molecules via indirect observation of transduction molecule signals corresponding to UV cleaved NTD ‘substrate’ molecules (that are freed from the capture matrix).

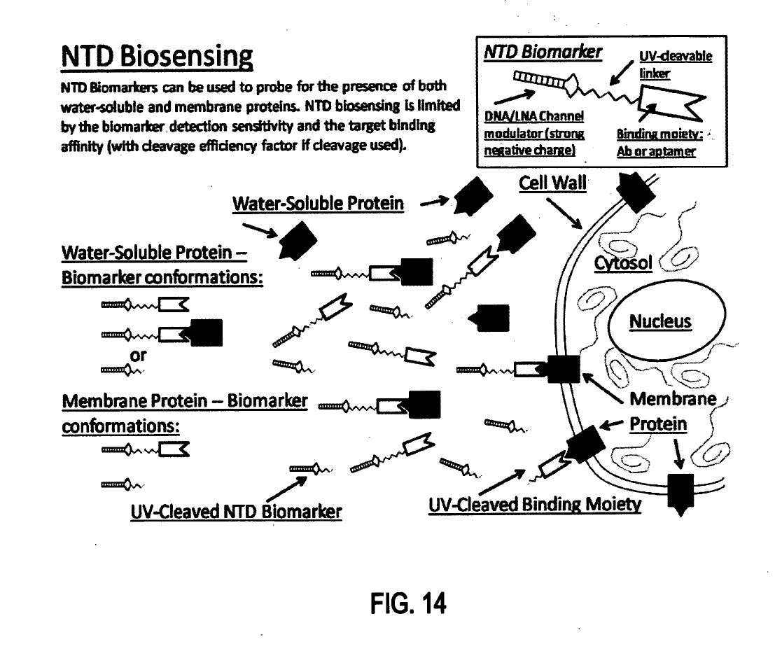

Commercially produced systems are available with matrices pre-loaded with immobilized Fc-binding antibodies, the secondary antibody can then be introduced, and bound by the Fc-binding Ab's, to establish the desired, immobilized, specific-binding matrix (analogous to sandwich-ELISA). If solution with target molecule is now repeatedly washed across the immunosorbant surface, an immobilized concentration of that target molecule can be obtained. We can now introduce our primary antibody that targets the immobilized antigen (‘sandwiching’ it). If the primary antibody can be attached to an NTD Biomarker as shown in FIG. 14 below, where the antibody is linked to a DNA hairpin modulator, and that linkage can be broken upon exposure to UV.

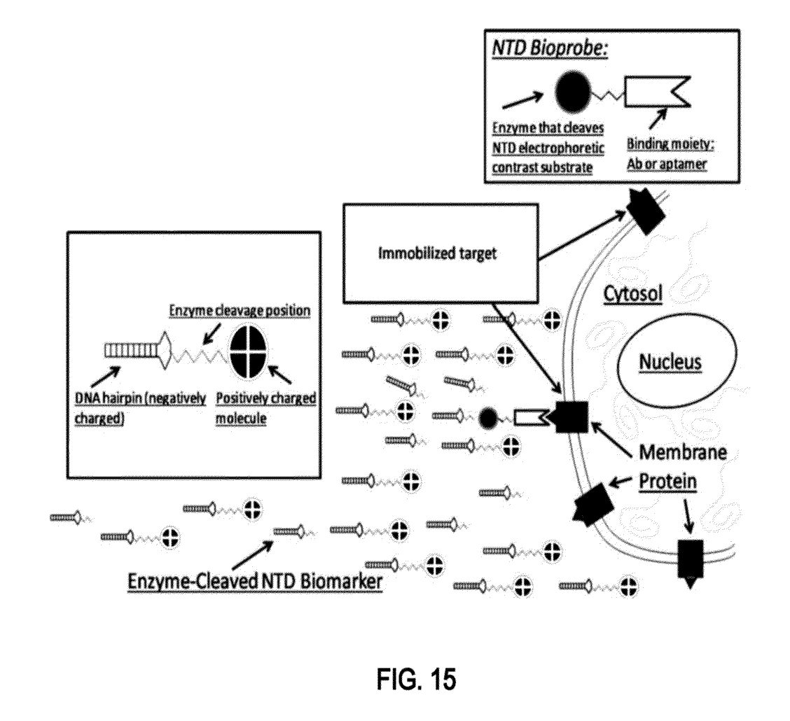

A further novel aspect of this setup is to now have the primary antibody linked to an enzyme that acts on a NTD transducer substrate (analogous to a fluorescent substrate in ELISA). By taking some of the methodology from the ELISA (enzyme-linked immunosorbent assay) approach, and merging it with unique aspects of our nanopore detection approach, we have the ‘Transducer Enzyme-Release with ImmunoAbsorbent Assay’ [in the TERISA Patent], where “Sandwich TERISA” assumed to typically be the case since specific immobilization is desired. This situation is shown in FIG. 15. Also shown in FIG. 15 is an example of an electrophoretic contrast (E-phi contrast) substrate. The idea being to have electro-neutral substrate and upon enzyme cleavage, to leave a highly negatively charged DNA hairpin to be electrophoretically driven (‘report’) to channel.

Analogous to real-time PCR, where a qualitative PCR result is self-calibrated according to is real-time values to obtain a quantitative PCR results, we can do the same with the TERISA and TARISA biosensing methods outlined here. In other words, for all three methods with real-time observation (RT-TARISA, RT-TERISA, E-phi Contrast RT-TERISA), we can shift to a more quantitative footing (as with RT-PCR or RT-ELISA), but in our case this is trivially achieved since the data-acquisition and signal processing is already in use and operating in ‘real-time’. This real-time tracking information helps to stabilize the method and complements the biosensing capability with a quantitative assaying capability (where highly accurate resolution of mixtures of DNA hairpin molecules is possible).

### III.A.3 Single-Molecule Enzyme Study

The NTD approach may provide a good means for examining enzymes, and other complex biomolecules, particularly their activity in the presence of different co-factors. There are two ways that these studies can be performed: (i) the enzyme is linked to the channel transducer, such that the enzyme's binding and conformational change activity may be directly observed and tracked or, (ii) the enzyme's substrate may be linked to the channel transducer and observation of enzyme activity on that substrate may then be examined. Case (i) provides a means to perform DNA sequencing if the enzyme is a nuclease, such as lambda exonuclease. Case (ii) provides a means to do screening, for example, against HIV integrase activity (for drug discovery on HIV integrase inhibitors).

### III.A.4 Multichannel

The S. aureus alpha-hemolysin pore-forming toxin that is used to produce our single-channel nanopore-detector construction is robust in solution as a monomer and reproducible and stable in a bi-layer as a heptamer, automatically self-assembling; it self-oligomerizes to derive the energetics necessary to create a channel through the bi-layer membrane. In the nanopore construction protocol, the process is limited to the creation of a single channel. It is possible to allow the process to continue unabated to create 100 channels or more. The 100 channel scenario has the potential to increase the sensitivity of the NTD, but the signal analysis becomes more challenging since there are 100 parallel noise sources. The recognition of a transducer signal is possible by the introduction of ‘time integration’ to the signal analysis akin to heterodyning a radio signal with a periodic carrier in classic electrical engineering. In order to introduce a ‘time integration’ benefit in the transducer signal, periodic (or stochastic) modulations can be introduced to the transducer environment. In a high noise background, modulations can be introduced such that some of the transducer level lifetimes have heavy-tailed distributions. With these modifications to the signal processing software a single transducer molecule signal could be recognizable in the presence of 100 channels or more. Increasing the number of channels by 100 and retaining the capability of recognizing a single transducer blockading one of those channels provides a direct gain in sensitivity according to the number of channels (e.g., 100 channels would provide a sensitivity boost of two orders of magnitude). It is important to note that this type of increase in sensitivity is implemented computationally and does not add complexity or cost to the NTD device.

### III.A.5 Single-Molecule, Processive, DNA Sequencing

Nanopore transduced DNA-enzymatic activity has the potential to be an inexpensive and versatile platform for DNA sequencing. In the proposed DNA sequencing scenario, the transducer molecule (NTD probe) captured in the nanopore channel is engineered to modulate the channel current with four discernably different signals as the lambda exonuclease processively excises the four different types of nucleotides from a strand of bound duplex DNA.

An NTD experiment has been designed (see FIG. 16.A) to discriminate between the four nucleotides that are excised by lambda exonuclease as it enzymatically and progressively excises the 3′ strand of bound duplex DNA. Other exonucleases are of interest as well but lambda exonuclease is known to work in a broad range of buffer conditions, including the standard buffer conditions used in the NTD platform, with magnesium added as co-factor. DNA sequencing occurs by observing the different back-reaction events (possibly conformational-change mediated) that are observed with an enzyme-coupled NTD probe—according to whether an ‘a’, ‘c’, ‘g’, or ‘t’ is excised. Additionally, the NTD probe can be engineered such that a coincidence detection event is enabled via the associated translocation disturbance associated with the excised nucleotide as it passes through the nanopore channel. We believe that the translocation event alone will not supply enough information to discriminate between the 4 nucleotides.

Experimental results indicate that NTD probes can be clearly discriminated from one another in two-state NTD experiments. For the DNA sequencing configuration above, experiments with the four state-transition signals observed with excision of individual nucleotides have shown discrimination between five different hairpins with 99.9% accuracy, four of which only differed in their terminal base-pairs. Taken together with the preliminary two-state binding results, there are strong indications that the NTD platform could be the basis for a next generation DNA sequencing platform.

DNA-hairpin modulators linked to processive DNA enzymes can report on the binding to DNA substrate and possible enzyme activity with introduction of cofactors such as magnesium. The enzymes listed below are all known to work in buffers compatible with the buffer requirements of the alpha-hemolysin channel heptamer. Items (i)-(iii) to follow are a non-exhaustive listing of possible DNA enzymes to use in the proposed method.
(i). DNA sequencing may be possible via examination of the Klenow fragment (KF) of E. coli DNA polymerase I, which processively grows a dsDNA strand from a dsDNA/ssDNA primer, via terniary complexation with the appropriate matching ‘a’, ‘c’, ‘g’, or ‘t’ from an dNTP substrate that has been introduce (along with magnesium). To the extent that the magnesium acts as an on/off switch for the enzyme, rate control may be best established via concentration control on the dNTPs present. This provides a substrate concentration variable-speed control mechanism.
(ii). DNA sequencing may be possible via examination of the base excision process as source of signal, via use of lambda exonuclease. Now the only cofactor needed is magnesium.
(iii). DNA sequencing may be possible via examination of the base excision process as source of signal, via use of Exo.

If the enzyme is a DNA exonuclease, the excised molecular bases can themselves interact with the channel modulator to produce a synchronization or coincidence detection enhancement to the detection, or be the main detection event for DNA sequencing itself, in some engineered scenarios. Linkage to any enzyme, thus, permits potential direct assays of that enzymes activity in the presence of cofactors. This has direct application in assays to identify molecules that can block HIV integrase activity, among other things (see Sec. III.A.3).

It is possible to develop computational/experimental architectures and machine-learning (ML) based pattern recognition software to perform real-time channel blockade classifications that operates at the single-molecule level. The importance of this can be understood in the context of the single-molecule selection ‘demon’ posited by Maxwell. With such a demon, and some operational idealizations, Maxwell showed how to defy the equilibration of the second law of thermodynamics, and thereby lay the foundation for a perpetual motion device. Here, using artificial intelligence & machine learning methods we are able to establish a single-molecule selection demon such that the channel appears to always be open (in a non-blocking sampling mode), which happens to be critical in high concentration probe experiments (where pushing the biosensing limits). The importance of this selection-activity ‘demon’ capability in the context of the above is that a coincidence coherence/synchronization demon may be critical to having the signal-to-noise for DNA sequencing. The problem with the weaker signal-to-noise may, initially, be due to loss of ‘framing’ information that delineates the different phases of blockade signal. To address this problem, in the case of lambda exonuclease, we can set up signal modeling and signal processing that accounts for two streams of ‘coincidence’ information. The problem is that the ‘coincidence event’, of excision/addition back-reaction accompanied by nucleotide translocation, may not exist for all nanopore detector settings. It may be that the ‘coherence’ of the timing between the two event series (one back-reaction phase changes, the other nucleotide traversal phase changes) may require active feedback by the nanopore detector setup. Fortunately, we have fully enabled the signal processing requirements for the feedback timescales involved, as demonstrated in the PRI Results (see Sec. II), so establishing a coherence stabilization appears to be possible. Control molecules, carrier references, can be introduced as well, to further inform the signal processing, and enable the coherence stabilization that may be needed.

Four-phase resolution may not be possible once the enzyme turnover (processive) rate is increased. In such an instance two-phase resolution might be attempted, for different DNA modifications/buffers/channels so as to recover four-state sequence info from a set of two-state sequencings.

Some processive DNA enzymes may have much more distinctive conformational change than others, according to base polymerization, allowing single-molecule sequencing at the processive rate of the enzyme at that temperature (which typically doubles for every added 10 C above the standard operating temperature of 23 C). By adjusting magnesium concentration and temperature the processive rate could be quite fast, with thousands per second easily possible. Thus, the success of the NTD sequencing approach would present a radically new form of DNA sequencing.

### III.A.6 NTD/Sanger DNA Sequencing

There is a NTD/Sanger sequencing scenario where sequencing is on a Sanger-sequencing type mixture, where copy terminations are designed to be blunt-ended dsDNA rather than DNA with a dye attachment or other expensive linkage. The blunt-ended DNA is then identified by its (blunt-ended) terminal base-pair and by its length, as with Sanger, to arrive at information usable, if complete, to determine the parent sequence. The terminal base pair is classified according to the distinctive blockade signals that captured dsDNA ends can provide (laser, or other, modulations may be needed to excite the captured blunt end to force it to exhibit its blockade toggle signal—this latter technique already done in a proof-of-concept experiment, see Sec. II). The strand length is classified according to channel blockade signal under a variety of nanopore detector modulations (applied potential, laser (electric) pulsing, electromagnetic field modulations, to list a few methods for externally driven modulations).

The basic design of the nanopore detector is a nanometer scale hole, a nanopore, in a biological membrane (see FIG. 2.A, Left). The nanopore detector, under standard operating conditions, has an open-channel ion flow of approximately 120 pA. Reductions and modulations of the channel current, due to direct interaction with a blockading target or due to indirect interaction with a transducer molecule, are then the basis of the analysis that follows. The electrophoresis that drives the ion current also draws in charged molecules like DNA. In FIG. 16.B, is shown a close-up of a nanopore detector channel with segment of dsDNA (double strand DNA) captured at one end. It may be possible to sequence the DNA by using pattern recognition informed sampling on ‘Sanger mixtures’ obtained in the Sanger sequencing protocols, where now, however, electrophoresis is not used to separate the molecules according to length (although this may be still employed to enhance length discrimination as much as convenient). Now the length ‘separation’ is done on a single-molecule pattern-recognition basis, simultaneous with reading the end of the dsDNA molecule. The terminus read-out and length evaluation is obtained from channel current blockade observations during capture of the molecule (FIG. 16.B). The terminus identification is thought to already be possible. Indications that length discrimination may be possible at the level of individual base-pair was indicated by the success of the modulatory approach used in terminus identification. The key aspect of the success of the length discrimination method lies in the fact that the physical mechanism (producing the discriminatory signal found to be useful) need not be understood. Rather, a model-independent machine-learning approach to the signal analysis can latch onto discriminatory aspects of the information. SVM are well-suited for that purpose here, together with feature extraction performed by a HMM.

The idea is to expose the channel to a mixture of PCR amplified DNA sequence with random termination (or other mixture of DNA), that is in a dsDNA annealed form with channel size such that the channel blockades correspond to single, non-translocating, dsDNA blockades (‘captures’) of one end of the dsDNA molecule, while extracting from the blockade channel current signal, a set of one or more pattern features to establish over a period of time either a blockade channel current signal pattern or a change in the blockade channel current signal pattern, with each sampling of the mixture.

Modulation responses may enable the PCR analytes (or any analytes for that matter) to be discerned with better resolution (such as for discerning the length of the captured dsDNA molecules in FIG. 16.B). Modulations serve to sweep through a range of excitations, with response possibly allowing classification of lengths given pre-calibrated (trained on known length) test cases, response also used to establish identity of captured end (terminal base-pair identification, for example).

Also note that very small reagent usage is necessary in NTD/Sanger due to the possible nano-scale reduction in operating analyte chamber volume, competitive with established methods (standard Sanger sequencing) where larger analyte volumes are needed, and more expensive reagents such as dyes (and associated suite of lasers) are required.

### III.A.7 Glycoprotein Assayer

NTD can operate as an HbA1c glycoform assayer to improve the knowledge of hemoglobin biochemistry (and that of heterogeneous, transient, glycoproteins in general). This could have significant medical relevance as a gap exists between what is known about hemoglobin biochemistry and how HbA1c information is used in the management of diabetic patients. The definition of ‘HbA1c’ is complex, as HbA1c is a heterogeneous mixture of non-enzymatically modified hemoglobin molecules (whose concentration in blood is in part genetically determined). In clinical applications, HbA1c is used as if it were single complex with glucose whose concentration is solely influenced by glucose concentration. It may be possible, using an NTD platform, to improve diabetes management by introducing a new assaying capability to directly close the gap between the basic and clinical knowledge of HbA1c.

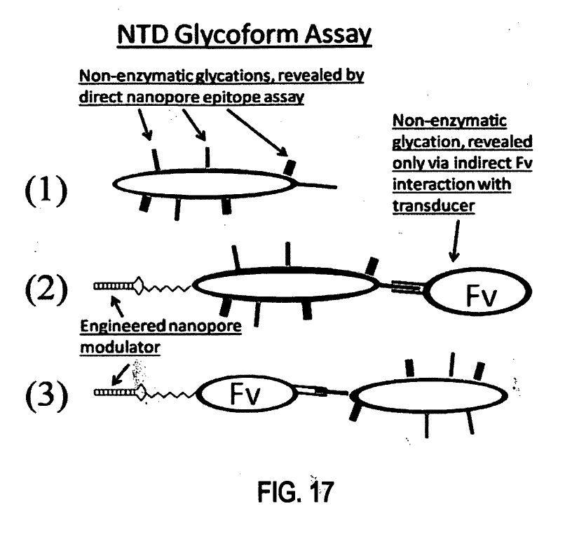

It may be possible, perhaps optimal, to apply NTD in direct nanopore detector-to-target assays in combination with indirect NTD-to-target assays, for purposes of characterizing post-translational protein modifications (glycations, glycosylations, nitrosilations, etc.), see FIG. 17.

The endocrine axis, thyroid stimulating hormone (TSH) in particular, is present as a heterogeneous mixture of TSH molecules with different amounts of glycation (and other modifications). The extent of TSH glycation is a critical regulatory feedback mechanism. Tracking the heterogeneous populations of critical proteins is critical to furthering our understanding and diagnostic capabilities for a vast number of diseases. Hemoglobin molecules provide a specific, on-the-market, example—here extensive glycation is more often associated with disease, where the A1c hemoglobin glycation test is typically what is performed in many over-the-counter blood monitors. The NTD testing of surface features of the protein can be done before or after digestion or other modification of the test molecule as a means to further improve signal contrast on the identity and number of possible protein modifications, as well as other surface features, including possible observation of hypervariable loop mutations that might be captured and characterized by the channel blockades produced.

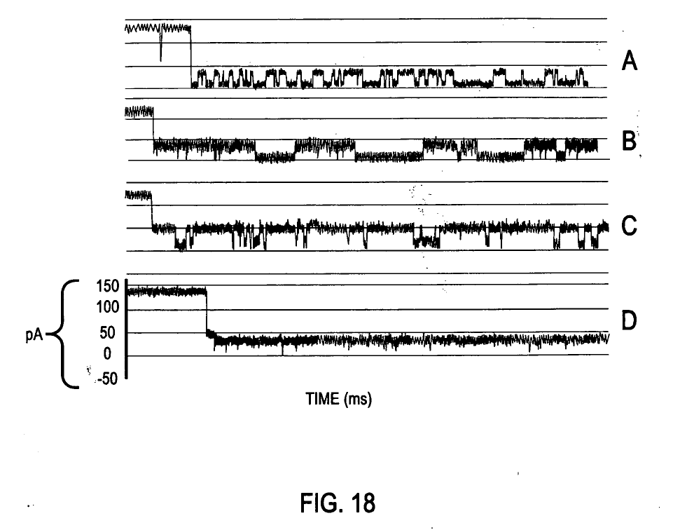

Although some surface features clearly elicit blockade signals that are modulatory (see FIG. 18 and FIG. 2.F), not all surface features of interest will exhibit blockade signals when drawn to the channel and in these instances antibody or aptamer based targeting of those features could be used, where the antibody or aptamer is linked to a channel modulator that then reports on the presence of the targeted surface feature indirectly, e.g., the NT-biosensing setup.

A nanopore-based glycoform assay could be performed on modified forms of the proteins of interest, i.e., not just native, but deglycosylated, active-site ‘capped’, and other forms of the protein of interest, to enable a careful functional mapping of all surface modifications. Pursuant to this, the methodology could also be re-applied with digests of the protein of interest, to further isolate the locations of post-translational modifications when used in conjunction with other biochemistry methods.

Part of the complexity of glycoforms, and other modifications, of proteins such as hemoglobin and TSH, is that these glycoforms are present as a heterogeneous mixture, and it is the relative populations of the different glycoforms that may relate to clinical diagnosis or identification of disease. To this end, a protein's heterogeneous mixture of glycations and other modified forms can be directly observed with a NT-detector, and this constitutes the clinically relevant data of interest, not simply the concentration of some particular glycoform. Furthermore, it is the transient, dynamic, changes of the glycoform profile that is often the data of interest, such that a ‘real-time’ profile of glycoform populations may be of clinical relevance, and obtaining such real-time profiling of modified forms (glycoforms, etc.) would be another area of natural advantage for the NTD approach.

Part of the clinically relevant testing is in response to stimulus (a high-sucrose bolus in the case of a diabetes patient). The methods outlined in the features could all be performed for patients where a stimulus has been introduced, with an expected (healthy) response and the possible disease response. The potential for drug discovery in this setting is profound. Any number of ligands can be tested insofar as their impact on glycoform profiles and other protein modification profiles. Agents could be tested for their ability to increase or decrease non-enzymatic glycation processes. Ligands could be examined for their ability to reduce advanced glycation end-products (AGE products).

The protein modification assays have indirect relevance for biodefense. This is because the degree of glycation of a patients hemoglobin is an early indication of their disease state (if any, or simply ‘glycation’ age otherwise). This is because the hemoglobin that is actively used in transporting oxygen throughout the body is analogous to a ‘canary-in-the-coalmine’ in that it provides an early warning about insipient complications or past chemical or nerve agent exposures. Red blood cells (that carry hemoglobin) typically live for 120 days—providing a 120-day window into past exposures and a 120-day average on the regulatory load induced by those exposures. In the future, if a mysterious gulf-war syndrome is encountered, and there is concern about a low-level exposure to a nerve agent, examining the hemoglobin glycation profiles, and similar profiles on other blood serum constituents, would provide a rapid assessment of biodefense status.

NTD detection and assaying provides a new technology for characterization of transient complexes, with a critical dependence on ‘real-time’ cyberinfrastrucure that is integrated into the nanopore detection method (Sec. III.B.2 describes the machine learning methods for pattern recognition and their implementation on a distributed network of computers for real-time experimental feedback and sampling control.

### III.A.8 Multicomponent Molecular Analyzer

Multi-component regulatory systems and their variations, often sources of disease, could be studied directly, as could multi-component enzyme systems, using the NTD approach. Information at the single-molecule level may be uniquely obtainable via nanopore transduction methods and may provide fundamental information regarding kinetic and dynamic characteristics of biomolecular systems critical in biology, medicine, and biotechnology. The design of higher-order interaction moieties, such antibody with cofactors and adjuvants; or DNA with TFs, opens the possibility of exploring drug design in much more complex scenarios. One simple extension of this is when the multiply interacting site is simple designed to have an affinity gain. The nanopore transduction detector can be operated as a population-based binding assayer (this would provide capabilities comparable to some SPR-based instruments). The NTD method might also be used to resolve critical internal dynamics pathways, such that the impact of cofactors (chaperones) might be assessed for certain folding processes.

### III.A.9 NTD-Gel

Nanopore detectors may offer the separation/identification information of gels but under physiological buffer conditions (in-vivo) and using non-destructive pattern recognition on blockade events to cluster (in-silico).

Enabled by machine-learning based pattern recognition capabilities, nanopore-based electrophoresis methods can be used to discern clusters (like the bands or dots in a gel) in a higher dimensional feature space, for greatly improved cluster resolution (such that isomers might be resolvable, etc.). For a nanopore to offer information equivalent to a gel, however, it must also sample a great number of molecules quickly, this requires active sampling control to optimize—i.e., once the sample molecule is identified it is ejected. To this end, pattern recognition informed sampling has been developed and used to boost the sampling rate on a desired species by two magnitudes over that obtainable with a passive recording (see PRI in Sec. III.B). This lays the foundation for nanopore-based molecular clustering. The separation-based methods still have more information than the separation/grouping of molecules into clusters, however, since they also provide an order of separation, according to mobility, or according to isoelectric point, etc. For the nanopore-based methods to recover this critical ordering information on the observed data clusters something else must be considered. One possibility is the introduction of a mobility reducing agent, such as PEG, into the buffer. The change in average arrival time of the different species after introduction of PEG (using voltage reversal to clear a ‘near-zone’), referred to as the ‘PEG shift’ in [NTD-Add], can then be the basis for an ordering—the least PEG shifted molecules are those, it is hypothesized, with greater mobility and charge (where this is done by comparison of acquisition rates after introduction of PEG and use of voltage control). Just as with gels, all sorts of functionalized PEG, or other functionalized buffer media, can be introduced for different sieving results, and that provides numerous related functionalizations to the nanopore-gel approach.

### III.A.10 DNA Annealing Characterization—Y-SNP

It may be possible to have an assay-type buffer, possibly multi-species/multi-target),containing a mixture of Y-probes of DNA/LNA. The Y-probes can have ssDNA (single strand DNA) ‘wobbly arms’ exposed upon properly-oriented base-capture in the channel (see FIG. 2.J). The wobbly-arm signal would be designed to typically be without significant ‘toggling’ structure (as found to be so useful with DNA-hairpin linked modulators). When a complement to the arms is presented, with one of two SNP variants typically present at the critical Y-nexus, we attempt to engineer/select two modulatory signals—as seen for similar Y-DNA transducers used in Proof-of-Concept experiments listed in Sec. II, and where a DNA mutation or SNP variant is a single mismatch to the Y-probe).

### III.A.11 Nanopore Processing Unit (NPU)

Have actual chemical computation device, where a fully parallelized, ‘chemical’ computation can be ‘loaded’ with choice of buffer and, changes in that buffer, that is sampled with NTD recognition and program/data processing. Akin to efforts in DNA computing, here DNA and DNA synthetics are an excellent material to use in this context, thus the notion of a nanopore processing unit (NPU). The use of multifunctional NTD transducers (as mentioned above) shows that NPU programming puts long instruction-set coding on the same footing as reduced instruction-set coding (RISC), where the latter has been popular with solid-state CPU's due to their less restricted pipelining (since CPU is not truly parallel as with the ‘chemical computing’ measured in the NPU). This doubly emphasizes the possible computational-speed benefits of massive parallel computation in properly programmed/utilized NPU component(s) in a standard computer (akin to the common GPU enhancement in vector processing already complementing CPU functionality). More sensitive TERISA biosensing benefits from the off-channel, fully parallelized, ‘chemical’ computation that is sampled with NTD recognition.

### III.A.12 NTD Device/Kit Construction and Operational Protocol

Using transducer molecules, a nanopore is leveraged into a NTD biosensor according to the methods indicated in the Parent Patent material quoted above. Channel-captured transducer modulations are engineered to give rise to more than one blockade signal type, where the signal types are engineered to correlate with transducer states, as demonstrated in experiments described in what follows, comprising a DNA transducer molecule designed to provide different blockade signatures according to linked binding moiety state being bound/unbound or cleaved/uncleaved, for example.

Device or Kit Materials
Nanopore Transduction Device (NTD): Teflon core with two wells ^{˜}100 μl in volume (cis and trans to aperture), with a small hole at the bottom of each well for the placement of a ^{˜}2.5 inch long Teflon tube which connects the two wells. There is a small hole on the outer side of each well for electrode insertion. In the cis chamber at the end of this tube, a piece of shrinkable Teflon is molded to form a 20-micron opening on a horizontal surface. The U-tube is exposed from beneath to allow illumination of the aperture.
Plus standard commercially available equipment, reagents, and supplies.

### Aperture Production Protocol

We produce our apertures using a thermoplastic material (“heat shrink”, examples: polyolefin, fluoropolymer, PVC, neoprene, silicone elastomer, Viton, PVDF, FEP, to name a non-exhaustive set), that is then mounted on PTFE tubing. Our shrink, slice, withdraw protocol is thought to produce a cusp-like tip, with possible tears or imperfections resulting from the guide-wire withdrawal.
1. Cut a length of U-tubing PTFE 18 about six centimeters long.
2. Cut a length of thin 40 gauge copper wire (0.0031 inch diameter) twice as long as the U-tubing and thread the wire through tubing, allowing 1 cm of wire to protrude beyond the tubing.
3. Cut a piece of the 0.115″ ID heat shrink tubing at least 1 cm in length.
4. Place heat shrink tubing as a sleeve over end of U-tubing. It should be arranged so that half the heat shrink is over the U-tubing and half is over the wire, allowing about ½ centimeter of wire to protrude beyond heat shrink.
5. Heat until clear and tightly shrunk around top of U-tubing. You may use forceps to hold heat shrink in place while heating.
6. Let cool till translucent.
7. Under the dissecting microscope, cut the excess heat shrink tubing and wire, making sure to allow enough material to maintain proper seal and produce working length of aperture tunnel.
8. Gently pull wire from other end with a slow but consistent force to dislodge wire from heat shrink.
9. Inspect the newly created aperture under the dissecting microscope for size and general appearance.
10. Using a microtone blade, gently shave a thin section of heat shrink from the top of aperture to produce clean annulus. Then shave the excess heat shrink tubing from the sides of the U-tubing to make it fit into the nanopore device.
11. Perform a “squirt” test. By attaching the buffer syringe and passing liquid through the tubing, one can inspect for holes caused by shaving and confirm that there is a fine and steady stream from the aperture itself.
12. Finally, QC the aperture in the nanopore system.

### III.A.13 Kit Deployments:

The implementation of the NTD Device can be deployed with a variety of forms of data and analysis dependency (via internet servers) on data repository or analysis service sites. In the kit deployments, in particular (see Sec. III Features), there is the possible of use of specialty buffers, kit constructs (including machined parts), special carrier-reference control molecules, instruction/protocol manual, and data-analysis book. The kit-user would run experiments with signals generated from use of specially ordered buffer and controls, and the analysis of that data would be used to calibrate. i.e., the company service site could be used to calibrate the kit NTD machines (at first use) as well as to perform on-line, ongoing, calibrations, as well as to utilize analysis services with the company server/provider.

### III.B. SSA/CCC Protocol and C&C Methods—Specific Teachings

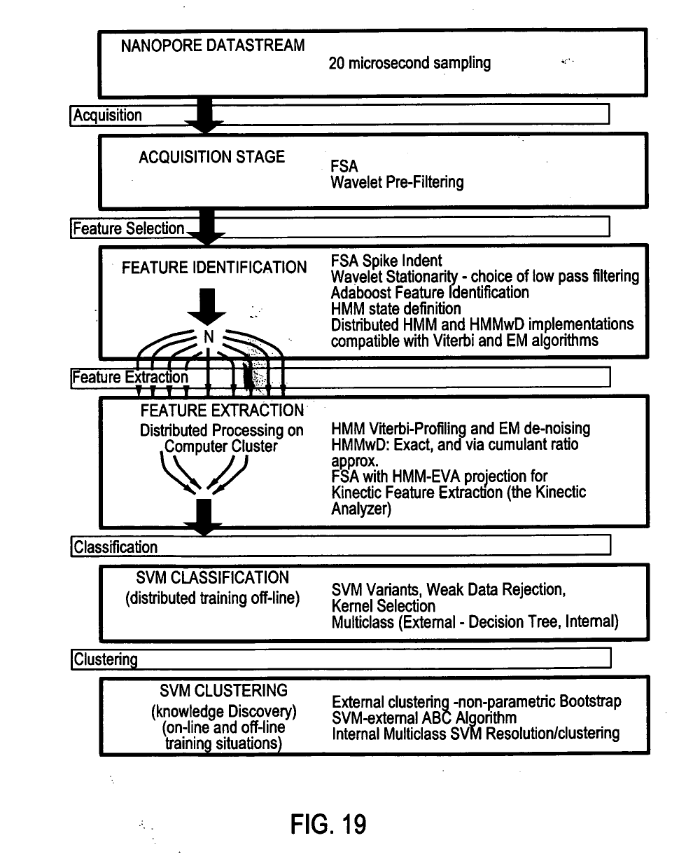

The [PARENT] describes some of the methods used in the CCC approach (see FIG. 19). Improvements to these approaches have been made (see Sec. III.B.1), particularly to the HMMBD algorithm and related improvements, as described in [HMMBD]. The HMMD recognition of a transducer signal's stationary statistics has benefits analogous to ‘time integration’ heterodyning a radio signal with a periodic carrier in classic electrical engineering, where longer observation time could be leveraged into higher signal resolution. In order to enhance such a ‘time integration’, or longer observation, benefit in the transducer signal, periodic (or stochastic) modulations may be introduced to the transducer environment (see relevant portions from the Parent Patent). In a high noise background, for example, modulations may be introduced such that some of the transducer level lifetimes have heavy-tailed, or multimodal, distributions. With these modifications a single transducer molecule signal could be recognizable in the presence of noise from many more channels than otherwise.

The typical flow of method applications is shown in FIG. 7, with details on methods given in the Parent Patent, the HMMBD Patent, the Meta-HMM Patent, the PRI Patent, and the NTD-Add Patent. Augmentations, modification, and improvements to these approaches are described in what follows, particularly the description of the SSA protocol, that governs the use of the methods and their ‘plumbing’ or architecture, and particularly to the HMMBD algorithm and related improvements, as described in the HMMBD Patent, and the meta-HMM algorithm as described in the Meta-HMM Patent. The SSA Protocol involving the use of these methods is shown in this document. Further details on some elements shown in those Figures are given in the next section, Sec. III.B.1.

### III.B.1 SSA and CCC Signal Processing Protocols

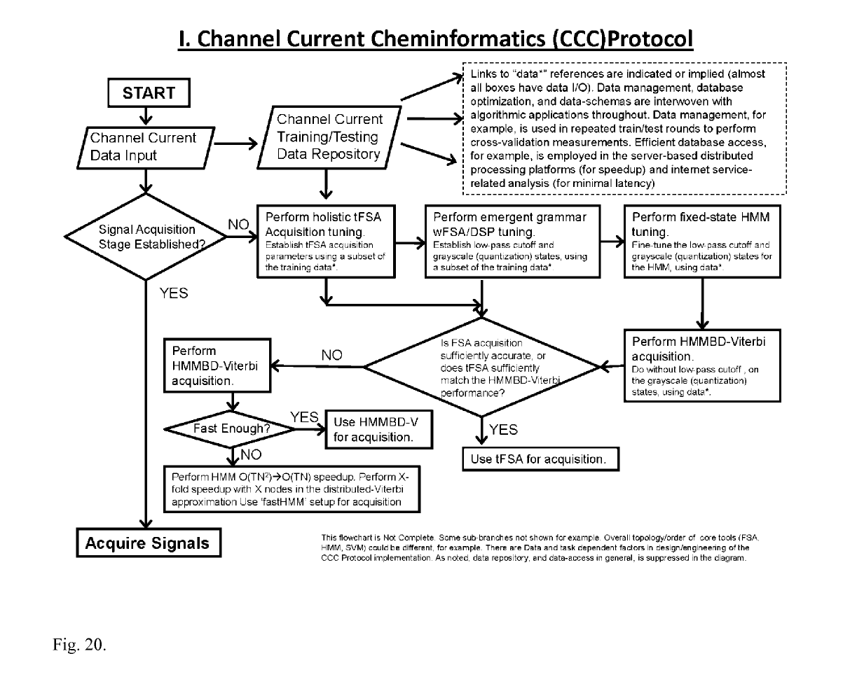

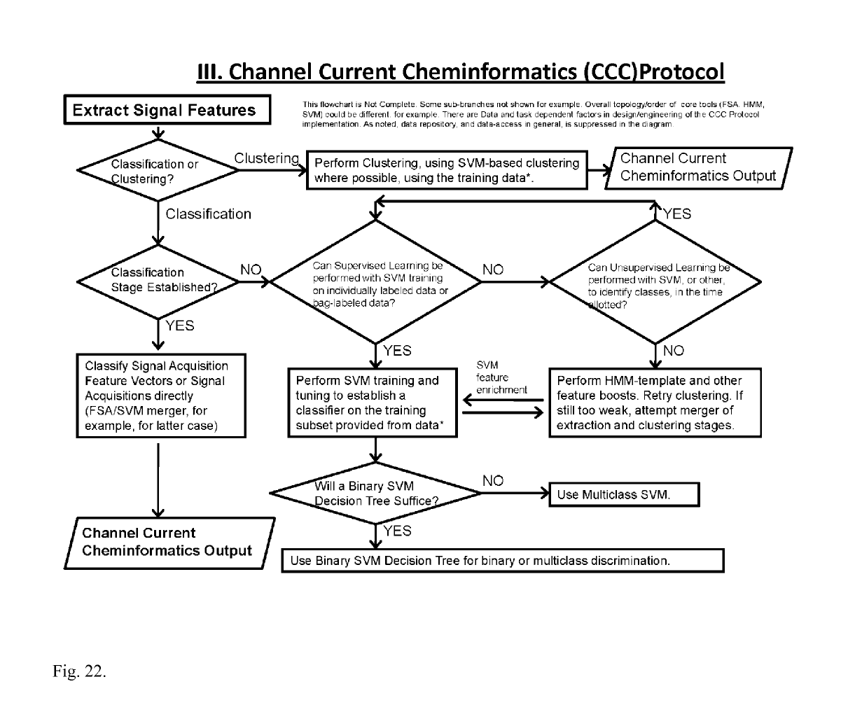

A protocol is described for use in the discovery, characterization, and classification of localizable, approximately-stationary, statistical signal structures in channel current data, and changes between such structures. The CCC protocol is shown in the Flowchart FIGS. 20-23, and is usually decomposed into a number of stages:

(Stage 1) Primitive Feature Identification:

This stage is typically finite-state automaton based, with feature identification comprising identification of signal regions (critically, their beginnings and ends), and, as-needed, identification of sharply localizable ‘spike’ behavior in any parameter of the ‘complete’ (non-lossy, reversibly transformable) classic EE signal representation domains: raw time-domain, Fourier transform domain, wavelet domain, etc. (The methodology for spike detection is shown applied to the time-domain in the continuation CCC ideas, and described in connection with FIG. 3.) Primitive feature extraction can be operated in two modes: off-line, typically for batch learning and tuning on signal features and acquisition; and on-line, typically for the overall signal acquisition (with acquisition parameters set—e.g., no tuning), and, if needed, ‘spike’ feature acquisition(s).

The FSA method that is primarily used in the channel current cheminformatics (CCC) signal discovery and acquisition is to identify signal-regions in terms of their having a valid ‘start’ and a valid ‘end’, with internal information to the hypothesized signal region consisting, minimally, of the duration of that signal (e.g., the duration between the hypothesized valid ‘end and hypothesized valid ‘start’). One approach along these lines is a signal ‘fishing’ protocol “ . . . constraints on valid ‘starts’ that are weak (with prominent use of ‘OR’ conjugation) and constraints on valid ‘ends’ that are strong (with prominent use of ‘AND’ conjugation).” We underpin our approach to signal analysis in a fundamentally different way, however, although the signal fishing method indicated above is still used as needed. The FSA signal analysis methodology used here, for example, involves identifying anomalously long-duration regions. Identification of anomalously-long duration regions in the more sophisticated Hidden Markov model (HMM) representation would suggest use of a HMM-with-duration to not lose information on the anomalous durations, which is one of the application areas for the HMMBD method (described in next section).

Once identification rules, often threshold-based, are established for the signal start's and signal end's, then those definitions can be explored/used in signal acquisition. As those definitions are tuned over, by exploring the different signal acquisition results obtained with different parameter settings, the signal acquisition counts can undergo radical phase transitions, providing the most rudimentary of the holistic tuning methods on the primitive feature acquisition FSA. By examining those phase transitions, and the stable regimes in the signal counts (and other attributes in more involved holistic tuning), the recognition of good parameter regimes for accurate acquisition of signal can be obtained. As more internal signal structure is modeled by the FSA, the holistic tuning can involve more sophisticated tuning recognition of emergent grammars on the signal sub-states. The end-result of the tuning is a signal acquisition FSA that can operate in an on-line setting, and very efficiently (computation on the same order as simply reading the sequence) in performing acquisition on the class of signals it has been ‘trained’ to recognize. On-line learning is possible-via periodic updates on the batch learning state/tuning process.

For typical CCC applications, the tFSA is used to recognize and acquire ‘blockade’ events (which have clearly defined start and stop transitions).

(Stage 2a) Feature Identification and Feature Selection:

This stage in the signal processing protocol is typically Hidden Markov model (HMM) based, where identified signal regions are examined using a fixed state HMM feature extractor or a template-HMM (states not fixed during a learning process where they learn to ‘fit’ to arrive at the best recognition on their train-data, the states then become fixed when the HMM-template is used on test data). The Stage 2 HMM methods are the central methodology/stage in the CCC protocol in that the other stages can be dropped or merged with the Stage 2 HMM in many incarnations. For example, in some data analysis situations the Stage 1 methods could be totally eliminated in favor of the more accurate HMM-based approach to the problem, with signal states defined/explored in much the same setting, but with the optimized Viterbi path solution taken as the basis for the signal acquisition structure identification. The reason this is not typically done is that the FSA methods sought in Stage 1 are usually only O(T) computational expense, where ‘T’ is the length of the stochastic sequential data that is to be examined, and ‘O(T)’ denotes an order of computation that scales as ‘T’ (linearly in the length of the sequence). The typical HMM Viterbi algorithm, on the other hand, is O(TN²), where ‘N’ is the number of states in the HMM. Stage 1 provides a faster, and often more flexible, means to acquire signal, but it is more hands-on. If the core HMM/Viterbi method can be approximated such that it can run at O(TN) or even O(T) in certain data regimes, for example, then the non-HMM methods in stage 1 could be phased out. Such HMM approximation methods are described in what follows (Sec. III), and present a data-dependent branching in the most efficient implementation of the protocol. If the data is sufficiently regular, direct tuning and regional approximation with HMM's may allow Stage 1 FSA methods to be avoided entirely in some applications. For general data, however, some tuning and signal acquisition according to Stage 1 will be desirable (possibly off-line) if only to then bootstrap (accelerate) the learning task of the HMM approximation methods.

The HMM emission probabilities, transition probabilities, and Viterbi path sampled features, among other things, provide a rich set of data to draw from for feature extraction (to create ‘feature vectors’). The choice of features is optimized according to the classification or clustering method that will make use of that feature information. In typical operation of the protocol, the feature vector information is classified using a Support Vector Machine (SVM). This is described in Stage 3 to follow. Once again, however, the Stage 3 classification could be totally eliminated in favor of the HMM's log likelihood ratio classification capability at Stage 2, for example, when a number of template HMMs are employed (one for each signal class). This classification approach is inherently weaker and slower than the (off-line trained) SVM methodology in many respects, but, depending on the data, there are circumstances where it may provide the best performing implementation of the protocol.

The HMM features, and other features (from neural net, wavelet, or spike profiling, etc.) can be fused and selected via use of various data fusion methods, such as Adaboost selection (use in prior proof-of-concept efforts). The HMM-based feature extraction provides a well-focused set of ‘eyes’ on the data, no matter what its nature, according to the underpinnings of its Bayesian statistical representation. The key is that the HMM not be too limiting in its state definition, while there is the typical engineering trade-off on the choice of number of states, N, which impacts the order of computation via a quadratic factor of N in the various dynamic programming calculations used (comprising the Viterbi and Baum-Welch algorithms among others). Features of the HMMBD implementation are given in other portions of this document (with references to the HMMBD Patent and the Meta-HMM Patent).

(Stage 2B) Stochastic Carrier Wave Encoding/Decoding

Using HMMBD we have an efficient means to establish a new form of carrier-based communications where the carrier is not periodic but is stochastic, with stationary statistics. The HMMBD algorithmic methodology, of the type described in the HMMBD Patent, enables practical stochastic carrier wave (SCW) encoding/decoding with this method.

Stochastic carrier wave (SCW) signal processing is also encountered at the forefront of a number of efforts in nanotechnology, where it can result from establishing or injecting signal modulations so as to boost device sensitivity. The notion of modulations for effectively larger bandwidth and increased sensitivity was described in the Parent Patent). Here we choose modulations that specifically evoke a signal type that can be modeled well with a HMMD but not with a HMM. This is a generally applicable approach where conventional, periodic, signal analysis methods will often fail. Nature at the single-molecule scale may not provide a periodic signal source, or allow for such, but may allow for a signal modulation that is stochastic with stationary statistics, as in the case of the nanopore transduction detector (NTD).

(Stage 3) Classification:

This stage is typically SVM based. SVMs are a robust classification method. If there are more classes to discern than two, the SVM can either be applied in a Decision Tree construction with binary-SVM classifiers at each node, or the SVM can internally represent the multiple classes, as done, for example, in proof-of-concept experiments. Depending on the noise attributes of the data, one or the other approach may be optimal (or even achievable). Both methods are typically explored in tuning, for example, where a variety of kernels and kernel parameters are also chosen, as well as tuning on internal KKT handling protocols. Simulated annealing and genetic algorithms have been found to be useful in doing the tuning in an orderly, efficient, manner. If the feature vectors produced correspond to complete data information/profiling in some manner, such is explicitly the case in a probability feature vector representation on a complete set of signal event frequencies (where all the feature ‘components’ are positive and sum to 1), then kernels can be chosen that conform to evaluating a measure of distance between feature vectors in accordance with that notion of completeness (or internal constraint, such as with the probability vectors). Use of divergence kernels with probability feature vectors in proof-of-concept experiments have been found to work well with channel blockade analysis and is thought to convey the benefit of having a better pairing of kernel and feature vector, here the kernels have probability distribution measures (divergences), for example, and the feature vectors are (discrete) probability distributions.

(Stage 4) Clustering:

This stage is often not performed in the ‘real-time’ operational signal processing task as it is more for knowledge discovery, structure identification, etc., although there are notable exceptions, one such comprising the jack-knife transition detection via clustering consistency with a causal boundary that is described in what follows. This stage can involve any standard clustering method, in a number of applications; but the best performing in the channel current analysis setting is often found to be an SVM-based external clustering approach (see Features), which is doubly convenient when the learning phase ends because the SVM-based clustering solution can then be fixed as the supervised learning set for a SVM-based classifier (that is then used at the operational level).

A computationally ‘expensive’ HMM signal acquisition at Stage 1 may be desirable or necessary for very weak signals, for example, if the typical Stage 1 methods fail. In this situation the HMM will probably have a very weak signal differential on the different signal classes if it were to attempt direct classification (and eliminate the need for a separate Stage 3). In this setting, the HMM would probably be run in the finest grayscale generic-state mode, with a number of passes with different window sample sizes to ‘step through’ the sequence to be analyzed. Then, there are two ways to proceed: (1) with a supervised learning ‘bias’, where windows on one side of a ‘cut’ are one class, and those on the other side the other class, can a the SVM classify at high accuracy on train/test with the labeled data so indicated? If so, a transition is identified. In (2) the idea is to use an unsupervised learning SVM-based clustering method where we look for a strong knife-edge split on clustered populations along the sequence of window samples. When this occurs, there is a strong identification of a transition. Since regions are identified (delineated) by their transition boundaries, we arrive at a minimally-informed means for state and state-transition discovery in stochastic sequential data involving HMM/SVM based channel current signal processing (with features described in Sec. III of CIP#2).

### (All Stages) Database/Data-Warehouse/Data-Structure/Database-Schema System Specification:

The adaptive HMM (AHMM) and modified SVM systems require implementation-specific data schema designs, for both input and output. The signal processing algorithms depend on information, represented structurally in the data, the algorithms are both process driven and data driven—these components impact the implementation of the algorithms.

The data schemas are typically implemented for optimal read time and ease of re-use and deployment, and have system dependencies that can be very significant, such as with client data-services involving distributed data access. The data schemas are typically implemented using flat files, low level operating system specific system calls to map data onto virtual memory, Relational Database Management Systems (RDBMS), and Object Database Management Systems (ODBMS). The database schemas are defined in two system contexts, 1) real time data acquisition, which includes feature recognition (AHMM) and classification (SVM), and, 2) data warehousing for client data-service, and for further analysis that can be computationally intensive and requires substantial data processing.

The real-time data acquisition systems associated with the signal processing is implemented using flat file systems and operating system specific virtual memory management interfaces. These interfaces are optimized to be scalable and high-bandwidth, to meet the requirements of high speed, real-time, data acquisition and storage. The data schemas allow for real-time signal processing such as feature recognition and classification, as well as local storage for subsequent export to a data warehouse, which can be implemented using industry standard RDBMS and ODBMS systems.

### (All Stages) Server-Based Data Analysis System Specification:

The data warehouse data schemas are optimized for applications-specific analysis of the signal processing tools in a distributed, scalable environment where substantial computing power can extend the analysis beyond what is possible in real-time. The local data acquisition systems produce and identify structure in real-time, storing the data locally, while another process streams the data transparently to an off-site data warehouse for subsequent analysis. The database uses data modeling tools to identify data schemas that work in tandem with the signal processing algorithms. The structure of the data schemas are typically integral to efficient implementation of the algorithms. Substantial off-line data pre-processing, for example, is used to create data structures based on inherent structure identified in the data. A WWW-based user interface allows for access to the stored data and provides a suite of server-based, application-specific analysis and data mining tools.

### III.B.2 Pattern Recognition Informed (PRI) NTD Operation

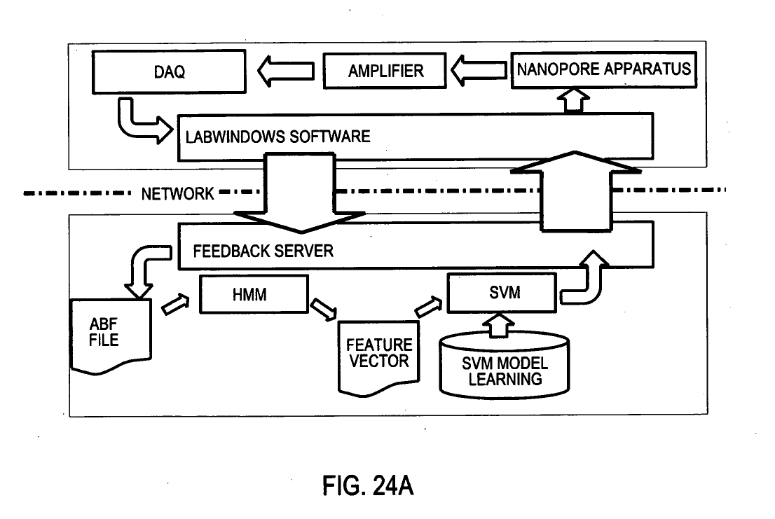

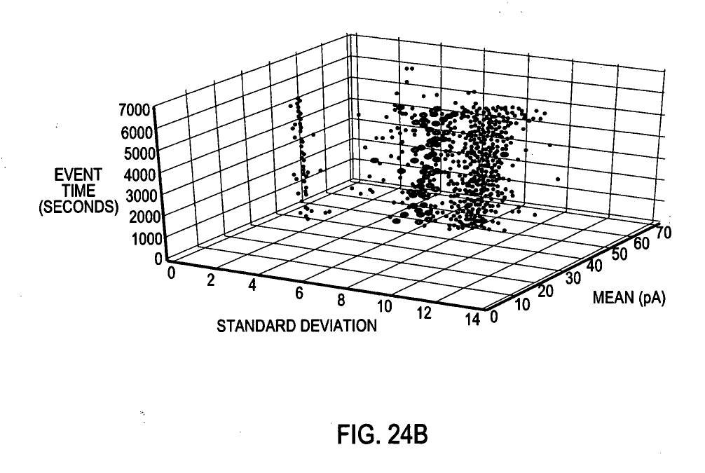

Machine learning software has been integrated into the nanopore detector for “real-time” pattern-recognition informed (PRI) feedback. The methods used to implement the PRI feedback include distributed HMM and SVM implementations, which enable the 100× to 1000× processing speedup that is needed. In FIG. 24, the PRI sample processing architecture is shown. The two orange boxes, labeled: ‘HMM’ and ‘SVM Model Learning’ are where distributed processing permits significant speedup. Since the HMM module is on the “real-time” signal processing pathway, the distributed speedup at the HMM module is clearly critical to implementing an operational PRI setup. (If we want to enable an adaptive set-up, the SVM Model learning must also be pulled into the real-time processing loop.)

A mixture of two DNA hairpin species {9TA, 9GC} (from FIG. 1.A) is examined in an experimental test of the PRI system. In separate experiments, data is gathered for the 9TA and 9GC blockades in order to have known examples to train the SVM pattern recognition software. A nanopore experiment is then run with a 1:70 mix of 9GC:9TA, with the goal to eject 9TA signals as soon as they are identified, while keeping the 9GC's for a full 5 seconds (when possible, sometimes a channel-dissociation or melting event can occur in less than that time). The results showing the successful operation of the PRI system is shown in FIG. 24.B as a 4D plot, where the radius of the event ‘points’ corresponds to the duration of the signal blockade (the 4^{th} dimension). The result in FIG. 24.B demonstrates an approximately 50-fold speedup on data acquisition of the desired minority species.

### III.B.2.1 PRI—Probe Boost Gain

Pattern recognition informed sampling has recently been used to boost the sampling rate on a desired species by two magnitudes over that obtainable with a passive recording (see FIG. 24.B).

In the case of direct antibody analysis, the capture of each antibody preparation should be studied by multiple events. Control software could also be designed that automatically detects the capture event, collects data for a defined time (100 ms to 1 second depending on experiment), ejects the antibody from the nanopore by reversing the current, and then sets up to capture another antibody molecule. Additional software may be designed to classify the blockade signals obtained. In this way, one is able to collect data from several hundred capture events for each antibody preparation, classify them on the basis of channel blockade produced, and perform statistical analyses defining the rate for each type.

### III.B.2.2 PRI—Nanomanipulation for Direct Antibody Event Transduction

Signal processing and pattern recognition can provide the ability to select desired molecules, at specified positions, and hold them. Surrounding buffer can then be perfused to introduce elements to bind or enzymatically cleave, or operate on the captured analyte in some other single-molecule modification or interaction. Repetition of this construction process permits examination of, and nanomanipulation of, very complex multicomponent biomolecular systems. The PRI selection and control of ambient buffer (i.e., microfluidics) enables a single-molecule nanomanipulation capability.

### III.B.2.3 PRI—Carrier Reference Stabilization

The notion of a “carrier wave” is familiar from analog signal processing. While, the notion of a “control” or “reference” measurement is critical to many experiments and statistical analysis. What is proposed here is a digital version of a “carrier wave” that serves to stabilize the signal processing when the “carrier” signal is handled as a control signal. The idea is to train the machine learning software to discriminate between digital signal states in a manner cognizant of the instrument status itself—via interspersed carrier reference (CR) molecules.

Discrimination can then be adapted (stabilized) to changing receiver or instrument environment by learning mappings on the signals from one receiver state to those signals on a standardized reference receiver state. In this manner, signal analysis on any device can be stabilized via an active feedback experimentally or via a passive filtering on the device output. Extensions to analog processing are available via A/D conversions, stabilization, followed by D/A conversion.

Carrier References (CRs) can be employed to track instrument state and provide information for digital signal stabilization. This is a general utility for any device producing digital signal output, and whose input can be injected with CR signals. A specific example of this is where the CR signals correspond to current blockades in the nanopore device due to control molecules. With PRI capabilities, the CRs inform an active control system for strong device stabilization. Strong pattern recognition capabilities with the classes to be discerned may also afford the opportunity to directly encode the CR indication of nanopore detector state in an associative memory context with the observed (non-control) blockade signal. This is simply done by altering the non-control feature vector to be itself concatenated with the last seen control-signal feature vector. This permits blockade characterization to also track system state values, such as pH, and to then be compared to other blockades accordingly.

### III.B.3 Modulation and Uses for Heavy-Tail Encoding

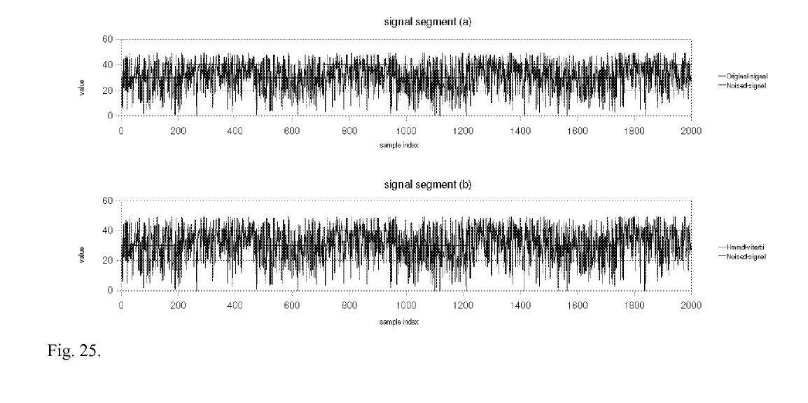

The HMMD recognition of a transducer signal's stationary statistics has benefits analogous to ‘time integration’ heterodyning a radio signal with a periodic carrier in classic electrical engineering, where longer observation time could be leveraged into higher signal resolution. In order to enhance such a ‘time integration’, or longer observation, benefit in the transducer signal, periodic (or stochastic) modulations may be introduced to the transducer environment. In a high noise background, for example, modulations may be introduced such that some of the transducer level lifetimes have heavy-tailed, or multimodal, distributions. With these modifications a single transducer molecule signal could be recognizable in the presence of noise from many more channels than otherwise, enabling multichannel devices in NTD among other things. A Proof-of-Concept experiment for signal recognition in noisy background is shown in FIG. 25.

In FIG. 25 we show state-decoding on synthetic data that is representative of a two-state biological ion-channel decoding problem. 120 data sequences were generated that have two states with channel blockade levels set at 30 and 40 pA (a typical scenario in practice). Every data sequence has 10,000 samples. Each state has emitted values in a range from 0 to 49 pA. The maximum duration of states is set at 500. The mean duration of the 40 pA state is given as 200 samples (typically have 1 sample every 20 microseconds in actual experiments), while the pA level has mean duration set at 300 samples. The task is to train using 100 of the generated data sequences and attempt state-decoding on the remaining 20 data sequences. An example sequence is shown in FIG. 25, along with its decoding when an HMM or an HMMD is employed. The performance difference is stark: the exact and adaptive HMMD decodings are 97.1% correct, while the HMM decoding is only correct 61% of the time (where random guessing would accomplish 50%, on average, in a two-state system). Three emission distributions were examined: geometric, Gaussian, and Poisson. In all cases the HMMD performed much more robustly than the HMM in tracking states.

The N-channel scenario has the potential to increase the sensitivity of the NTD N-fold, but the signal analysis becomes more challenging since there are N parallel noise sources. The HMMD recognition of a transducer signal's stationary statistics is analogous to ‘time integration’ heterodyning a radio signal with a periodic carrier in classic electrical engineering. In order to enhance the ‘time integration’ benefit in the transducer signal, periodic (or stochastic) modulations can be introduced to the transducer environment. In a high noise background, modulations introduced can be such that some of the transducer level lifetimes have heavy-tailed, or multimodal, distributions. Using SSA, with possible SCW enhancements, a single transducer molecule signal should be recognizable in the presence of multiple channels. Increasing the number of channels by N, and retaining the capability of recognizing a single transducer blockading one of those channels, provides a direct gain in sensitivity by N. It is important to note that this increase in sensitivity is mostly implemented computationally and does not add complexity or cost to the NTD device itself.

Increasing the effective bandwidth of the nanopore device greatly enhances its utility in almost every application, particularly those, such as DNA sequencing, where the speed with which blockade classifications can be made (sequencing) is directly limited by bandwidth restrictions. Bead attachments can couple in excitations passively from background thermal (Brownian) motions, or actively, in the case of magnetic beads, by laser pulsing and laser-tweezer manipulation. Dye attachments can couple excitations via laser or light (UV) excitations to the targeted dye molecule. Large, classical, objects, such as microscopic beads, provide a method to couple periodic modulations into the single-molecule system. The direct coupling of such modulations, at the channel itself, avoids the low Reynolds number limitations of the nanometer-scale flow environment. For rigid coupling on short biopolymers, the overall rigidity of the system also circumvents limitations due to the low Reynolds number flow environment. Similar consideration also come into play for the dye attachments, except now the excitable object is typically small, in the sense that it is usually the size of a single (dye) molecule attachment. Excitable objects such as dyes must contend with quantum statistical effects, so their application may require time averaging or ensemble averaging, where the ensemble case involves multiple channels that are observed simultaneously—which relates to the platform of the multi-channel configuration of the experiment. Modulation in the third, membrane-modulated, experiment also avoids quantum and low Reynolds number limitations. In all the experimental configurations, a multi-channel platform may be used to obtain rapid ensemble information. In all cases the modulatory injection of excitations may be in the form of a stochastic source (such as thermal background noise), a directed periodic source (laser pulsing, piezoelectric vibrational modulation, etc.), or a chirp (single laser pulse or sound impulse, etc.). If the modulatory injection coincides with a high frequency resonant state of the system, low frequency excitations may result, i.e., excitations that can be monitored in the usable bandwidth of the channel detector. Increasing the effective bandwidth of the nanopore device greatly enhances its utility in almost every application.

III.B.4 Modulated NTD with ‘Ghost’ Transducers:

Multiple channels may be present in some forms, but operational mode typically involves at most one modulated channel (or a few such channels). The channel can be modulated via a molecular-capture channel modulator, or due to externally driven, localized, modulation of a single channel, with or without a molecular-capture modulator. An example of the latter is a localized laser pulsing on one channel to evoke a stationary statistics channel modulation that interacts with ‘binding’ target of interest so as to produce a change in blockade stationary statistics upon modulated-channel interaction with target—this scenario is modulated-NTD with a ‘ghost’ transducer interacting with target, where the ‘ghost’ is a stationary, selection ‘sensitized’, targeted effect produced by the specific modulations chosen (this method could be applied to tuned ‘hairy’ solid-state etches (fuzzy, conical, channels), for example, where a very cheap process may be developed for the detector's channel construction). A related effect, the ‘re-awakening’ of long dsDNA fixed blockade channel current, under laser pulsing modulations at an appropriate range of frequencies, into a stochastically modulated channel current, has been observed (as discussed in the Parent Patent), and may enable terminus and other molecular characteristics to be identified with extremely high accuracy on capture of long dsDNA molecules (could be used for Sanger-style sequencing, among other things).

III.C HMM-Based Signal Processing, with Possible Use of Side Information and Side Methods

### III.C.1 HMMD and Martingale Background

Markov Chains and Standard Hidden Markov Models.

A Markov chain is a sequence of random variables S₁; S₂; S₃; . . . with the Markov property of limited memory, where a first-order Markov assumption on the probability for observing a sequence ‘s₁s₂s₃s₄ . . . sₙ’ is:

P(S₁=s₁, . . . , Sₙ=sₙ)=P(S₁=s₁)P(S₂=s₂|S₁=s₁) . . . P(Sₙ=sₙ|Sₙ₋₁=sₙ₋₁)

In the Markov chain model, the states are also the observables. For a hidden Markov model (HMM) we generalize to where the states are no longer directly observable (but still 1^{st}-order Markov), and for each state, say S₁, we have a statistical linkage to a random variable, O₁, that has an observable base emission, with the standard (0^{th}-order) Markov assumption on prior emissions. The probability for observing base sequence ‘b₁b₂b₃b₄ . . . bₙ’ with state sequence taken to be ‘s₁s₂s₃s₄ . . . sn’ is then:

P(O;S)=P(‘b₁b₂b₃b₄ . . . bₙ’;‘s₁s₂s₃s₄ . . . sₙ’)=P(S₁=s₁)P(S₂=s₂|S₁=s₁)P(Sₙ=sₙ|Sₙ₋₁=sₙ₋₁)×P(O₁=b₁|S₁=s₁)P(Oₙ=bₙ|Sₙ=sₙ)

HMM with Duration Modeling.

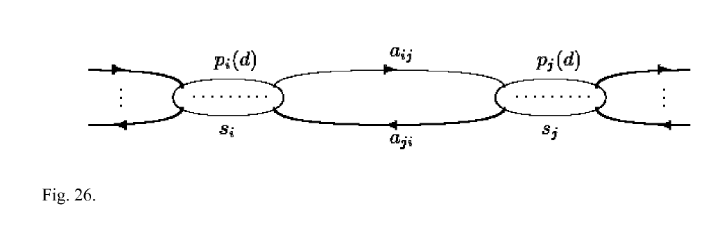

In the standard HMM, when a state i is entered, that state is occupied for a period of time, via self-transitions, until transiting to another state j (see FIG. 26). If the state interval is given as d, the standard HMM description of the probability distribution on state intervals is implicitly given:

pᵢ(d)aᵢᵢ^{d-1}(1−aᵢᵢ) (1)

where aᵢᵢis self-transition probability of state i. This geometric distribution is inappropriate in many cases. The standard HMMD replaces Eq. (1) with a pᵢ(d) that models the real duration distribution of state i. In this way explicit knowledge about the duration of states is incorporated into the HMM. A general HMMD is illustrated in FIG. 26.

It is easy to see that the HMMD will turn into a HMM if pᵢ(d) is set to the geometric distribution shown in Eq. (1). Equations (2)-(6) (not shown) describe the re-estimation formula, etc., for the standard HMMD from HSMM, and are given in the provisional [HMMBD].

Significant Distributions that are not Geometric.

Non-geometric duration distributions occur in many familiar areas, such as the length of spoken words in phone conversation, as well as other areas in voice recognition. The Gaussian distribution occurs in many scientific fields and there are huge number of other (skewed) types of distributions, such as heavy-tailed (or long-tailed) distributions, multimodal distributions, etc.

Heavy-tailed distributions are widespread in describing phenomena across the sciences. The log-normal and Pareto distributions are heavy-tailed distributions that are almost as common as the normal and geometric distributions in descriptions of physical phenomena or man-made phenomena and many other phenomena. Pareto distribution was originally used to describe the allocation of wealth of the society, known as the famous 80-20 rule, namely, about 80% of the wealth was owned by a small amount of people, while ‘the tail’, the large part of people only have the rest 20% wealth. Pareto distribution has been extended to many other areas. For example, internet file-size traffic is a long-tailed distribution, that is, there are a few large sized files and many small sized files to be transferred. This distribution assumption is an important factor that must be considered to design a robust and reliable network and Pareto distribution could be a suitable choice to model such traffic. (Internet applications have found more and more heavy-tailed distribution phenomena.) Pareto distributions can also be found in a lot of other fields, such as economics.

Log-normal distributions are used in geology & mining, medicine, environment, atmospheric science, and so on, where skewed distribution occurrences are very common. In Geology, the concentration of elements and their radioactivity in the Earth's crust are often shown to be log-normal distributed. The infection latent period, the time from being infected to disease symptoms occurs, is often modeled as a log-normal distribution. In the environment, the distribution of particles, chemicals, and organisms is often log-normal distributed. Many atmospheric physical and chemical properties obey the log-normal distribution. The density of bacteria population often follows the log-normal distribution law. In linguistics, the number of letters per words and the number of words per sentence fit the log-normal distribution. The length distribution for introns, in particular, has very strong support in an extended heavy-tail region, likewise for the length distribution on exons or open reading frames (ORFs) in genomic DNA. The anomalously long-tailed aspect of the ORF-length distribution is the key distinguishing feature of this distribution, and has been the key attribute used by biologists using ORF finders to identify likely protein-coding regions in genomic DNA since the early days of (manual) gene structure identification.

Significant Series that are Martingale.

A discrete-time martingale is a stochastic process where a sequence of random variables {X₁, . . . , Xₙ} has conditional expected value of the next observation equal to the last observation: E(Xₙ₊₁|X₁, . . . , Xₙ)=Xₙ, where E(|Xₙ|)<∞. Similarly, one sequence, say {Y₁, . . . , Yₙ}, is said to be martingale with respect to another, say {X₁, . . . , Xₙ}, if for all n: E(Yₙ₊₁|X₁, . . . , Xₙ)=Yₙ, where E(|Yₙ|)<∞. Examples of martingales are rife in gambling. For our purposes, the most critical example is the likelihood-ratio testing in statistics, with test-statistic, the “likelihood ratio” given as: Yₙ=Πⁿᵢ₌₁g(Xᵢ)/f(Xᵢ), where the population densities considered for the data are f and g. If the better (actual) distribution is f, then Yₙ is martingale with respect to Xₙ. This scenario arises throughout the HMM Viterbi derivation if local ‘sensors’ are used, such as with profile-HMM's or position-dependent Markov models in the vicinity of transition between states. This scenario also arises in the HMM Viterbi recognition of regions (versus transition out of those regions), where length-martingale side information will be explicitly shown in what follows, providing a pathway for incorporation of any martingale-series side information (this fits naturally with the clique-HMM generalizations described in what follows). Given that the core ratio of cumulant probabilities that is employed is itself a martingale, this then provides a means for incorporation of side-information in general.

### III.C.2 The Hidden Semi-Markov Model (HSMM) HMMD Via Length Side-Information

In this section we present a means to lift side information that is associated with a region, or transition between regions, by ‘piggybacking’ that side information along with the duration side information. We use the example of such a process for HMM incorporation of duration itself as the guide. In doing so we arrive at a hidden semi-Markov model (HSMM) formalism, the most efficient formalism in which to implement an HMMD. The formalism introduced here, however, is directly amenable to incorporation of side-information and to adaptive speedup (as described in later sections).

For the state duration density pᵢ(x=d), 1≦x≦D, we have:

$${p}_{i} ( x = d ) = {p}_{i} ( x \geq 1 ) \cdot \frac{{p}_{i} ( x \geq 2 )}{{p}_{i} ( x \geq 1 )} \cdot \frac{{p}_{i} ( x \geq 3 )}{{p}_{i} ( x \geq 2 )} … \frac{{p}_{i} ( x \geq d )}{{p}_{i} ( x \geq d - 1 )} \cdot \frac{{p}_{i} ( x = d )}{{p}_{i} ( x \geq d )} \qquad ( 7 )$$

where pᵢ(x=d) is abbreviated as pᵢ(d) if no ambiguity. Define “self-transition” variable sᵢ(d)=probability that next state is Sᵢ given that Sᵢ has consecutively occurred d times up to now.

$${p}_{i} ( x = d ) = [ {\prod }_{j = 1}^{d - 1} {s}_{i} ( j ) ] ( 1 - {s}_{i} ( d ) ) , \\ where \\ {s}_{i} ( d ) = \{ \begin{matrix}\frac{{p}_{i} ( x \geq d + 1 )}{{p}_{i} ( x \geq d )} & if 1 \leq s \leq D - 1 \\ 0 & if d = D\end{matrix} \qquad ( 8 )$$

We see with comparison of Eqn.'s (8) and (1) that we now have similar form, there are ‘d-1’ factors of ‘s’ instead of ‘a’, with a ‘cap term’ ‘(1-s)’ instead of ‘(1-a)’, where the ‘s’ terms are not constant, but only depend on the state's duration probability distribution. In this way, ‘s’ can mesh with the HMM's dynamic programming table construction for the Viterbi algorithm at the column-level in the same manner that ‘a’ does.

Side-information about the local strength of EST matches or homology matches, etc., that can be put in similar form, can now be ‘lifted’ into the HMM model on a proper, locally optimized Viterbi-path, sense. The length probability in the above form, with the cumulant-probability ratio terms, is a form of martingale series (more restrictive than that seen in likelihood ratio martingales). The Baum-Welch algorithm in the hidden semi-Markov model (HSMM) formalism is described next, followed by a description of the Viterbi algorithm in the HSMM formalism.

### The Baum-Welch Algorithm in the Length-Martingale Side-Information HMMD Formalism.

We define the following three variables to simplify what follows:

$$\begin{matrix} {\overline{s}}_{i} ( d ) = \{ \begin{matrix}1 - {s}_{i} ( d + 1 ) & if d = 0 \\ \frac{1 - {s}_{i} ( d + 1 )}{1 - {s}_{i} ( d )} \cdot {s}_{i} ( d ) & if 1 \leq d \leq D - 1\end{matrix} & ( 9 ) \\ θ ( k , i , d ) = {e}_{i} ( k ) {\overline{s}}_{i} ( d ) \\ 0 \leq d \leq D - 1 & ( 10 ) \\ ξ ( k , i , d ) = {e}_{i} ( k ) {s}_{i} ( d ) \\ 1 \leq d \leq D - 1 & ( 11 ) \\ Define \text{:} {f}_{t}^{′} ( i , d ) = P ( {O}_{1} {O}_{2} … {O}_{t} , {S}_{i} has consecutively occurred d times up to t / λ ) \\ {f}_{t}^{′} ( i , d ) = \{ \begin{matrix}{e}_{i} ( {O}_{t} ) {\sum }_{j = 1 , j \neq i}^{N} {F}_{t - 1} ( j ) {a}_{ji} & if d = 1 \\ {f}_{t - 1}^{′} ( i , d - 1 ) {s}_{i} ( d - 1 ) {e}_{i} ( {O}_{t} ) & if 2 \leq d \leq D\end{matrix} \\ Define \text{:} \begin{matrix}{\overline{f}}_{t} ( i , d ) = P ( {O}_{1} {O}_{2} … {O}_{t} , {S}_{i} ends at t with duration d \vert λ ) \\ = \begin{matrix}{f}_{t}^{′} ( i , d ) ( 1 - {s}_{i} ( d ) ) & 1 \leq d \leq D\end{matrix} \\ = \{ \begin{matrix}θ ( {O}_{t} , i , d - 1 ) {F}_{t - 1}^{′} ( i ) & if d = 1 \\ θ ( {O}_{t} , i , d - 1 ) {\overline{f}}_{t - 1} ( i , d - 1 ) & if 2 \leq d \leq D\end{matrix}\end{matrix} \\ where & ( 12 ) \\ {F}_{t}^{′} ( i ) = {\sum }_{j = 1 , j \neq i}^{N} {F}_{t} ( j ) * {a}_{ji} \\ {F}_{t} ( i ) = {\sum }_{d = 1}^{D} {f}_{t}^{′} ( i , d ) ( 1 - {s}_{i} ( d ) ) & ( 13 ) \\ Define \text{:} \begin{matrix}{b}_{t}^{′} ( i , d ) = P ( {O}_{t} {O}_{t + 1} … {O}_{T} , {S}_{i} will has a duration of d from t \vert λ ) \\ = \{ \begin{matrix}θ ( {O}_{t} , i , d - 1 ) {B}_{t + 1}^{′} ( i ) & if d = 1 \\ θ ( {O}_{t} , i , d - 1 ) {b}_{t + 1}^{′} ( i , d - 1 ) & if 1 < d \leq D\end{matrix}\end{matrix} \\ where & ( 14 ) \\ {B}_{t}^{′} ( i ) = {\sum }_{j = 1 , j \neq i}^{N} {a}_{ij} {B}_{t} ( j ) \\ {B}_{t} ( i ) = {\sum }_{d = 1}^{D} {b}_{t}^{′} ( i , d ) & ( 15 )\end{matrix}$$

Now f, f*, b and b* can be expressed as:

$${f}_{t}^{*} ( i ) = \frac{{f}_{t + 1}^{′} ( i , 1 )}{{e}_{i} ( {O}_{t + 1} )}$$

$${b}_{t}^{*} ( i ) = {B}_{t + 1} ( i )$$

$${b}_{t} ( i ) = {B}_{t + 1}^{′} ( i )$$

$${f}_{t} ( i ) = {F}_{t} ( i )$$

Now define

$$\begin{matrix} ω ( t , i , d ) = {\overline{f}}_{t} ( i , d ) {B}_{t + 1}^{′} ( i ) & ( 16 ) \\ \begin{matrix} {μ}_{t} ( i , j ) = P ( {O}_{1} … {O}_{T} , {q}_{t} = {S}_{i} , {q}_{t + 1} = {S}_{j} \vert λ ) \\ = {F}_{t} ( i ) {a}_{ij} {B}_{t + 1} ( j )\end{matrix} & ( 17 ) \\ ϕ ( i , j ) = {\sum }_{t = 1}^{T - 1} {μ}_{t} ( i , j ) & ( 18 ) \\ {v}_{t} ( i ) = P ( {O}_{1} … {O}_{T} , {q}_{t} = {S}_{i} \vert λ ) = \{ \begin{matrix}π ( i ) {B}_{1} ( i ) & if t = 1 \\ {v}_{t - 1} + {\sum }_{j \neq i}^{N} ( {μ}_{t - 1} ( j , i ) - {μ}_{t - 1} ( i , j ) ) & if 2 \leq t \leq T\end{matrix} & ( 19 )\end{matrix}$$

Using the above equations:

$$\begin{matrix}{π}_{i}^{new} = \frac{{π}_{i} {b}_{1}^{′} ( i , 1 )}{P ( O \vert λ )} & ( 20 ) \\ {a}_{ij}^{new} = \frac{ϕ ( i , j )}{{\sum }_{j = 1}^{N} ϕ ( i , j )} & ( 21 ) \\ {e}_{i}^{new} ( k ) = \frac{{\sum }_{{t = 1}_{s . t . {O}_{t} = k}}^{T} {v}_{t} ( i )}{{\sum }_{t = 1}^{T} {v}_{t} ( i )} \\ {p}_{i} ( d ) = \frac{{\sum }_{t = 1}^{T} ω ( t , i , d )}{{\sum }_{d = 1}^{D} {\sum }_{t = 1}^{T} ω ( t , i , d )} & 2 )\end{matrix}$$

### The Viterbi Algorithm in the Length-Martingale Side-Information HMMD Formalism.

$$\begin{matrix}Define {v}_{t} ( i , d ) = the most probable path that consecutively occured d times at state i at time t \text{:} \\ {v}_{t} ( i , d ) = \{ \begin{matrix}{e}_{i} ( {O}_{t} ) {max}_{j = 1 , j \neq i}^{N} {V}_{t - 1} ( j ) {a}_{ji} & if d = 1 \\ {v}_{t - 1} ( i , d - 1 ) {s}_{i} ( d - 1 ) {e}_{i} ( {O}_{t} ) & if 2 \leq d \leq D\end{matrix} \\ where & ( 24 ) \\ {V}_{t} ( i ) = {max}_{d = 1}^{D} {v}_{t} ( i , d ) ( 1 - {s}_{i} ( d ) ) & ( 25 )\end{matrix}$$

The goal is to find:

$$\begin{matrix}{argmax}_{[ i , d ]} \{ {max}_{i , d}^{N , D} {v}_{T} ( i , d ) ( 1 - {s}_{i} ( d ) \} \\ θ ( k , i , d ) = {\overline{s}}_{i} ( d - 1 ) {e}_{i} ( k ) \\ 1 \leq d \leq D & ( 27 ) \\ \begin{matrix}{v}_{t}^{′} ( i , d ) = \begin{matrix}{v}_{t} ( i , d ) ( 1 - {s}_{i} ( d ) ) & 1 \leq d \leq D\end{matrix} \\ = \{ \begin{matrix}θ ( {O}_{t} , i , d ) {max}_{j = 1 , j \neq i}^{N} {V}_{t - 1} ( j ) {a}_{ji} & if d = 1 \\ {v}_{t - 1}^{′} ( i , d - 1 ) θ ( {O}_{t} , {i}_{d} ) & if 2 \leq d \leq D\end{matrix}\end{matrix} \\ where & ( 28 ) \\ {V}_{t} ( i ) = {max}_{d = 1}^{D} {v}_{t}^{′} ( i , d ) & ( 29 )\end{matrix}$$

The goal is now:

$${argmax}_{[ i , d ]} \{ {max}_{i , d}^{N , D} {v}_{T}^{′} ( i , d ) \} \qquad ( 30 )$$

If we do a logarithm scaling on, a and e in advance, the final Viterbi path can be calculated by:

$$\begin{matrix}\begin{matrix} {θ}^{′} ( k , i , d ) = log θ ( k , i , d ) = log {\overline{s}}_{i} ( d - 1 ) + log {e}_{i} ( k ) & 1 \leq d \leq D\end{matrix} & ( 31 ) \\ {v}_{t}^{′} ( i , d ) = \{ \begin{matrix}{θ}^{′} ( {O}_{t} , i , d ) + {max}_{j = 1 , j \neq 1}^{N} ( {V}_{t - 1} ( j ) + log {a}_{ji} ) & if d = 1 \\ {v}_{t - 1}^{′} ( i , d - 1 ) + {θ}^{′} ( {O}_{t} , i , d ) & if 2 \leq d \leq D\end{matrix} & ( 32 )\end{matrix}$$

where the argmax goal above stays the same.

A summary of the application of the Baum-Welch and Viterbi training algorithms are as follows, beginning with Baum-Welch:
1. initialize elements(λ) of HMMD.
2. calculate bₜ′(i,d) using Eq.s (14) and (15) (save the two tables: Bₜ(i) and Bₜ′(i)).
3. calculate f̅ₜ(i, d) using Eq. (12) and (13).
4. re-estimate elements(λ) of HMMD using Eq. (16)-(23).
5. terminate if stop condition is satisfied, else goto step 2.

The memory complexity of this method is O(TN). As shown above, the algorithm first does backward computing (step (2)), and saves two tables: one is Bₜ(i), the other is Bₜ′(i). Then at very time index t, the algorithm can group the computation of step (3) and (4) together. So no forward table needs to be saved. We can do a rough estimation of HMMD's computation cost by counting multiplications inside the loops of Σ^{T} Σ^{N} (which corresponds to the standard HMM computational cost) and Σ^{T} Σ^{D} (the additional computational cost incurred by the HMMD). The computation complexity is O(TN²+TND). In an actual implementation a scaling procedure may be needed to keep the forward-backward variables within a manageable numerical interval. One common method is to rescale the forward-backward variables at every time index t using the scaling factor cₜ=Σᵢfₜ(i). Here we use a dynamic scaling approach. For this we need two versions of θ(k, i, d). Then at every time index, we test if the numerical values is too small, if so, we use the scaled version to push the numerical values up; if not, we keep using the unscaled version. In this way no additional computation complexity is introduced by scaling. As with Baum-Welch, the Viterbi algorithm for the HMMD is O(TN²+TND). Because logarithm scaling can be performed for Viterbi in advance, however, the Viterbi procedure consists only of additions to yield a very fast computation. For both the Baum-Welch and Viterbi algorithms, use of the HMMBD algorithm [11] can be employed (as in this work) to further reduce computational time complexity to O(TN²), thus obtaining the speed benefits of a simple HMM, with the improved modeling capabilities of the HMMD.

### III.C.3 HMMBD

The HMM with binned duration algorithm of the type set forth in the HMMBD Patent is an efficient, self-tuning, explicit and adaptive, hidden Markov model with Duration (also sometimes referred to as the ESTEAHMMD algorithm). The standard hidden Markov model (HMM) constrains state occupancy durations to be geometrically distributed, while the standard hidden Markov model with duration (HMMD) addresses this limitation, but at significant computational expense. A standard HMM requires computation of order O(TN²), where T is the period of observations and N is the number of states. An explicit-duration HMM (HMMD) requires computation of order O(TN²+TND²), where D is the maximum interval between state transitions, while a hidden semi-Markov HMMD requires computation of order O(TN²+TND). The latter improvement is still fundamentally limited if D>>N (where D>500, typically), and imposes a maximum state interval constraint that may be too restrictive in some situations such as intron modeling in gene structure identification. The ESTEAHMMD algorithm proposed here relaxes the maximum state interval constraint and requires computation of order O(TN²+TND*), where D* is the bin number in an adaptive representation of the distribution on the interval between state transitions, and is typically reducible to ^{˜}50 for standard single-peak probability distributions. This provides a means to do forward-backward and Viterbi algorithm HMMD computations at an expense only marginally greater than the standard HMM for N<50; and at negligible added expense when N>50.

In what follows an explicit hidden Markov model with Duration (HMMD) construction is demonstrated with order of computation O(TN²+TND), where T is the period of observations, N is the number of states, and D is the maximum interval between state transitions (D is typically>500). We then show how adaptive self-tuning HMMBD can be used to further reduce the order of computation to O(TN²+TND*), where D* is typically less than 50. The adaptive reduction in computational expense is accomplished at no appreciable loss in accuracy over the explicit (exact) HMMD, and also provides a generalization to arbitrarily large intervals of state self-transitions (where Dₘₐₓ>>D). This is an important result because the critically important, HMM-based, Viterbi and Baum-Welch algorithms, with computational expense O(TN²), are directly enhanced in their practical usage. The Viterbi and Baum-Welch algorithms are the underlying communication, error-coding, and structure-identification algorithms used in cell-phone communications, deep-space satellite communications, voice recognition, and in gene-structure identification, with growing applications in areas such as image processing now becoming commonplace as well. The HMMD generalization is important because the standard, HMM-based, Viterbi and Baum-Welch algorithms are critically constrained in their modeling ability to distributions on state intervals that are geometric. This works fine for the special instance where the state-interval distributions are geometric, but can lead to a significant decoding failure in noisy environments when the state-interval distributions are not geometric (or approximately geometric). The HMM with duration eliminates this deficiency by also exactly modeling the interval distributions themselves. The original description of an explicit HMMD required computation of order O(TN²+TND²), which was prohibitively computationally expensive in practical, real-time, operations, and introduced a severe maximum-interval constraint on the interval-distribution model. Improvements via hidden semi-Markov models to computations of order O(TN²+TND) were then made, but the maximum-interval constraint remains.

The intuition guiding the result obtained here is that the standard HMM already does the desired duration modeling when the distribution modeled is geometric, suggesting that, with sufficient effort, a self-tuning explicit HMMD might be possible to achieve HMMD modeling capabilities at HMM computational complexity in an adaptive context.

Computer systems, microprocessors, supercomputers, and integrated circuits implemented with the ESTEAHMMD pattern recognition algorithm, method and related processes, will have vastly improved performance capabilities. The improved signal resolution possible via the signal processing method will allow for reduced signal processing overhead, thereby reducing power usage. This directly impacts satellite communications where a minimal power footprint is critical, and cell phone construction, where a low-power footprint allows for smaller cell phones, or cell phones with smaller battery requirements; or cell phones with less expensive power system methodologies. For real-time signal processing the ESTEAHMMD signal processing process permits much more accurate signal resolution and signal de-noising than current methods. This impacts real-time operational systems such as voice recognition hardware implementations, over-the-horizon radar detection systems, sonar detection systems, and receiver systems for streaming low-power digital signal broadcasts (such an enhancement improves receiver capabilities on various high-definition radio and TV broadcasts). For batch (off-line) signal resolution, the ESTEAHMMD signal processing process operating on a computer, network of computers, or supercomputer, allows for significantly improved gene-structure resolution in genomic data, biological channel current characterization, and extraction of binding/conformational kinetic feature extraction involving molecular interactions observed by nanopore detector devices. For scientific and engineering endeavors in general, where there is any data analysis that can be related to a sequence of measurements or observations, the ESTEAHMMD signal processing systems that can be implemented all permit improved signal resolution and speed of signal processing. This includes instances of 2-D and higher order dimensional data, such as 2-D images, where the information can be reduced to a 1-D sequence of measurements via a rastering process, as has been done with HMM methods in the past.

The duration distribution of state i consists of rapidly changing probability regions (with small change in duration) and slowly changing probability regions. In the standard HMMD all regions share an equal computation resource (represented as D substates of a given state)—this can be very inefficient in practice. In this section, we describe a way to recover computational resources, during the training process, from the slowly changing probability regions. As a result, the computation complexity can be reduced to O(TN²+TND*), where D* is the number of “bins” used to represent the final, coarse-grained, probability distribution. A “bin” of a state is a group of substates with consecutive duration. For example, f(i, d), f(i, d+1), . . . f (i, d+δd) can be grouped into one bin. The bin size is a measure of the granularity of the evolving length distribution approximation. A fine-granularity is retained in the active regions, perhaps with only one length state per bin, while a coarse-granularity is adopted in weakly changing regions, with possibly hundreds of length states per bin. An important generalization to the exact, standard, length-truncated, HMMD is suggested for handling long duration state intervals—a “tail bin”. Such a bin is strongly indicated for good modeling on certain important distributions, such as the long-tailed distributions often found in nature, the exon and intron interval distributions found in gene-structure modeling in particular. In practice, the idea is to run the exact HMMD on a small portion, δT, of the training data, at O(δTNN+δTND) cost, to get an initial estimate of the state interval distributions. Some preliminary course-graining is then performed, where strongly indicated, and the number of bins representing the length distribution is reduced from D to D′. The exact HMMD is then performed on the D′ substrate model for another small portion of the training data, at computational expense O(δTNN+δTND′). This is repeated until the number of bin states, D*, reduces no further, and the bulk of the training then commences with the D* bin-states length distribution model at expense O(TN²+TND*). The key to this process is the retention of training information during the ‘freezing out’ of length distribution states, and such that the D* bin state training process can be done at expense O(TN²+TND*)≈O(TN²), which is the same complexity class as the standard HMM itself.

Starting from the above binning idea, for substates in the same bin, a reasonable approximation is applied:

$${\sum }_{{d}^{′} = d}^{d + {δ}_{d}} {f}_{t} ( i , {d}^{′} ) θ ( {O}_{t} , i , {d}^{′} ) = θ ( {O}_{t} , i , \overline{d} ) {\sum }_{{d}^{′} = d}^{d + {δ}_{d}} {f}_{t} ( i , {d}^{′} ) \qquad ( 33 )$$

where d′ is the duration representative for all substates in this bin.

We begin in sub-section A that follows with a description of the Baum-Welch algorithm in the adaptive hidden semi-Markov model (HSMM) formalism. This is followed in sub-section B with a description of the Viterbi algorithm in the adaptive HSMM formalism.

### A. the Baum-Welch Algorithm in the Adaptive HMMD Formalism

$$Define \text{:} {fprod}_{t} ( i , n ) = {\prod }_{t - {δ}_{d} ( i , n )}^{t} θ ( {O}_{t} , i , \overline{d} )$$

Based on the above approximation and equation, formulas (12) and (13) used by forward algorithm can be replaced by:

$$\begin{matrix}\begin{matrix}{fbin}_{t} ( i , n ) = P ( \begin{matrix}{O}_{1} {O}_{2} … {O}_{t} , {S}_{i} ends at t with duration between \\ d and d + {δ}_{d} ( i , n ) \vert λ\end{matrix} ) \\ = \{ \begin{matrix}{fbin}_{t - 1} ( i , n ) θ ( {O}_{t} , i , \overline{d} ) - {pop}_{t} ( i , n ) + {F}_{t - 1}^{′} ( i ) & if n = 1 \\ {fbin}_{t - 1} ( i , n ) θ ( {O}_{t} , i , \overline{d} ) - {pop}_{t} ( i , n ) + {pop}_{t} ( i , n - 1 ) & if 1 < n < {D}^{*}\end{matrix}\end{matrix} \\ where & ( 35 ) \\ {F}_{t} ( i ) = {\sum }_{n = 1}^{{D}^{*}} {fbin}_{t} ( i , n ) \\ {F}_{t}^{′} ( i ) = {\sum }_{j = 1 , j \neq i}^{N} {F}_{t} ( j ) {a}_{ji} & ( 36 ) \\ {pop}_{t} ( t , n ) = queue ( i , n ) \cdot pop * {fprod}_{t} ( i , n ) & ( 37 )\end{matrix}$$

After the above calculations two updates are needed:

queue(i,n).push(popₜ(i,n−1)) (38)

fprodₜ(i,n)=fprodₜ(i,n)/θ(O_{t-δ}_{_{d}}_{(i,n)},i, d̅) (39)

The explanation for push and pop operations, etc., begins with associating every bin with a queue queue(i, n). The queue's size is equal to the number of substates grouped by this bin. At every time index, the oldest substrate: f(i, d+δ_{d}(i, n)) will be shifted out of its current bin and pushed into its next bin, as shown in (38), where queue(i, n) stores the original probability of each substates in that bin when they were pushed in. So when one substrate becomes old enough to move to next bin, its current probability can be recovered by first popping out its original probability, then multiplied by its “gain”, as shown in (37). Then an update on (39) is applied. Similarly, define:

$${bprod}_{t} ( i , n ) = {\prod }_{t}^{t + {δ}_{d} ( i , n )} θ ( {O}_{t} , i , \overline{d} ) \qquad ( 40 )$$

Formulas (14) and (15) used by the backward algorithm can be replaced by

$$\begin{matrix}\begin{matrix}{bbin}_{t} ( i , n ) = P ( {O}_{t} {O}_{t + 1} … {O}_{T} , {S}_{i} has remaining a duration between d and d + {δ}_{d} ( i , n ) at t \vert λ ) \\ = \{ \begin{matrix}θ ( {O}_{t} , i , \overline{d} ) {bbin}_{t + 1} ( i , n ) - {pop}_{t} ( i , n ) + {B}_{t + 1}^{′} ( i ) & if n = 1 \\ θ ( {O}_{t} , i , \overline{d} ) {bbin}_{t + 1} ( i , n ) - {pop}_{t} ( i , n ) + {pop}_{t} ( i , n + 1 ) & if 1 < n < {D}^{*}\end{matrix}\end{matrix} \\ where & ( 41 ) \\ {B}_{t} ( i ) = {\sum }_{n = 1}^{{D}^{*}} {bbin}_{t} ( i , n ) \\ {B}_{t}^{′} ( i ) = {\sum }_{i = 1 , i \neq i}^{N} {a}_{ij} {B}_{t} ( j ) & ( 42 ) \\ {pop}_{t} ( t , n ) = queue ( i , n ) \cdot pop * {bprod}_{t} ( i , n ) & ( 43 )\end{matrix}$$

After the above calculation two updates are needed:

queue(i,n).push(popₜ(i,n+1)) (44)

bprodₜ(i,n)=bprodₜ(i,n)/θ(O_{t+δ}_{_{d}}_{(i,n)},i, d̅)(45)

The re-estimation formulas stay unchanged.

### B. the Viterbi Algorithm in the Adaptive HMMD Formalism

The idea is similar to the one for adaptive Baum-Welch training (with computation complexity also O(TN²+TND*). where the following formulas are used:

$$\begin{matrix}{New}_{t} ( i , n ) = \{ \begin{matrix}{max}_{j = 1 , j \neq i}^{N} ( {m}_{t - 1} ( j ) + log {a}_{ji} ) & if n = 1 \\ {Sum}_{t - 1} ( i , n ) - Queue ( i , n - 1 ) \cdot pop & if 1 < n \leq {D}^{*}\end{matrix} & ( 46 ) \\ {Sum}_{t} ( i , n ) = \{ \begin{matrix}0 & if t = 1 \\ {Sum}_{t - 1} ( i , n ) + {θ}^{′} ( {O}_{t} , i , {\overline{d}}_{n} ) & if 1 < t \leq T\end{matrix} & ( 47 ) \\ {D}_{t} ( i , n ) = {Sum}_{t} ( i , n ) - {New}_{t} ( i , n ) & ( 48 ) \\ Queue ( i , n ) \cdot push ( {D}_{t} ( n , i ) ) & ( 49 ) \\ Sort ( i , n ) \cdot insert ( {D}_{t} ( n , i ) ) & ( 50 ) \\ {m}_{t} ( i , n ) = max \{ {m}_{t} ( i , n ) , {D}_{t} ( n , i ) \} & ( 51 ) \\ {m}_{t} ( i ) = {max}_{n}^{{D}^{*}} {m}_{t} ( i , n ) & ( 52 )\end{matrix}$$

The usage of the above relations is described in [11]. Note: there is non-trivial handling of many stack operations in order to attain the theoretically indicated O(TND) to O(TND*) improvement in actual implementation, as described in detail in [32].

If states have self-transitions with a notably non-geometric distribution on their self-transition ‘durations’, then a fit to a geometric distribution in this capacity, as will be forced by the standard HMM, will be weak, and HMMD modeling may serve best. In engineered communications protocols, or in engineered, modulated, nanopore transduction detector (NTD) signals, highly non-geometric distributions can be sought or induced. One encoding scheme that is strongly non-geometric in same-state duration distribution is the familiar open-reading-frame (ORF) encoding found in genomic data.

An example application of the HMM-with-duration (HMMD) method in channel current analysis includes kinetic feature extraction from EVA projected channel current data. The EVA-projected/HMMD offers a hands-off (minimal tuning) method for extracting the dwell times for various blockade states (see section III.C.7 and III.C.16 for further details).

### III.C.4 Generalized-Clique HMM Construction

We describe a clique-generalized, meta-state, HMM. The model involves both observations and states of extended length in a generalized clique structure, where the extents of the observations and states are incorporated as parameters in the new model. This clique structure was intended to address the following 2-fold hypothesis:
1) The introduction of extended observations would take greater advantage of the information contained in higher order, position-dependent, signal statistics in DNA sequence data taken from extended regions surrounding coding/noncodong sites; and
2) The introduction of extended states would attain a natural boosting by repeated look-up of the tabulated statistics associated in each case with the given type of coding/non-coding boundary.

We find that our meta-state HMM approach enables a stronger HMM-based framework for the identification of complex structure in stochastic sequential data. We show an application of the meta-state HMM to the identification of eukaryotic gene structure in the C. elegans genome. We have shown that the performance of the meta-state HMM-based gene-finder performs comparably to three of the best gene-finders in use today, GENIE, GENSCAN and HMMgene. The method shown here, however, is the bare-bones HMM implementation without use of signal sensors to strengthen localized encoding information, such as splice site information. An SVM-based improvement, to integrate directly with the approach introduced here, has been developed by SWH, and given the successful use of neural-net discriminators to improve splice-site recognition in the GENIE gene finder, there are clear prospects for further improvement in overall gene-finding accuracy with the meta-state HMM.

The traditional HMM assumes that a 1^{st} order Markov property holds among the states and that each observable depends only on the corresponding state and not any other observable. The current work entails a maximally-interpolated departure from that convention (according to training dataset size) in an attempt to leverage anomalous statistical information in the neighborhood of coding-noncoding transitions (e.g., the exon-intron, introns-exon, junk-exon, or exon-junk transitions, collectively denoted as ‘eij-transitions’). The regions of anomalous statistics are often highly structured, having consensus sequences that strongly depart from the strong independence assumptions of the 1^{st} order HMM. The existence of such consensus sequences suggests that we adopt an observation model that has a higher order Markov property with respect to the observations. Furthermore, since the consensus sequences vary by the type of transition, this observational Markov order should be allowed to vary depending on the state.

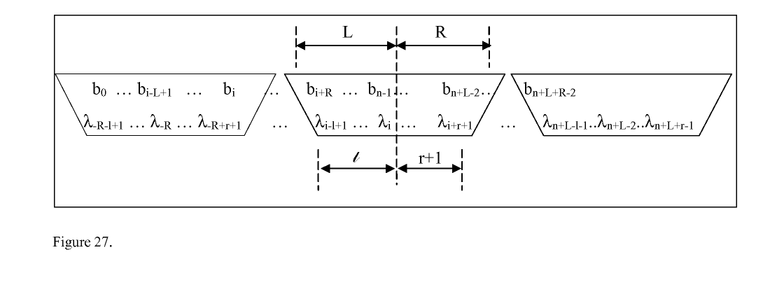

In the Viterbi context, for a given state dimer transition, such as e₀e₁ or e₀i₀, we can boost the contributions of the corresponding base emissions to the correct prediction of state by using extended states. Specifically, when encountered sequentially in the Viterbi algorithm, the sequence of eij-transition footprint states would conceivably score highly when computed for the footprint-width number of footprint-states that overlap the eij-transition (as the generalized clique is moved from left-to-right over the HMM graphical model, as shown in FIG. 27). In other words we can expect a natural boosting effect for the correct prediction at such eij-transitions (compared to the standard HMM).

The meta-state, clique-generalized, HMM entails a clique-level factorization rather than the standard HMM factorization (that describes the state transitions with no dependence on local sequence information). This is described in the general formalism to follow, where specific equations are given for application to eukaryotic gene structure identification.

Observation and state dependencies in the generalized-clique HMM are parameterized independently according to the following.

1) Non-negative integers L and R denoting left and right maximum extents of a substring, wᵢ, (with suitable truncation at the data boundaries, b₀ and bₙ₋₁) are associated with the primitive observation, bᵢ, in the following way:

wᵢ=b_{i-L+1}, . . . , bᵢ, . . . , b_{i+R}

ŵᵢ=b_{i-L+1}, . . . , bᵢ, . . . , b_{i+R-1}

2) Non-negative integers l and r are used to denote the left and right extents of the extended (footprint) states, f. Here, we show the relationships among the primitive states λ, dimer states s, and footprint states f:
sᵢ=λᵢλᵢ₊₁ (dimer state, length in λ's=2)

fᵢ=sᵢ₋ₗ₊₁, . . . , sᵢ₊ᵣ≅λᵢ₋ₗ₊₁, . . . , λᵢ, . . . , λᵢ₊ᵣ₊₁ (footprint state,length in s's=l+r)

As in the 1^{st} order HMM, the i^{th} base observation bᵢ is aligned with the i^{th} hidden state λᵢ.

With the choice of first and last clique described in FIG. 27, we have introduced some additional state and observation primitives (associated with unit-valued transition and emission probabilities) for suitable values of L, R, l, and r. These additional primitives for completion of boundary cliques are shown below

| Additional Primitives | Type of Primitive | Boundary |
|---|---|---|
| λ_{-R-\|+1}, . . . , λ₋₁ | States | Left |
| bₙ, . . . , b_{n+L+R-2} | Observations | Right |
| λₙ, . . . , λ_{n+L+r+1} | States | Right |

Given the above, the clique-factorized HMM proceeds as follows:

P(B,Λ)=P(w_{-R},f_{-R}){n_{i=-R+1}^{n+L-2}[P(wᵢ,fᵢ₋₁,fᵢ)/P(ŵᵢ,fᵢ₋₁)]}

A generalization to the Viterbi algorithm can now be directly implemented, using the above form, to establish an efficient dynamic programming table construction. Generalized expressions for the Baum-Welch algorithm are also possible. Some of the generalizations are straightforward extensions of the algorithms from 1^{st} order theory with its minimal clique. Sequence-dependent transition properties in the generalized-clique formalism have no counterpart in the standard 1^{st} Order HMM formalism, however, and that will be elaborated upon here. The core term in the clique-factorization above can be written as:

$$\begin{matrix}\frac{P ( {w}_{i} , {f}_{i - 1} , {f}_{i} )}{P ( {\tilde{w}}_{i} , {f}_{i - 1} )} = \frac{P ( {w}_{i} , {f}_{i - 1} , {f}_{i} )}{{Σ}_{{f}_{i ( allowed )}^{′}} P ( {\tilde{w}}_{i ,} {f}_{i - 1} , {f}_{i}^{′} )} \\ = \frac{P ( {w}_{i} \vert {f}_{i - 1} , {f}_{i} ) P ( {f}_{i} \vert {f}_{i - 1} ) P ( {f}_{i - 1} )}{{Σ}_{{f}_{i}^{′}} P ( {\tilde{w}}_{i} \vert {f}_{i - 1} , {f}_{i}^{′} ) P ( {f}_{i}^{′} \vert {f}_{i - 1} ) P ( {f}_{i - 1} )} .\end{matrix}$$

We now examine specific cases of this equation to clarify the novel improvements that result. Consider, first, the case with the first footprint state being of eij-transition type, and the second thereby constrained to be of the appropriate xx-type:

$$\begin{matrix}\frac{P ( {w}_{i} , {f}_{i - 1} , {f}_{i} )}{P ( {\tilde{w}}_{i} , {f}_{i - 1} )} {\vert}_{{{f}_{i - 1} ∈ eij}_{{[ {f}_{i}^{′} allowed ∈ xx ]}_{unique}}} = P ( {b}_{i + R} \vert {\tilde{w}}_{i} , {f}_{i - 1} ) P ( {f}_{i} \vert {f}_{i - 1} ) \\ = P ( {b}_{i + R} \vert {\tilde{w}}_{i} , {f}_{i - 1} )\end{matrix}$$

Consider, next, the case with the first footprint state being xx-type:

$$\frac{P ( {w}_{i} , {f}_{i - 1} , {f}_{i} )}{P ( {\tilde{w}}_{i} , {f}_{i - 1} )} {\vert}_{{f}_{i - 1} ∈ xx} = \frac{P ( {w}_{i} \vert {f}_{i} ) P ( {f}_{i} \vert {f}_{i - 1} )}{{Σ}_{{f}_{i}^{′}} P ( {\tilde{w}}_{i} \vert {f}_{i}^{′} ) P ( {f}_{i}^{′} \vert {f}_{i - 1} )}$$

If the second footprint is eij-transition type, then the equation has two sum terms in the denominator if the first transition is ii or jj transition, and a third sum contribution (the term with ‘f_{ey}’) if the first transition is an ee-transition:

$$\begin{matrix}\frac{P ( {w}_{i} , {f}_{i - 1} , {f}_{i} )}{P ( {\tilde{w}}_{i} , {f}_{i - 1} )} {\vert}_{{{f}_{i - 1} ∈ xx ,}_{{f}_{i} ∈ eij}} = \frac{P ( {w}_{i} \vert {f}_{i} ) P ( {f}_{i} \vert {f}_{i - 1} )}{\begin{matrix}P ( {\tilde{w}}_{i} \vert {f}_{i} ) P ( {f}_{i} \vert {f}_{i - 1} ) + P ( {\tilde{w}}_{i} \vert {f}_{xx} ) P ( {f}_{xx} \vert {f}_{i - 1} ) + \\ P ( {\tilde{w}}_{i} \vert {f}_{ey} ) P ( {f}_{ey} \vert {f}_{i - 1} )\end{matrix}} \\ = \frac{P ( {b}_{i + R} \vert {\tilde{w}}_{i} , {f}_{i} )}{\begin{matrix}1 + ( \frac{P ( {\tilde{w}}_{i} \vert {f}_{xx} )}{P ( {\tilde{w}}_{i} \vert {f}_{i} )} ) ( \frac{P ( {f}_{xx} \vert {f}_{i - 1} )}{P ( {f}_{i} \vert {f}_{i - 1} )} ) + \\ ( \frac{P ( {\tilde{w}}_{i} \vert {f}_{ey} )}{P ( {\tilde{w}}_{i} \vert {f}_{i} )} ) ( \frac{P ( {f}_{ey} \vert {f}_{i - 1} )}{P ( {f}_{i} \vert {f}_{i - 1} )} )\end{matrix}}\end{matrix}$$

The term with ‘f_{ey}’ is the footprint state fₑᵢ if fᵢ is ‘ej’-type, and is footprint state fₑⱼ if fᵢ is ‘ei’-type.

$$\frac{P ( {w}_{i} , {f}_{i - 1} , {f}_{i} )}{P ( {\tilde{w}}_{i} , {f}_{i - 1} )} {\vert}_{{{f}_{i - 1} ∈ xx ,}_{{f}_{i} ∈ eij}} = \frac{P ( {b}_{i + R} \vert {\tilde{w}}_{i} , {f}_{i} ) P ( {f}_{i} \vert {f}_{i - 1} )}{P ( {f}_{i} \vert {f}_{i - 1} ) + P ( {f}_{xx} \vert {f}_{i - 1} ) ( \frac{P ( {\tilde{w}}_{i} \vert {f}_{xx} )}{P ( {\tilde{w}}_{i} \vert {f}_{i} )} ) + P ( {f}_{ey} \vert {f}_{i - 1} ) ( \frac{P ( {\tilde{w}}_{i} \vert {f}_{ey} )}{P ( {\tilde{w}}_{i} \vert {f}_{i} )} )}$$

If the first and second footprints are xx-type, then have the following form, again with only the first two terms in the denominator if xx=ii or jj, and with the additional third term if xx is an ee-transition:

$$\frac{P ( {w}_{i} , {f}_{i - 1} , {f}_{i} )}{P ( {\tilde{w}}_{i} , {f}_{i - 1} )} {\vert}_{{{f}_{i - 1} ∈ xx ,}_{{f}_{i} ∈ xx}} = \frac{P ( {b}_{i + R} \vert {\tilde{w}}_{i} , {f}_{i} ) P ( {f}_{i} \vert {f}_{i - 1} )}{P ( {f}_{i} \vert {f}_{i - 1} ) + P ( {f}_{xy} \vert {f}_{i - 1} ) ( \frac{P ( {\tilde{w}}_{i} \vert {f}_{xy} )}{P ( {\tilde{w}}_{i} \vert {f}_{i} )} ) + P ( {f}_{xz} \vert {f}_{i - 1} ) ( \frac{P ( {\tilde{w}}_{i} \vert {f}_{xz} )}{P ( {\tilde{w}}_{i} \vert {f}_{i} )} )}$$

In the above expressions we clearly have sequence dependent transitions. For fᵢ₋₁εxx, and fᵢεeij we have:

$$\tilde{P} ( {f}_{i} \vert {f}_{i - 1} ) = P ( {f}_{i} \vert {f}_{i - 1} ) / [ P ( {f}_{i} \vert {f}_{i - 1} ) + P ( {f}_{xx} \vert {f}_{i - 1} ) ( \frac{P ( {\tilde{w}}_{i} \vert {f}_{xx} )}{P ( {\tilde{w}}_{i} \vert {f}_{i} )} ) + \{ ey term \} ] .$$

Also not that the sequence dependencies enter via likelihood ration terms. These are precisely the type of terms examined in an effort to improve the HMM-based discriminatory ability via use of SVMs.

We now examine the above equations in situations where the sequence-dependent likelihood-ratios strongly favor one state model over another, with particular attention as to whether there are sequence dependent scenarios offering recovery of the heavy-tail distribution:

$$\begin{matrix}ρ = \frac{P ( {w}_{i} , {f}_{i - 1} , {f}_{i} )}{P ( {\tilde{w}}_{i} , {f}_{i - 1} )} {\vert}_{{{f}_{i - 1} ∈ xx ,}_{{{f}_{i} ∈ xx ,}_{{x ∈ \{ e , i , j \} ,}_{suppose x = 1}}}} \\ = \frac{P ( {b}_{i + R} \vert {\tilde{w}}_{i} , {f}_{i} ) P ( {f}_{i} \vert {f}_{i - 1} )}{P ( {f}_{i} \vert {f}_{i - 1} ) + P ( {f}_{allowed}^{′} \vert {f}_{i - 1} ) ( \frac{P ( {\tilde{w}}_{i} \vert {f}_{allowed}^{′} )}{P ( {\tilde{w}}_{i} \vert {f}_{i} )} )} \\ = \frac{P ( {b}_{i + R} \vert {\tilde{w}}_{i} , ii ) P ( ii \vert ii )}{P ( ii \vert ii ) + P ( ie \vert ii ) ( \frac{P ( {\tilde{w}}_{i} \vert ie )}{P ( {\tilde{w}}_{i} \vert ii )} )}\end{matrix}$$

P(\tilde{w}ᵢ|ie)=P(\tilde{w}ᵢ|ii)(weakly classified)

ρ|_{ie≅ii}≅P(b_{i+R}|\tilde{w}ᵢ,ii)P(ii|ii)/[P(ii|ii)+P(ie|ii)]=P(b_{i+R}|\tilde{w}ᵢii)P(ii|ii) Case 1:

In this case we recover regular 1^{st} order HMM theory, with geometric distribution-on-‘ii’.

Case 2:

$$P ( {\tilde{w}}_{i} \vert ie ) >> P ( {\tilde{w}}_{i} \vert ii ) ( strongly classified - in local region )$$

$$ρ {\vert}_{ie >> i i} ≅ P ( {b}_{i + R} \vert {\tilde{w}}_{i} , ii ) [ \frac{P ( {\tilde{w}}_{i} \vert ii ) P ( ii \vert ii )}{P ( {\tilde{w}}_{i} \vert ie ) P ( ie \vert ii )} ]$$

In this case we obtain contributions less than the regular 1^{st} order HMM counterpart, effectively shortening the geometric distribution on ‘ii’→e.g., it adaptively switches to a shorter, sharper, fall-off on the distribution in a sequence dependent manner.

P(\tilde{w}ᵢ|ie)<<PI\tilde{w}ᵢ|ii)

ρ|_{ie<<ii}≅P(b_{i+R}|\tilde{w}ᵢ,ii)1 Case 3:

In this case we obtain contributions greater than the regular 1^{st} order HMM theory. In particular, we recover the heavy tail distribution in a sequence dependent manner.

$$\frac{P ( {w}_{i} , {f}_{i - 1} , {f}_{i} )}{P ( {\tilde{w}}_{i} , {f}_{i - 1} )} {\vert}_{{{f}_{i - 1} ∈ ie ,}_{{f}_{i} ∈ ee}} = P ( {b}_{i + R} \vert {\tilde{w}}_{i} , {f}_{i - 1} )$$

One more example-case will be considered, that involving acceptor splice-site recognition:

$$\begin{matrix}ρ = \frac{P ( {w}_{i} , {f}_{i - 1} , {f}_{i} )}{P ( {\tilde{w}}_{i} , {f}_{i - 1} )} {\vert}_{{{{f}_{i - 1} ∈ ii ,}_{{f}_{i} ∈ \{ ii , ie \} ,}}_{suppose {f}_{i} = ie}} \\ = \frac{P ( {b}_{i + R} \vert {\tilde{w}}_{i} , {f}_{i} ) P ( {f}_{i} \vert {f}_{i - 1} )}{P ( {f}_{i} \vert {f}_{i - 1} ) + P ( ii \vert ii ) ( \frac{P ( {\tilde{w}}_{i} \vert ii )}{P ( {\tilde{w}}_{i} \vert ie )} )} \\ = \frac{P ( {b}_{i + R} \vert {\tilde{w}}_{i} , ie ) P ( ie \vert ii )}{P ( ie \vert ii ) + P ( ii \vert ii ) ( \frac{P ( {\tilde{w}}_{i} \vert ii )}{P ( {\tilde{w}}_{i} \vert ie )} )}\end{matrix}$$

P(\tilde{w}ᵢ|ie)≅P(\tilde{w}ᵢ|ii)

ρ|_{ie≅ii}≅P(b_{i+R}|\tilde{w}ᵢ,ie)P(ie|ii) Case 1:

We recover regular HMM theory.

P(\tilde{w}ᵢ|ie)>>P(\tilde{w}ᵢ|ii)

ρ|_{ie>>ii}≅P(b_{i+R}|\tilde{w}ᵢ,ie) Case 2:

Greater than regular 1^{st} order HMM theory. Removes key penalty of P(ie|ii) factor when sequence match overrides. Resolves weak contrast resolution at 1^{st} order.

Case 3:

$$P ( {\tilde{w}}_{i} \vert ie ) << P ( {\tilde{w}}_{i} \vert ii )$$

$$ρ {\vert}_{ie << ii} ≅ ( {b}_{i + R} \vert {\tilde{w}}_{i} , ie ) [ \frac{P ( ie \vert ii ) P ( {\tilde{w}}_{i} \vert ie )}{P ( ii \vert ii ) P ( {\tilde{w}}_{i} \vert ii )} ]$$

Less than regular 1^{st} Order HMM, effectively weakens ie transition strength (the classic major-transition bias factor).

The clique factorization also allows for an alternate representation such that the internal scalar-based state discriminant can be replaced with a vector-based feature. This would allow the substitution of a discriminant based on a Support Vector Machine (SVM) as demonstrated for splice sites (see Proof-of-Concept Experiments in Sec. II). Also, we note that these alternate representations would not introduce any significant increase in computational complexity, since the SVM-based discriminant, having been trained offline, would require the computation of a simple vector dot product. Thus, the likelihood ratio look-up can simply be to the tabulated sequence probability estimates (based on counts, as outlined in what follows), or make use of BLAST (homology-based) test, or an SVM-based test (the latter two cases areas of ongoing work, see Discussion).

All predictions are based on state prior, state transition, and emission probabilities which are estimated directly from counts in the training data without any further refinement. The meta-state HMM model is interpolated to highest Markov order on emission probabilities given the training data size, and to highest Markov order (subsequence length) on the footprint states. The former is accomplished via simple count cutoff rules, the latter via an identification of anomalous base statistics near the coding/noncoding-transitions, initially, followed by direct HMM performance tuning. Allowed footprint transitions are restricted to those that have at most one coding/noncoding-transition, which leads to only linear growth in state number with footprint size, not geometric growth, enabling the full advantage of generalized-clique modeling at a computational expense little more than that of a standard HMM.

In the meta-state HMM we have linear growth in number of states with linear increase in footprint size F, with computational time complexity given by O(T(F+L+R)), where linearity in F for fixed L and R was verified in the set of time trials.

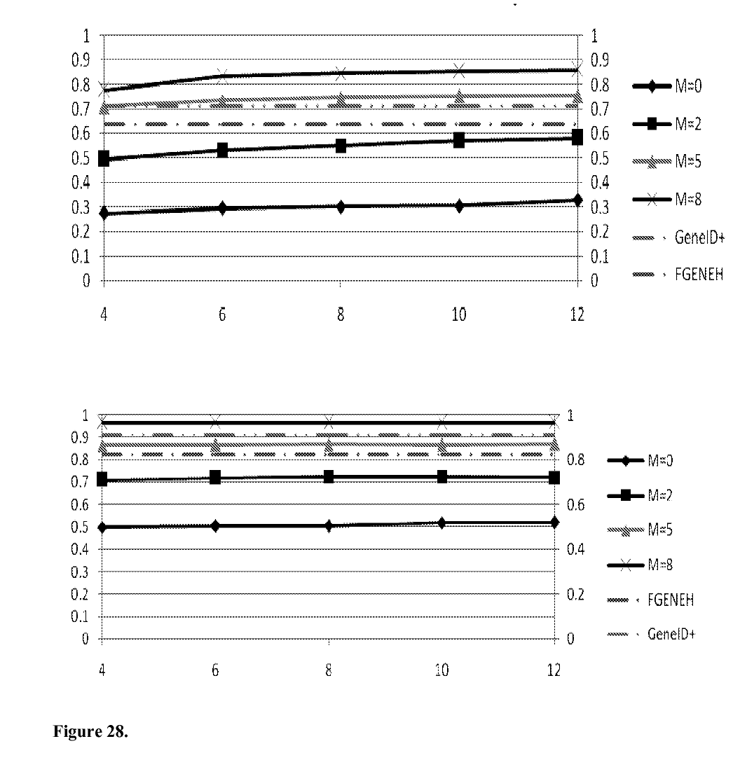

Exon- and base-level accuracy for values of the parameters M, F, L, and R were tested and examined for stability. FIG. 28 below shows plots for exon- and base-level maxima, respectively, over the parameters L and R of meta-state HMM's prediction performance. The plots illustrate the enhanced performance of the meta-state HMM over simpler prediction models, including the (null hypothesis result) meta-state HMM for which the base Markov parameter, M=0. (Note: the meta-state HMM uses only the intrinsic information in the data—making no use of extrinsic information, such as EST's, protein homology, etc.) FIG. 28 also shows good performing predictors from the original benchmark study, FGENEH and GeneID+, that use intrinsic and extrinsic genomic information, respectively. At both the full exon- and base-levels, the meta-state HMM outperforms standard HMM approaches by a discernable margin.

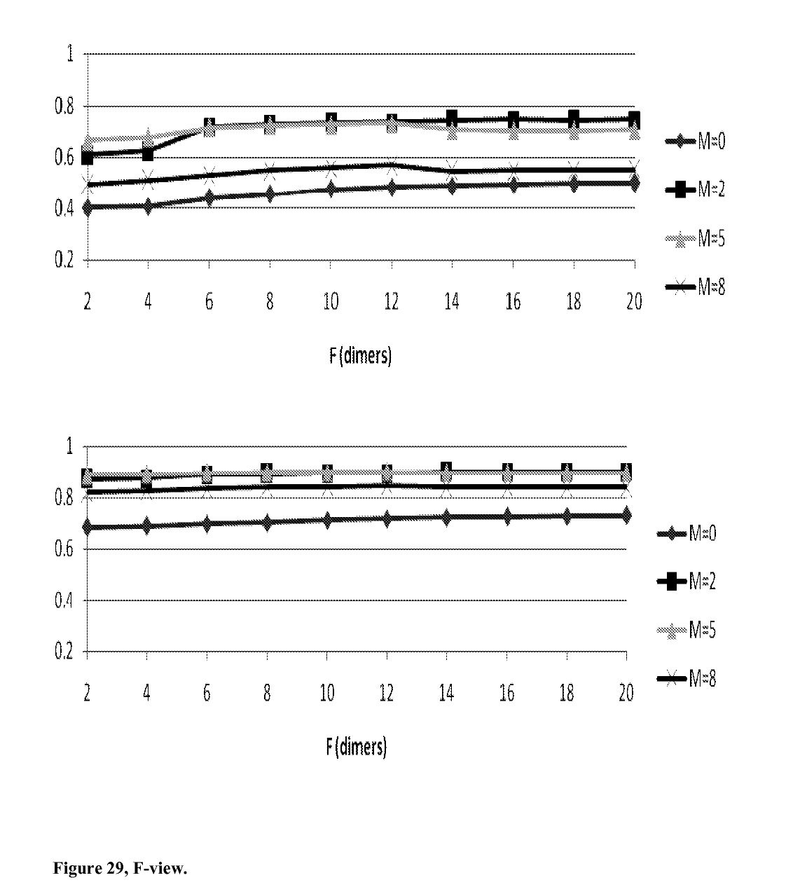

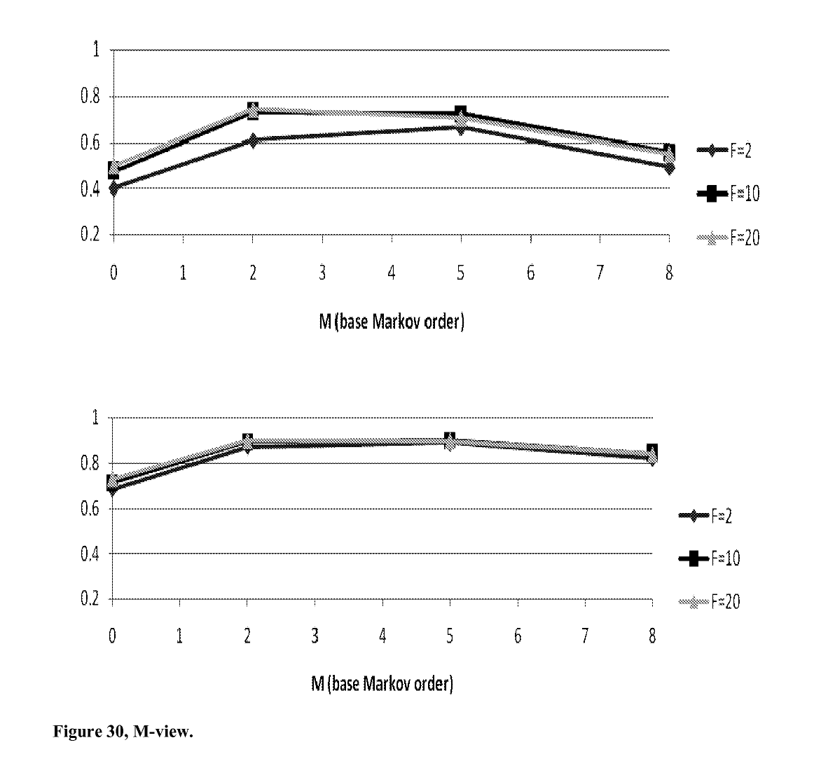

The results shown in FIG. 29 (F-view, with FIG. 30 showing ‘M-view’) indicate that a local maximum for the exon and base level predictions was attained at F=12, with a plateau for F>12 extending to F=20, with exact exon prediction accuracy 74% and base accuracy 90%. In comparing the results of this data set to the other results in this effort, the reduced performance at full exon level for M=8 compared to that for M=5 is an indication of insufficient training size reflected in lack of support for M=8 probability estimates at splice sites. The degree of preconditioning in our data set is minimal, such that there is allowance in the data for disagreement with the consensus dinucleotide introns sequences, gt and ag, as well as the incorporation of reverse encodings. As mentioned previously, we arrive at a base accuracy of 90%. The prospects for improving this result further with the foundation in place are many, starting with simply enlarging the training dataset by including similar genomes from other nematodes, C. Briggsiae in particular.

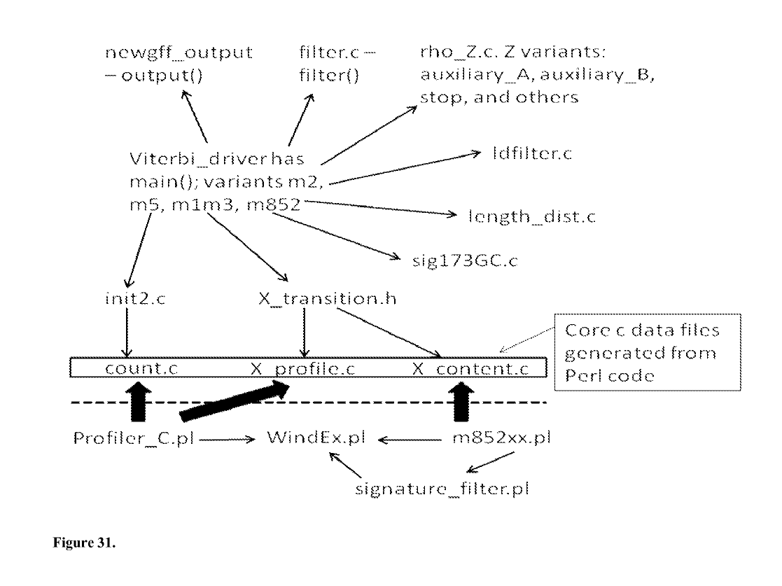

Efficient chunking of training and viterbi table construction is performed for gene structure identification on a network of computers via direct shell command for data transfers and result mergers, with implementation shown as shown in FIG. 31 for model description (described in more detail in Sec. III.C.5 to follow). This is possible by simple cloning of the software and data chunks onto a network. More formal client/server formalism of this process is the contribution in the derivative work that is described after the HOHMM theory/model description to follow. The number of allowed transitions among footprint states is restricted to linear growth: # transitions=13+20(F), where F=l+r+1=the size of the footprint state string in units of state primitives.

### III.C.5 Method for Modeling Gene Finder State Structure

### The Exon Frame States and Other HMM States.

Exons have a 3-base encoding as directly revealed in a mutual information analysis of gapped base statistical linkages in prokaryotic DNA, as shown in. The 3-base encoding elements are called codons, and the partitioning of the exons into 3-base subsequences is known as the codon framing. A gene's coding length must be a multiple of 3 bases. The term frame position is used to denote one of the 3 possible positions −0, 1, or 2 by our convention—relative to the first base of a codon. Introns may interrupt genes after any frame position. In other words, introns can split the codon framing either at a codon boundary or one of the internal codon positions.

Although there is no need for framing among introns, for convenience we associate a fixed frame label with the intron as a tracking device in order to ensure that the frame of the following exon transition is constrained appropriately. The primitive states of the individual bases occurring in exons, introns, and junk are denoted by: Exon states={e₀, e₁, e₂},Intron states={i₀, i₁, i₂}, Junk state={j}.

The vicinity around the transitions between exon, intron and junk usually contains rich information for gene identification. The junk to exon transition usually starts with an ATG; the exon to junk transition ends with one of the stop codons {TAA, TAG, TGA}. Nearly all eukaryotic introns start with GT and end with AG (the AG-GT rule). To capture the information at these transition areas we build a position- dependent emission (pde) table for base positions around each type of transition point. It is called ‘position-dependent’ since we make estimation of occurrence of the bases (emission probabilities) in this area according to their relative distances to the nearest non-self state transition. For example, the start codon ‘ATG’ is the first three bases at the junk-exon transition. The size of the pde region is determined by a window size parameter centered at the transition point (thus, only even numbered window sizes are plotted in the Results). We use four transition states to collect such position-dependent emission probabilities ie; je0; ei; e2j: Considering the framing information, we can expand the above four transition into eight transitions i2e0; i0e1; i1e2; je0; e0i0; e1i1; e2i2; e2j: We make i2e0; i0e1; i1e2 share the same ie emission table and e0i0; e1i1; e2i2 share the same ei emission tables. Since we process both the forward-strand and reverse-strand gene identifications simultaneously in one pass, there is another set of eight state transitions for the reverse strand. Forward states and their reverse state counterparts also share the same emission table (i.e., their instance counts and associated statistics are merged). Based on the training sequences' properties and the size of the training data set, we adjust the window size and use different Markov emission orders to calculate the estimated occurrence probabilities for different bases inside the window (e.g., interpolated Markov models are used).

The regions on either side of a pde window often include transcription factor binding sites, etc., such as the promoter for the je window. Statistics from these regions provide additional information needed to identify start of gene coding and alternative splicing. The statistical properties in these regions are described according to zone-dependent emission (zde) statistics. The signals in these areas can be very diverse and their exact relative positions are typically not fixed positionally. We apply a 5^{th}-order Markov model on instances in the zones indicated (further refinements with hash-interpolated Markov models have also met with success but are not discussed further here). The size of the ‘zone’ region extends from the end of the position-dependent emission table's coverage to a distance specified by a parameter. For the dataruns shown in the Results, this parameter was set to 50.

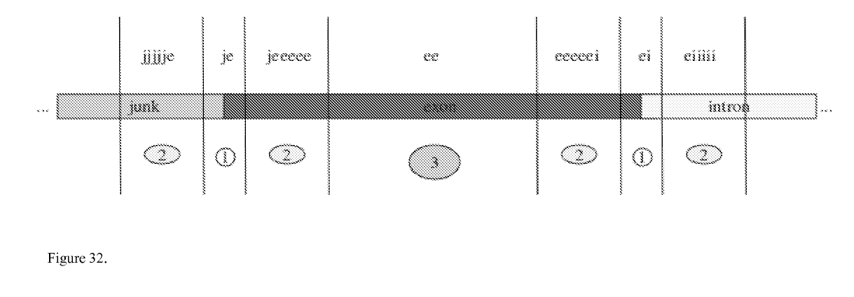

There are eight zde tables:{ieeeee, jeeeee, eeeeei, eeeeej, eiiiii, iiiiis, ejjjjj, jjjjje}, where ieeeee corresponds to the exon emission table for the downstream side of an ie transition, with zde region 50 bases wide, e.g., the zone on the downstream side of a non-self transition with positions in the domain (window, window+50].We build another set of eight hash tables for states on the reverse strand. We see 2% performance improvement when the zde regions are separated from the bulk dependent emissions (bde), the standard HMM emission for the regions. When outside the pde and zde regions, thus in a bde region, there are three emission tables for both the forward and reverse strands exon, intron, and junk states, corresponding to the normal exon emission table, the normal intron emission table and the normal junk emission table. The three kinds of emission processing are shown in FIG. 32.

The model contains the following 27 states in total for each strand, three each of {ieeeee, jeeeee, eeeeei, eeeeej, eeeeee, eiiiii, iiiiie, iiiiii}, corresponding to the different reading frames; and one each of {ejjjjj, jjjjje, jjjjjj}. As before, there is another set of corresponding reverse-strand states, with junk as the shared state. When a state transition happens, junk to exon for example, the positional-dependent emissions inside the window (je) will be referenced first, then the state travels to the zone-dependant emission zone (jeeeee), then travels to the state of the normal emission region (eeeee), then travels to another state of zone-dependent emissions (eeeeei or eeeeej), then to a bulk region of self-transitions (iiiiii or jjjjjj), etc. The duration information of each state is represented by the corresponding bin assigned by the algorithm. For convenience in calculating emissions in the Viterbi decoding, we pre-compute the cumulant emission tables for each of 54 sub-states (states of the forward and reverse strand), then as the state transitions, its emission contributions can be determined by the differences between two references to the pre-computed cumulant array data.

The occurrence of a stop codon (TAA, TAG or TGA) that is in reading frame 0 and located inside an exon, or across two exons because of the intron interruption, is called as an ‘in-frame stop’. In general the occurrences of in-frame stops are considered very rare. We designed our in-frame stop filter to penalize such Viterbi paths. A DNA sequence has six reading frames (read in six ways based on frames), three for the forward strand and three for the reverse strand. When pre-computing the emission tables in the above for the sub-states, for those sub-states related to exons we consider the occurrences of in-frame stop codons in the six reading frames. For each reading frame, we scan the DNA sequence from left to the right and whenever a stop codon is encountered in-frame we add to the emission probability for that position a user defined stop penalty factor. In this way, the in-frame stop filter procedure is incorporated into the emission table building process and does not bring the additional computational complexity to the program. The algorithmic complexity of the whole program is O(TND*) where N=54 sub-states and D* is the number of bins for each sub-state, and the memory complexity is O(TN), via the HMMBD method.

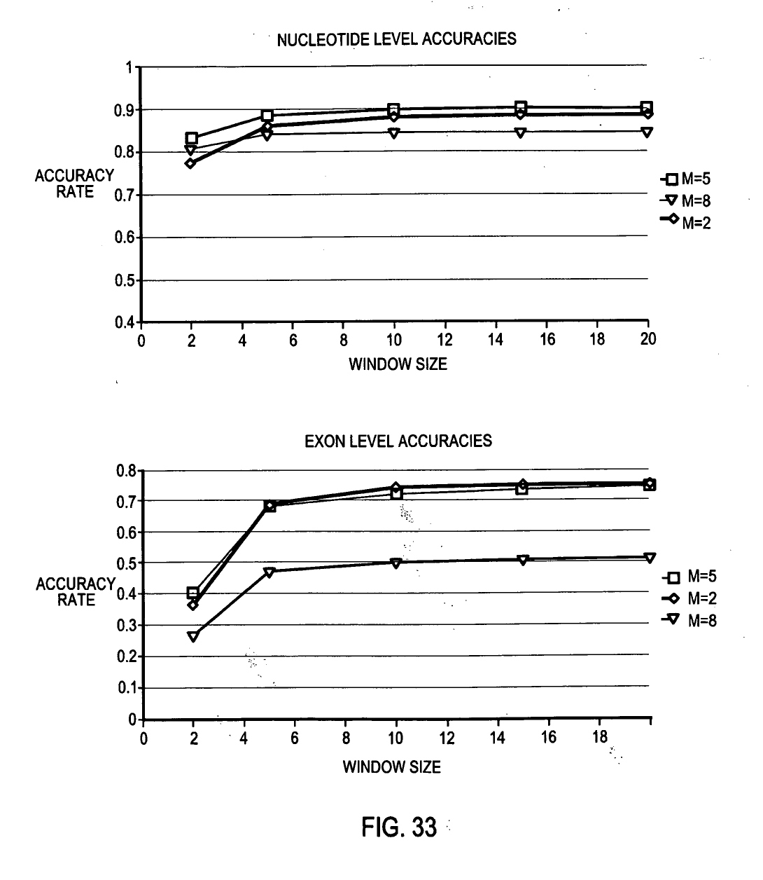

In FIG. 33 we show the results of the experiments where we tune the Markov order and window size parameters to try to reach a local maximum in the predication performance for both the full exon level and the individual nucleotide level. We compare the results of three kinds of different configurations. In the first configuration, shown in FIG. 33, we have the HMM with binned duration (HMMBD) with position-dependent emissions (pde's) and zone dependent emissions (i.e., HMMBD+pde+zde).

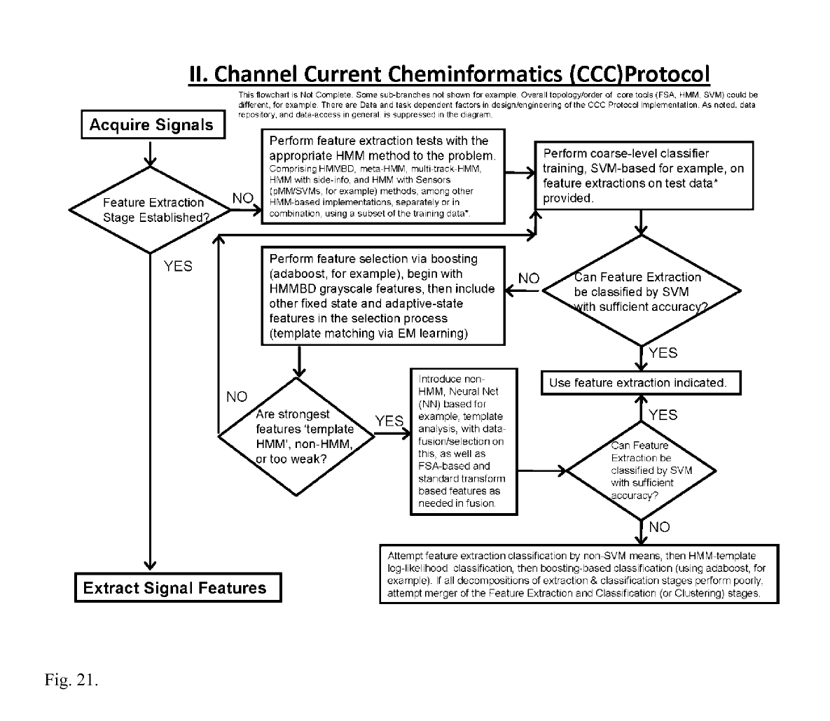

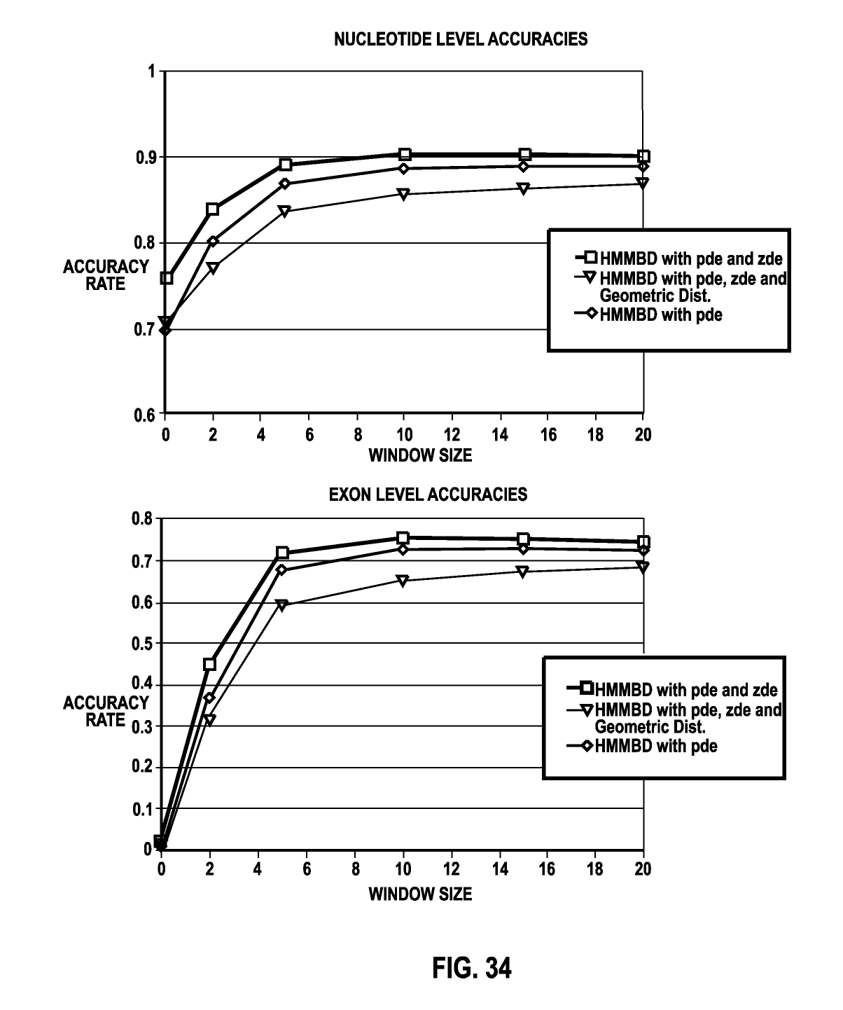

In the second configuration, we turn off the zone dependent emissions (so, HMMBD+pde), the resulting accuracy suffers a 1.5-2.0% drop as shown in FIG. 34. In the third setting, we use the same setting as the first setting except that we now use the geometric distribution that is implicitly incorporated by HMM as the duration distribution input to the HMMBD (HMMBD+pde+zde+Geometric). One preference is to have an approximation of the performance of the standard HMM with pde and zde contributions. As show in FIG. 21, the performance of the result has about 3% to 4% drop (conversely, the performance improvement with HMMD modeling, with the duration modeling on the introns in particular, is improved 3-4% in this case, with a notable robustness at handling multiple genes in a sequence—as seen in the intron submodel that includes duration information). When the window size becomes 0, i.e., when we turn off the setting of position-dependent emissions, the performances of the results drop sharply as shown in FIG. 34. This is because the strong information at the transitions, such as the start codon with ATG or stop codons with TAA, TAG or TGA, etc., are now ‘buried’ in the bulk statistics of the level accuracy rate results for three different kinds of settings: exon, intron, or junk regions.

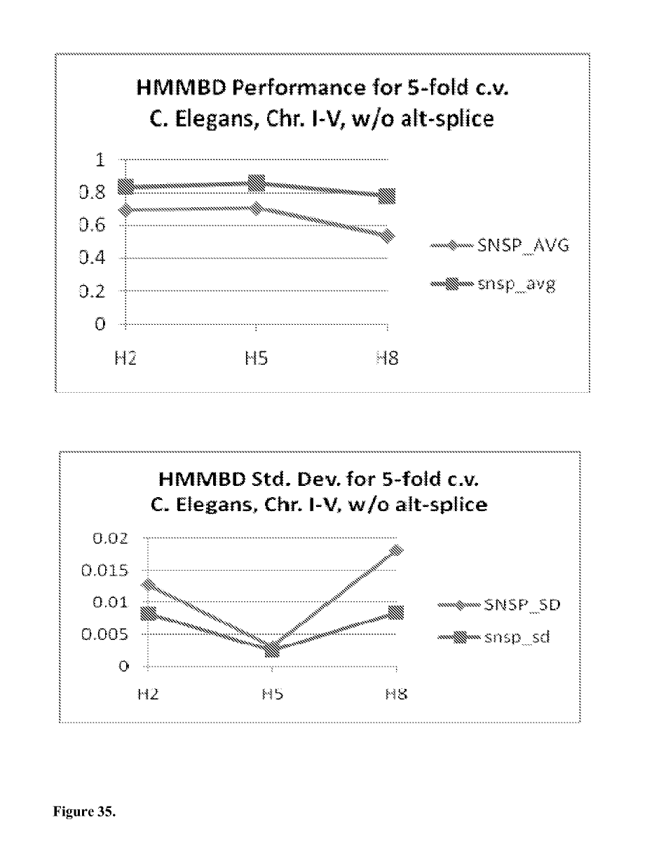

A full five-fold cross validation is performed for the HMMBD+pde+zde case, as shown in FIG. 35. The fifth and second order Markov models work best, with the fifth order Markov model having a notably smaller spread in values. The best case performance was 86% accuracy at the nucleotide level and 70% accuracy at the base level (compared with 90% on nucleotides and 74% on exons on the exact same datasets in the meta-HMM described in Sec. III.C.4).

### III.C.6 Emission Inversion

Observed data is brought into the HMM/EM process chiefly through the emission probabilities. When the observed states and emitted states share the same alphabet, the roles of observed states and emitted states can be reversed for possible improvement to classification performance.

Experimentally, emission inversion is found to work well with channel current data (available as an option in Scanbinary.c in FIG. 31). In the case where the 150-component feature set was used, inverting the emissions yields a 5% peak increase in accuracy. This result was stable over a large range of kernel parameter.

In the HMM, emissions are the probability of a hidden state emitting an observed state:

emission_probabilities[state][observed_value]≡P(X=b|S=k),

where b=observed_value and k=state. The data inversion implementation simply exchanges the roles of the actual state and the observed state as follows:

emission_probabilities[observed_value][state]≡P(X=k|S=b),

This simple inversion introduces another information factor into the Viterbi algorithm and can improve performance. So, with inversion, instead of P(X=b|S=k) we now have P(X=k|S=b). In our analysis we have P(X=k|S=b) P(S=k|X=b), so the change with inversion is approximately a factor of [P(S=k)/P(X=b)] introduced at each column position. For the Viterbi calculation, with sums on log contributions from each column, i.e., log [P(S=k)/P(X=b)], the new term sums to the length-weighted relative entropy between the state prior probability and emission posterior probability: −L D(X∥S), where L is the length of data parsed and ‘D(*∥*)’ is the Kullback-Leibler Divergence (or relative entropy).

### III.C.7 Emission Variance Amplification.

HMM with EVA is a method to reduce the gaussian noise band around distinct channel-blockade levels. In a non-EVA approach, emission probabilities are initialized with a gaussian profile. The initialization is as follows:

emission_probabilities[i][k]=exp(−(k−i)*(k−i)/(2*variance))

where “i” and “k” are each a state with 0<={i, k}<=49 in a 50 state system. To perform EVA, the variance is simply multiplied by a factor that essentially widens the gaussian distribution imposed on possible emissions, and the equation simply becomes

exp(−(k−i)*(k−i)/(2*variance*eva_factor)).

Essentially EVA boosts the variance of the distribution and yields the following effect: for states near a dominant level in the blockade signal, the transitions are highly favored to points nearer that dominant level. This is a simple statistical effect having to do with the fact that far more points of departure are seen in the direction of the nearby dominant level than in the opposite direction. When in the local gaussian tail of sample distribution around the dominant level, the effect of transitions towards the dominant level over those away from the dominant level can be very strong. In short, a given point is much more likely to transition towards the dominant level than away from it.

### III.C.8 Modified Adaboost for Feature Election and Data Fusion

Adaptive Boosting (AdaBoosting) is typically used for classification purposes. In general, AdaBoost is an iterative process that uses a collection of weak learners to create a strong classifier. Training data is given a weight, and at each iteration, the weak learners are trained on this weighted data. Weights for these data points are then updated based on the error rate of the weak learner and whether a given data point was classified correctly or not. The consensus vote at each iteration is treated as a hypothesis, and weights are given to a hypothesis based on its accuracy. At the end of the iterative process, final classification is done using all hypotheses and their corresponding weights. In this way, AdaBoost is able to use a set of weak learners to generate a strong classifier.

As a classification method, one of the main disadvantages of AdaBoost is that it is prone to overtraining. However, AdaBoost is a natural fit for feature selection. Here, overtraining is not a problem, as AdaBoost finds diagnostic features and those features can be passed on to a classifier that does not suffer from overtraining (such as an SVM).

As has been shown in the spike analysis, careful selection of features plays a significant role in classification performance. However, adding non-characteristic or noisy features will hurt classification performance. In addition, recall from the discussion in Background that the last set of 50 components from the baseline 150-component feature vector are compressed transition probabilities. With a 50 state HMM, there would be 50*50 or 2500 possible transitions. However, a means of compression is necessary because many of these transitions are very unlikely and contribute noise to the feature vector. Without compression, classification performance suffers as a result, yet it is uncertain as to whether diagnostic information has been inadvertently discarded in the manual compression of the transition probabilities. An automated approach is desired to solve the issue of feature selection. Here, a hybrid AdaBoost approach is used as an automated, objective means of feature selection.

In Modified AdaBoost (see Proof-of-concept Exp.s, Sec. II) weights are given to the weak learners as well as the training data. The key modifications here are to give each column of features in a training set a weak learner and to update each weak learner every iteration, not just updates the weights on the data. In an example where there is a set of 150-component feature vectors, 150 weak learners would be created. As previously mentioned, each weak learner corresponds to a single component and classifies a given feature vector based solely on that one component. Then, weights for these weak learners are introduced. In each iteration of this modified AdaBoost process, weights for both the input data and the weak learners are updated. The weights for the input data are updated as in the standard AdaBoost implementation, while weights on the individual weak learners are updated as if each were a complete hypothesis in the standard AdaBoost implementation. At the end of the iterative process, the weak learners with the highest weights, that is, the weak learners that represent the most diagnostic features, are selected and those features are passed on to a SVM for classification. Thus, the benefits of both AdaBoost and SVMs are obtained. This is acutely needed when enriching the selection of statistical measures with the gap and hash interpolated Markov models (ghIMMs—described in material that follows).

### III.C.9 Gap and Sequence-Specific (Hash) Interpolated Markov Models

The program gIMM.pl implements the motif finding and generalized HMM structure identifications described below.

Interpolated Markov Model (IMM):

The order of the MM is interpolated according to some globally imposed cut-off criterion, such as a minimum sub-sequence count: 4th-order passes if Counts (x₀; x₋₁; x₋₂; x₋₃; X₋₄)>cutoff for all x₋₄ . . . x₀ sub-sequences (100, for example), the utility of this becomes apparent with the following re-expression:

$$\begin{matrix}P ( {x}_{0} \vert {x}_{- 1} ; {x}_{- 2} ; {x}_{- 3} ; {x}_{- 4} ) = \frac{P ( {x}_{0} ; {x}_{- 1} ; {x}_{- 2} ; {x}_{- 3} ; {x}_{- 4} )}{P ( {x}_{- 1} ; {x}_{- 2} ; {x}_{- 3} ; {x}_{- 4} )} \\ = \frac{Counts ( {x}_{0} ; {x}_{- 1} ; {x}_{- 3} ; {x}_{- 4} )}{Counts ( {x}_{- 1} ; {x}_{- 2} ; {x}_{- 3} ; {x}_{- 4} )} \times \\ \frac{TotalCounts ( length 5 )}{TotalCounts ( length 4 )} \\ = \frac{Counts ( {x}_{0} ; {x}_{- 1} ; {x}_{- 2} ; {x}_{- 3} ; {x}_{- 4} )}{Counts ( {x}_{- 1} ; {x}_{- 2} ; {x}_{- 3} ; {x}_{- 4} ) [ \frac{( L - 4 )}{( L - 3 )} ]} \\ ≅ \frac{Counts ( {x}_{0} ; {x}_{- 1} ; {x}_{- 2} ; {x}_{- 3} ; {x}_{- 4} )}{Counts ( {x}_{- 1} ; {x}_{- 2} ; {x}_{- 3} ; {x}_{- 4} )}\end{matrix}$$

Suppose Counts (x₀; x₋₁; x₋₂; x₋₃; x₋₄; x₋₅)<cutoff for some x₋₅ . . . x₀ sub-sequence, then the interpolation would halt (globally), and the order of MM used would be 4th order.

Gap Interpolated Markov Model (gIMM):

Like IMM with its count cutoff, but when going to higher order in the interpolation there is no constraint to contiguous sequence elements—I.e., ‘gaps’ are allowed. The resolution of what gap-size to choose when going to the next higher order is resolved by evaluating the Mutual Information. I.e., when going to 3rd order in the Markov context, P(x₀|x₋₅; x₋₂; x₋₁) is chosen over P(x₀|x₋₃; x₋₂; x₋₁)

if MI({x₀;x₋₁;x₋₂}{x₋₅})>MI({x₀;x₋₁;x₋₂},{x₋₃}).

Or, in terms of Kullback-Leibler divergences,

if D[P(x₀;x₋₁;x₋₂;x₋₅)∥P(x₀;x₋₁;x₋₂)P(x₋₅)]>D[P(x₀;x₋₁;x₋₂;x₋₃)∥P(x₀;x₋₁;x₋₂)P(x₋₃)].

Hash Interpolated Markov Model (hIMM) and Gap/Hash Interpolated Markov Model (ghIMM):

No longer employ a global cutoff criterion—count cutoff criterion applied at the sub-sequence level.

III.C.10 pMM/SVM

For start-of-coding recognition, can create MM-based classifier based on log [Pₛₜₐᵣₜ/Pₙₒₙ₋ₛₜₐᵣₜ]=Σᵢ log [Pₛₜₐᵣₜ(xᵢ=bᵢ)/Pₙₒₙ₋ₛₜₐᵣₜ(xᵢ=bᵢ)] (described as a pMM). Rather than a classification built on the sum of the independent log odds ratios, however, the sum of components could be replaced with a vectorization of components:

Σᵢ log [Pₛₜₐᵣₜ(xᵢ=bᵢ)/Pₙₒₙ₋ₛₜₐᵣₜ(xᵢ=bᵢ)]->{ . . . , log [Pₛₜₐᵣₜ(xᵢ=bᵢ)/Pₙₒₙ₋ₛₜₐᵣₜ(xᵢ=bᵢ), . . . }

These can be viewed as feature vectors (f.v.'s), and can be classified by use of an SVM (as described in a publication by the Inventor, and denoted pMM/SVM). The SVM partially recovers linkages lost with whatever order of Markov model dependency that is imposed. For the 0th order MM in the example, the positional probabilities are approximated as independent—which is far from accurate. The SVM approach can recover statistical linkages between components in the f.v.'s in the SVM training process.

There are generalizations for the MM sensor and its SVM f.v. implementation, and all are compatible with the SVM f.v. classification profiling. Markov Profiling with component-sum to component feature-vector mapping for SVM/MM profiling: MM, IMM, gIMM, hIMM, ghIMM==>SVM/MM, SVM/IMM, SVM/gIMM, etc.

III.C.11 Topological Structure Identification (smORF and tFSA)

smORF.pl (uses gIMM.pl) is a program for ab initio prokaryotic gene-structure identification. A bootstrap approach to prokaryotic gene structure identification is implemented. The method begins with identification of likely coding regions by identifying the different types of codon “voids” and their relative statistics. This then gives an unsupervised prescription for choosing a length cutoff for likely coding ORFs. The 1^{st} ATG in the ORF is then taken as the likely start codon and the indicated coding regions are analyzed using a novel, mutual information based, gap-interpolating Markov model (gIMM.pl, described below). The purported coding regions are then scored and outliers dropped. The gIMM data is then reacquired in the “cleaned” coding regions, and separately acquired in the upstream transcription regulation region. The Shine-Dalgarno variants for the prokaryote are obtained via this approach, as well as many core promoter sequences. A second, partially supervised, pass is then made by incorporating statistics extracted from the first pass into a 2^{nd}-pass HMM structural model that includes information about the upstream regulatory structure. The length cutoff on coding regions and the 1^{st} ATG heuristic are partially relaxed on the 2^{nd} pass. A maximum entropy tuning criterion is then described to obtain a, mostly, unsupervised tuning process on refining the HMM model. A data mining approach is then described for the larger family of coding regions obtained and for use in constructing a 3^{rd}-pass HMM-based gene structure identifier that uses profile HMMs and support vector machines (i.e., a hybrid HMM/SVM gene predictor). Application to prokaryotic genomes, and comparative genomic results, have been obtained with as high as 99% predictive accuracy in test efforts.

### III.C.12 Multi-Track, Parallel, or Holographic HMMs

A model for multi-track HMM is developed and software developed for extracting the statistical information needed for that model in a Proof-of-Concept (Sec. II) application to identification of alternatively spliced genes.

### Multi-Track HMM Statistical Modeling Code-Base:

| | |
|---|---|
| Elegans_extractor.pl | DNA_sequence.pm |
| GFF_Source_Select.pl | EST_Label_Sequence.pm |
| GFF_Partition.pl | EST_Labeled_DNA_Sequence.pm |
| GFF_Collect.pl | General_HMM.pm |
| CHR_Partition_Loop.pl | General_Sequence.pm |
| GFF_Select.pl | GFF_Sequence.pm |
| Worm_Starter.pl.sh | Labeled_DNA_Sequence.pm |
| Add_count_Files.pl | |

The core data processing uses the code-base as follows:
GFF_Collect.pl extracts feature lists from Sanger annotated (GFF) files. writes as feature files. A separate GenBank to GFF convertor exists for more general applicability, but is not needed for the C. elegans genome used as test set.
GFF_Select.pl selects on source=“Coding” or “hand_built”
GFF_Partition.pl partitions Sanger style GFFs, determines ‘good’ partitioning of base data for chunk processing
partitionCount.pl uses Perl module GFF_Sequence.pm which does typically is called to do the following: (i) initiailize a GFF_Sequence object on a multi-track model given a GFF annotation file; (ii) perform Transition_Contraction to get collections of objects desired; (iii) perform Sequence_Element_Tally to perform counts and obtain statistical models of the various states, state-transitions, etc.
GFF_Sequence.pm typically initializes with a read to populate Hash_GFF_Records, given a gffErrors intercept to arrive at a Label_Region entity. When GFF_Sequence lays the gene annotation information, a second ‘track’ of annotation is introduced if an unavoidable overlap occurs, where the second track has the same range of indexing into the raw data being analyzed. The subroutines Transition_contraction and Sequence_element_Tally are then easily performed and as side effect to produce output files that can be used in the HMM statistical model (General_HMM.pm an extension of the platform used in the HOHMM).

The analysis of the C. elegans genome indicates sufficient support for the above two-track statistical model:

For a Single-Track Labeling Scheme there are 9 Labels: (0, 1, 2, A, B, C, i, l, l):

### Exon Forward Read, Frame 0, 1, 2: (012)

### Exon Reverse Read, Frame A, B, C: (CBA)

Intron in forward gene: i
Intron in reverse gene: I
Non-coding, non-intron (junk): j

The first chromosome of C. elegans has 14,025,570 bases and is fully annotated. With annotation according to the above label scheme, the counts on different labels are shown in Table 2:

TABLE 2
Counts on Labels (Track 1)

| | | |
|---|---|---|
| 0 571,187 | A 518,431 | l 1,634,653 |
| 1 571,187 | B 518,431 | i 1,779,392 |
| 2 571,187 | C 518,431 | j 7,336,733 |

There are 25 transitions between labels, or transition “states”, with counts showing consistency with that labeling scheme (i.e., only 25 transitions with nonzero counts) in Table 3:

TABLE 3
Counts on Label Transitions (Track 1).

| | | |
|---|---|---|
| 01 569,483 | BA 516,874 | ll 1,628,572 |
| 12 569,490 | CB 516,868 | ii 1,772,795 |
| 20 566,732 | AC 514,309 | jj 7,334,177 |
| 0i 1,704 → i1 1,704* | lA 1,557 → Bl 1,557 | j0 1,257 → 2j 1,257 |
| 1i 1,696 → i2 1,696 | lB 1,563 → Cl 1,563 | Aj 1,161 → jC 1,161 |
| 2i 3,197 → i0 3,197 | lC 2,961 → Al 2,961 | |

*notice the label convention on introns, such that a sequence of transitions between labels (two-label contractions) might look like the following: ...20 0i ii ii ii ii ---- ii i1 12 20 01 ...., thus it is expected that the number of 0i transitions will equal the number of i1 transitions, etc.

Suppose there were multiple annotations regarding the labeling of a base (i.e., alternative splicing). As the genome is traversed in the forward direction, gene annotations that aren't in conflict with annotations already seen are used to determine labels on label-track-one. If a gene annotation is in conflict (an alternative splicing) then its label information is recorded on a second, adjacent, label track. The above tables are actually the label counts on track one, in Table 4 are the label counts on track two (where the default base label is taken to be ‘j’):

TABLE 4
Counts on Labels (Track 2)

| | | |
|---|---|---|
| 0 21,599 | A 64,475 | l 325,471 |
| 1 21,599 | B 64,471 | i 81,289 |
| 2 21,599 | C 64,467 | j 13,354,661 |

Since the j count on track two is 13,354,661, this indicates that 95.2% of the first chromosome of C. elegans is not alternatively splices, i.e., about 5% of the CHR I genes have alternate splicing. Table 5 shows the track 2 label transition counts:

TABLE 5
Counts on Label Transitions (Track 2).

| | | |
|---|---|---|
| 01 21,554 | BA 64,296 | ll 324,751 |
| 12 21,548 | CB 64,275 | ii 81,073 |
| 20 21,441 | AC 63,986 | jj 13,354,350 |
| 0i 45 → i1 45 | lA 175 → Bl 175 | j0 38 → 2j 38 |
| 1i 51 → i2 51 | lB 192 → Cl 192 | Aj 136 → jC 136 |
| 2i 120 → i0 120 | lC 353 → Al 353 | |

The two-element “vertical” label comprising the track 1 and 2 values. So if a base has label ‘0’ on track 1 and label ‘A’ on track 2, it's V-label is ‘V0A’. 72 V-label are found to have nonzero counts (out of 9*9=81 possible). Most of the V-label describe an overlap of noncoding on one track with coding on the other track. These are the counts on V-labels describing coding region overlaps as shown in Table 6:

TABLE 6
V-label Counts. Notice how the V-labels tend NOT to favor
simple frame-shifts in a given read direction (i.e.,
the V01 count is very low compared to V00, etc.).

| | |
|---|---|
| V00, V11, V22 17,839 | VA0, VB2, VC1 0 |
| V01, V12, V20 3 | VA1, VB0, VC2 0 |
| V02, V10, V21 58 | VA2, VB1, VC0 829 |
| V0A, V1C, V2B 741 | VAA, VBB, VCC16,169 |
| V0B, V1A, V2C 957 | VAB, VBC, VCA0 |
| V0C, V1B, V2A 5164 | VAC, VBA, VCB54 |

There are 263 transitions on V-labels with non-zero counts. Many of the V-transitions have very low counts and can either be ignored in the initial model, or can have their stat's boosted by bringing information from related genomes (C. Briggsae). Ignoring those V-transitions with negligible counts as not allowed transitions, as well as those implicitly describing no alternative splicing locally (an overlap with ‘j’ in either track), reduces to an active V-transition set consisting of 86 transitions between V-labels. This is a tractable number of states to manage in the HMM analysis, suggesting a simple and direct approach to alternative splice HMM analysis. The number of V-transitions, whether counting all 263, or the 86 ‘active’ ones, is still much smaller than the 72*72=5,184 transitions that would have been surmised for track annotations that were entirely independent.

### III.C.13 Distributed HMM Methods Via Viterbi-Path Based Reconstruction and Verification

The signal processing latency for an HMM becomes very prohibitive when input data is large. Methods are described for performing HMM algorithms in a distributed manner. The pathological instances where the distributed merges can fail to exactly reproduce the non-distributed HMM calculation can be made as least likely as desired with sufficiently strict, but not computationally expensive, segment join conditions. In this way the distributed HMM provides a feature extraction that is equivalent to that of the sequentially run, general definition HMM, and with a speedup factor approximately equal to the number of independent CPUs operating on the data. The Viterbi most probable path calculation and the Expectation/Maximization (EM) calculation are described in this distributed processing context.

A test of the algorithm was conducted on 5 computers with 300 signals. Each signal had 5000 samples. The resulting viterbi paths matched perfectly between the distributed HMM and standard HMM. For the standard HMM, EM training (5 loop) and Viterbi totally took 272 seconds. For distributed HMM, they only cost 69 seconds. So using 5 computers, we had a speedup of 3.94 (272/69). As the number of computers increases, this benefit to data analysis capacity can be greatly enhanced.

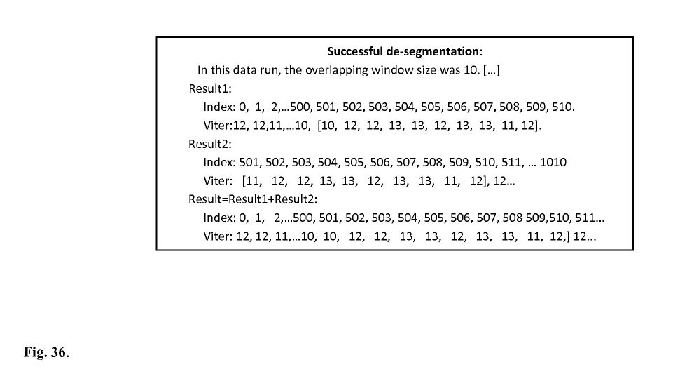

FIG. 36 shows how a perfect de-segmentation was performed with an N=10 match window. It was found that a perfect stitching of segments was also possible simply with N=1, with the real data examined, due the implicit stringency of the simultaneity condition (the overlap match, at the one position corresponding to N=1, must globally index to the same observation data index for both segments).

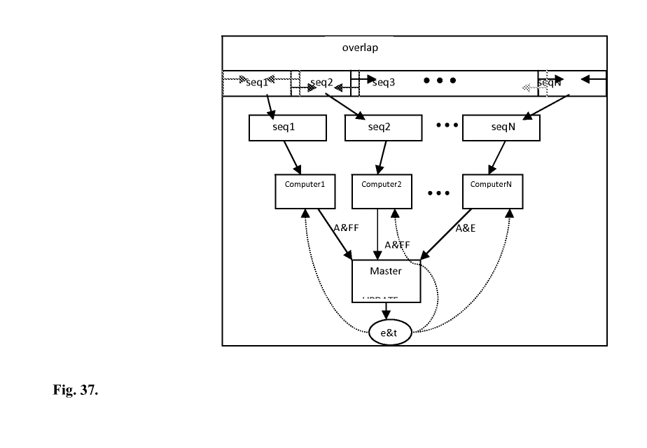

With HMM/EMs we have excellent feature extraction on channel current blockades: strong info on level occupation, emission probabilities and transition probabilities. To make this strong modelling accessible to real-time, and large-scale computational efforts, a distributed methodology can be employed as shown in FIG. 37.

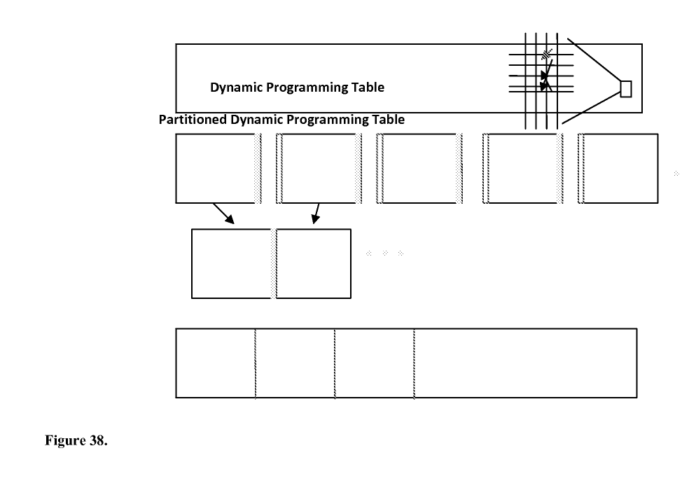

As shown in FIGS. 38 & 39, the main parts of job (step(3)-step(5)) can run independently and concurrently among slaves, no synchronization cost at all. Then the slaves send to the master their “contributions” (A&E), which are just small arrays. So the communication cost is nearly zero. The master use A&E s to do an instant update for the emission and transition probabilities and broadcast them to slaves. Because the main work is truly distributed, we gain a speedup approximately proportional to the number of computers running on the data.

Testing.

Apply Viterbi algorithm in the above model to find the most probable path that emit the symbols of the testing sequence:
(1) Calculate viterbi path using Viterbi Algorithm. (SLAVES)
(2) Send viterbi paths to Master (SLAVES)
(3) Use “Extended viterbi match de-segment rule” to join viterbi paths together. (MASTER).

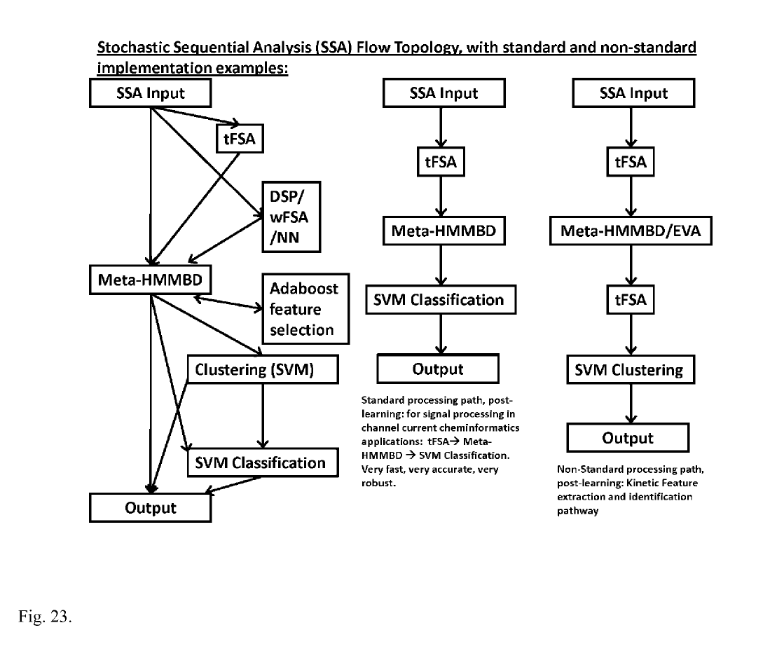

The distributed data sequences are continuous. And each prior has an overlap with the latter (FIGS. 38 & 39). As a result, the respective output viterbi paths also have overlaps. This makes sense when the sequence is long enough. Since the viterbi path can be considered as “internal missing data”, which exist there waiting for HMM to “dig it out”. In this sense, it is stable. FIG. 23 provides a successful example from the output screenshot. Another type of rule considered for stitching together sequentially ordered, overlapping, segments of the full dynamic programming table: Viterbi column-pointer match de-segmentation rule: now seek agreement of the entire column of state pointers, but only at a particular data-index (typically). One of the column pointers would be the Viterbi path pointer, so this match condition would include the information of Method (1) above for the N=1. case. As such, the N=1 case will bound its performance. Our results establish Method (1) on channel current data (N=10 case) provides a correct stitching, as well as bound the performance of Method (2) with the N=1 case, which is also shown to perform a correct stitching.

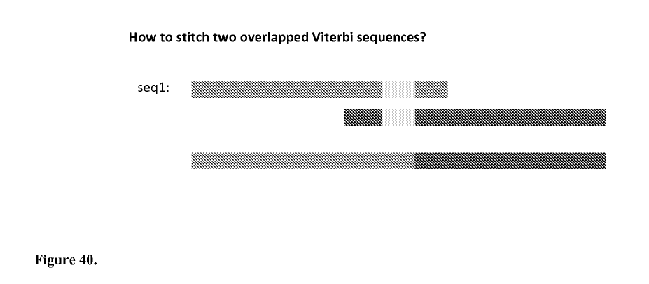

Extended Viterbi-match de-segmentation rule (FIG. 40): seek agreement of specified length, N, of Viterbi sub-sequence in segment overlap region (where such agreement is restricted to be at coincident indexing into the data). It is found that coincident indexing is already a very restrictive situation, such that even a single state match (N=1) can work with some data, such as with some of the channel current data.

Table-based Algorithm Pseudocode

```
Viterbi algorithm
    Initialisation(i=0): v₀(0)=1, vₖ(0)=0 for k>0.
    Recursion(i=1...T): vₜ(i)=eₜ(xᵢ) maxₖ(vₖ(i−1)aₖₜ); Ptri(t) =
    argmaxₖ(vₖ(i−1)aₖₜ).
    Termination: P(x, π* )=maxₖ(vₖ(T)aₖ₀); π_{L}* = argmaxₖ(vₖ(T)aₖ₀).
    Traceback (i=T...1): πᵢ₋₁*= Ptrᵢ(πᵢ*).
Forward algorithm
    Initialization(i=0): f₀(0)=1, fₖ(0)=0 for k>0.
    Recursion(i=1...T): fₜ(i)=eₜ(xᵢ) Σₖ fₖ(i−1)aₖₜ;
    Termination: P(x)= Σₖ fₖ(T)aₖ₀;
Backward algorithm
    Initialization(i=T): bₖ(T)=aₖ₀ for all k.
    Recursion(i=T−1...1): bₖ(i)=Σₜaₖₜ eₜ(xᵢ₊₁) bₜ(i+1);
    Termination: P(x)= Σₜ a₀ₜ eₜ(x₁) bₜ(1);
EM algorithm (Baum Welch)
    aₖₜ = Aₖₗ / Σ_{t′} A_{kt′}
    eₖ(b) = Eₖ(b)/ Σ_{b′} Eₖ(b′)
    Aₖₜ = Σfₖ(i)aₖₜeₜ(xᵢ₊₁)bₜ(i+1) /P(x)
    Eₖ(b)= Eₖ(b) = Σ_{{i |Xi=b}} fₖ(i)bₖ(i) /P(x)
Data Inversion
    eₖ(b) --> e_{b}(k), where e_{b}(k) = P(S=k|Z=b)
EVA Projection
    eₖ(b) parameterized as a Gaussian with mean at b=k. EVA,
emission variance amplification, amplifies the variance of the Gaussian
parameterization by a multiplicative factor (typically ranging from
1.5 to 4).
```

### III.C.14 Adaptive Null-State Binning for O(TN) Computation

During the HMM Viterbi table construction for each of T sequence data values there is a column entry, and for each of N states there is a row. At each column the HMM Viterbi algorithm must look to the past column entries as it populates the table from left to right, thus leading to an O(TN²) computation. If we establish an adaptive binning capability, reminiscent of what was done with the HMMBD method, then we can keep track of lists with respect to each state that correspond to prior column transitions to that state. If we, in particular, track those Viterbi most-probable-paths that arrive at our state cell with probability below some cutoff (with respect to the other probabilities arriving at that cell), we can ignore transitions from such cells in later column computations. What results is an initial O(Tn²) computation to learn the state lists for above cut-off transitions (suppose K on average), followed by the main body of the O(TNK) computation (with K<<N).

During the HMM Viterbi table construction for each of T sequence data values there is a column entry, and for each of N states there is a row. At each column the HMM Viterbi algorithm must look to the past column entries as it populates the table from left to right, thus leading to an O(TN²) computation. If we establish an adaptive binning capability, reminiscent of what was done with the HMMBD method, then we can keep track of lists with respect to each state that correspond to prior column transitions to that state. If we, in particular, track those Viterbi most-probable-paths that arrive at our state cell with probability above some cutoff (with respect to the other probabilities arriving at that cell), we can ignore transitions from weakly coupled cells in later column computations. What results is an initial O(Tn²) computation to learn the state lists for above cut-off transitions (suppose K on average), followed by the main body of the O(TNK) computation (with K<<N).

A method is possible comprising use of fastViterbi process where O(TN²)→O(TmN) via learned, local, max-path ordering in a given column of the Viterbi computation for the highest ‘m’ values. Subsequent columns first only examine the top ‘m’ max-paths and if their ordering is retained, and their total probability advanced sufficiently, then the other states remain ‘frozen-out’ with a large grouping (binning) on the probabilities on those states used to maintain their probability information (and correct normalization summing) when going forward column-by column, with reset to full column evaluation on the individual state level when the m values fall out of their initially identified ordering.

A method is possible comprising use of fastViterbi process where O(TN²)→O(Tmn)→O(T) via learned global and local aspects of the data as indicated in the Features. This approach offers significant utility as a purely HMM-based alignment algorithm that will outperform BLAST and in comparable time complexity.

### III.D SVM-Based Classification and Clustering

### Support Vector Machines (SVMs)

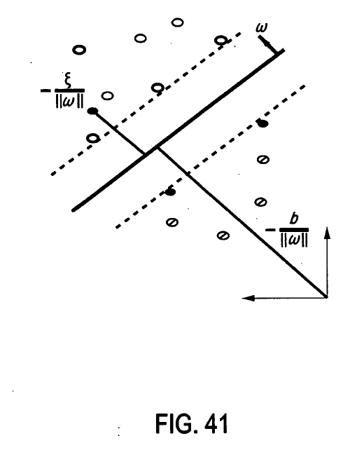

SVMs are variational-calculus based methods that are constrained to have structural risk minimization (SRM), unlike neural net classifiers, such that they provide noise tolerant solutions for pattern recognition. Simply put, an SVM determines a hyperplane that optimally separates one class from another, while the structural risk minimization (SRM) criterion manifests as the hyperplane having a thickness, or “margin,” that is made as large as possible in the process of seeking a separating hyperplane (see FIG. 41).

HMM/SVM Developments.

Markov-based statistical profiles, in a log likelihood discriminator framework, can be used to create a fixed-length feature vector for Support Vector Machine (SVM) based classification (see experiments described in Sec. II on Proof-of-Concept work). Part of the idea of the method is that whenever a log likelihood discriminator can be constructed for classification on stochastic sequential data, an alternative discriminator can be constructed by ‘lifting’ the log likelihood components into a feature vector description for classification by SVM. Thus, the feature vector uses the individual log likelihood components obtained in the standard log likelihood classification effort, the individual-observation log odds ratios, and ‘vectorizes’ them rather than sums them. The individual-observation log odds ratios are themselves constructed from positionally defined Markov Models (pMM's), so what results is a pMM/SVM sensor method. This method may have utility in a number of areas of stochastic sequential analysis, including splice-site recognition and other types of gene-structure identification, file recovery in computer forensics (‘file carving’), and speech recognition.

Single-Convergence Initialized SVM-Clustering.

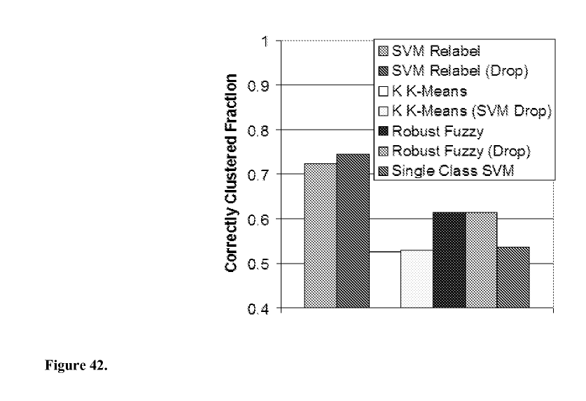

The initial SVM-based two-class clustering approach was based on initializing unlabeled data with a random labeling and obtaining a convergent SVM classifier solution based on that random data labeling. The convergence sometimes has to be attempted several times (with different randomized initializations) before a SVM solution is obtained. Once an SVM solution is obtained, however, the strengths of the SVM classifier can be used to full advantage. SVMs are ideal in this effort as they not only classify, but offer a confidence parameter with their classification, and can do so in a generalized kernel space. Once a convergent solution is obtained label-flipping (from positive to negative) can be done for low-confidence labels in an iterative process, with SVM re-training after each round of weak-label changes. At each iteration we can potentially have unequal numbers of positives and negatives changing their labels, thus, asymmetrically sized clusters can be realized from a half-positive/half-negative initialization. This iterative process continues until there is no longer a low-confidence classification by the SVM, or until an external cluster validation, such as the sum-of-squared error (SSE) on each cluster, remains relatively unchanged. There are numerous tuning parameters in the SVM-classification process itself, as well as in the SVM-clustering halting specification, and even tuning choices in the SVM chunk-training (that may be necessary for larger data sets). As shown in FIG. 42, SVM-based clustering often outperforms other methods.

The problem with the single-convergence initiated SVM clustering approach is that it can get stuck in a weak solution or occasionally fail more seriously, such stabilization needs to be accomplished and efficiently. Stabilization could be done with numerous repeats of the SVM clustering process, but this is computationally over-kill and more efficient processes, including distributed intelligence tuning (with genetic algorithms, for example) are sought in the label-flipping convergence process (Sec. III.D.1 to follow), a different approach, initializing in a more informed way, with more than one initial convergence required, is described in (Sec. III.D.2. Section III.D.3 describes multi-class (more than 2) SVM clustering with one or more multi-label convergences and with or without additional external tuning management. Section III.A.3.4 describes SVM distributed processing.

III.D.1 Support Vector Machine (SVM) Based Classification and Clustering with Automatic Tuning/Training

The SVM kernels used in the analysis are based on a family of previously developed kernels [see Parent Patent], referred to as ‘Occam's Razor’, or ‘Razor’ kernels. All of the Razor kernels examined perform strongly on channel current data, often outperforming the Gaussian Kernel. The kernels fall into two classes: regularized distance (squared) kernels; and regularized information divergence kernels. The first set of kernels strongly models data with classic, geometric, attributes or interpretation. The second set of kernels is constrained to operate on (R⁺)^{N}, the feature space of positive, non-zero, real-valued feature vector components. The space of the latter kernels is often also restricted to feature vectors obeying an L₁-norm=1 constraint, i.e., the space of discrete probability vectors. In dataruns with the probability feature vector channel current data, the two best-performing kernels are the entropic and the indicator ‘Adbsdiff’ kernels, with the Gaussian trailing in performance in general (but still outperforming other methods such as polynomial and dot product). The L₁-norm channel current feature vector components appears to encapsulate a key constraint of a discrete probability vector via its domain selection and its associated optimal kernel sets.

Our desire is to establish an automated tuning solution for SVM classification over a variety of novel kernel and algorithmic parameters. In Proof-of-Concept work this has been done by implementing a genetic algorithm tuning procedure, where SVM performance on training data is used to define a fitness function. In initial efforts with genetic algorithm tuning (in analysis of channel current data), the genetic algorithm tuning results were as good as or better than those obtained by an expert manually, so there is a high degree of confidence that this method will offer advantages. Alternative, easily distributed, tuning approaches will be considered as needed, and include ACO, and other multi-agent distributed intelligence approaches.

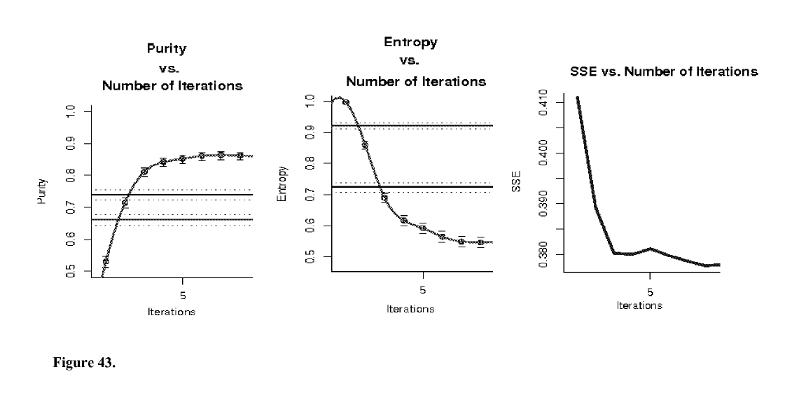

Although convergence is always achieved with the SVM-clustering method in the label-flippings, after the initial convergence, convergence to a global optimum is not guaranteed. FIGS. 43a and 43b show the Purity and Entropy (with the RBF kernel) as a function of Number of Iterations, while FIG. 43c shows the SSE as a function of Number of Iterations. The stopping criteria used for the algorithm is based on the unsupervised (external) SSE measure. Comparison to fuzzy c-means and kernel k-means is shown on the same dataset (the solid blue and black lines in FIGS. 43a and 43b).

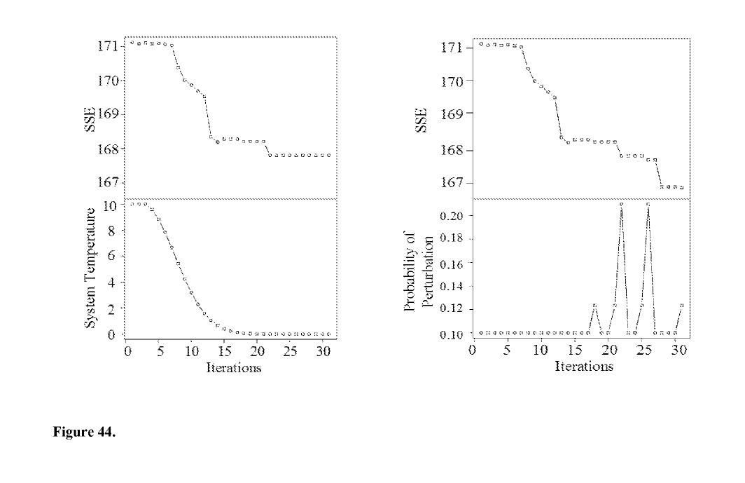

In the effort shown in FIG. 43 it was found that random perturbation and hybridized methods (with more traditional clustering methods) could help stabilize the clustering method, but often at significant cost to its performance edge over other clustering methods (apparently due to getting stuck in local minima traps to which the other parametric clustering methods are susceptible). The ‘pure’ SVM-external clustering method appears to offer very strong solutions about half the time—which allows for optimization simply by repeated clustering attempts and looking for the most tightly clustered (smallest SSE) solution, which suggested a simulated annealing approach for greater computational efficiency, as shown in FIG. 44 (more recent Proof of Concept work with Genetic Algorithms not shown, but were found to exhibiting even stronger stability). Results of this effort (FIG. 44) significantly improve and stabilize the SVM clustering process.

Given the wide variety of dissimilar tuning parameters in the SVM classification process alone, tests on SVM classification with genetic algorithm (GA) based tuning seems optimal. The very robust and rapid auto-tuning with the GA approach on SVM classification in initial tests strongly suggests that this, or any swarm intelligence search/tuning paradigms, offer important refinement to the SVM-classification efforts and critical refinement to the single-convergence initialization SVM-clustering efforts.

### III. D.2 Multiple-Convergence Initialized SVM-Clustering

The Multiple-convergence initialized SVM-clustering approach to unsupervised learning provides a non-parametric means to clustering. In preliminary work we have found that the SVM-based clustering method also offers prospects for inheriting the very strong performance of standard SVMs from the supervised classification setting (see Sec. II). This offers a remarkable prospect for knowledge discovery and enhancing the scope of human cognition—the recognition of patterns and clusters without the limitations imposed by assuming a parametric mode and ‘fitting’ to it, where resolution of the identified clusters can be at an accuracy comparable to the supervised setting (i.e., where cluster identities are already specified).

One new approach is to first obtain multiple SVM convergences at initialization (two might suffice, for example, in many situations) and thereby obtain the confidence magnitudes on data points, and their nearest neighbors (if repeatedly have the same neighbors, have high linkage to them). This is used to inform a label-flipping process to arrive at an improved clustering solution on further iterations and analysis. For example, one approach is to establish a high-linkage high-confidence label set (labels retained or flipped accordingly) and a low-linkage, low-confidence, label set (some, according to criteria, may be flipped as well, or dropped). The magnitude comparison in the simplest ‘multiple’ convergence result would involve two convergences, with the difference in confidence value for a particular training instance producing a line segment, and for all the training instances, their two-convergent point-differences would provide a collection of line-segments. The most stable part of the line-segment ‘field’, that of the high-linkage high-confidence data instances, can then be used, for example, to provide indication of structure to guide tuning efforts and label-flipping criteria.

### III.D.3 SVM Distributed Processing and GPU/CPU Enhancements

To further enhance processing speed, if desired, we aim to not only perform distributed processing as indicated, but also to boost thread-processing speed on a given computer via use of GPU processing. This has been implemented in Proof-of-Concept Experiments (see Sec. II), where distributed chunks of SVM training data were processed using a CPU/GPU that, at marginal added cost (a graphics card), provided as much as a 32-fold speedup on the channel current blockade classification. We can incorporate the GPU usage into the main SVM package and do similar GPU speed enhancements to the other machine learning algorithms.

In related Proof-of-Concept work, a distributed SVM training method was implemented with chunk learning with GPU/CPU speedup (using CUDA). Chunking becomes desirable when classifying large datasets (regardless of speedup concerns). When training on the chunk is complete, the resulting feature vectors can be split into distinct sets (support vectors, polarization set, penalty set, and KKT violator). These sets give the user different categories of feature vectors that they can pass to the next round of chunk partitioning & training.

Distributed learning on SVMs can be accomplished by breaking the training set into smaller chunks, running separate SVM processes on each of those chunks, and pooling the information that is ‘learned’, e.g., the support vectors identified as well as nearby (in terms of confidence value) training data vectors and outliers. The reduced pool of data is randomly repartitioned into another round of chunk processing. This is repeated until only a single chunk remains, whose solution is then either the solution sought or close to it (other minor refinements could be sought). There is a fundamental memory limit encountered with larger SVM training sets, such that chunking is needed on training sets even if we aren't interested in the distributed learning speedup (e.g., we need to use a sequential process on a single machine). For this circumstance, for sequential processing of chunks, we take the SV's identified from the prior round of chunk training and merge it with the next chunk to be trained, and iterate. In this way we never have a pure SV training set. If multiple CPU's are available, we can distribute the processing on chunks amongst the machines, and pool their SV's (i.e., pass 100% of their SV's to the training pool for the next round). The resulting ‘pure SV’ training sets, however, are often found to not converge.

There are a variety of ways to avoid the pure SV training-set pathology. Since we are interested in training set reduction overall, we consider the possibility of simply reducing the SV set. This appears to work in preliminary tests on well-studied datasets of interest (see Table 1), where the SV's nearest to the decision hyperplane (most supporting the hyperplane) are retained. For the channel current data examined in, with 150-component feature vectors, we find that 30% SV passing is optimal on distributed learning topologies. The low SV-passing percentage that is found to work in distributed chunking might fundamentally be an issue of outlier control during distributed learning. Further reduction of SV passed is possible with dropping SV's with confidence values at the other extreme, near zero (i.e., those nearest and most strongly supporting the hyperplane). This entails a additional Support Vector reduction (SVR) process that is run right after the SVM learning step is complete, where we further reduce the support vector set according to some confidence cut-off (actually imposed via cut-off on associated Lagrange multiplier in the SVM/SMO implementation). By reducing the number of support vectors propagated into the next round, we further accelerate the chunked processing. In this way, a strongly performing distributed chunk-training process is possible, with speedup by ^{˜}10 in the example shown in Table 6 (with no significant loss in accuracy). One problem is that this took some expert handling to set up. Our desire is to automate this expert handling via use of automated tuning & selection procedures. To achieve this it is necessary to examine the stability of the algorithmic parameters such as the pass percentages on the different types of ‘learned data.

TABLE 6
Performance comparison of the different SVM methods.

| | Sensi- | Speci- | (SN + | Time |
|---|---|---|---|---|
| SVM Method | tivity | ficity | SP)/2 | (ms) |
| SMO (non-chunked) | 0.87 | 0.84 | 0.86 | 47708 |
| Sequential Chunking | 0.84 | 0.86 | 0.85 | 27515 |
| Multi-threaded Chunking | 0.88 | 0.78 | 0.83 | 7855 |
| SMO (non-chunked) with | 0.91 | 0.81 | 0.86 | 43662 |
| SV Reduction | | | | |
| Sequential Chunking with | 0.90 | 0.82 | 0.86 | 18479 |
| SV Reduction | | | | |
| Multi-threaded Chunking | 0.85 | 0.83 | 0.84 | 5232 |
| with SV Reduction | | | | |
| Multi-threaded Dist. Chunking | 0.85 | 0.83 | 0.84 | 5973 |
| with SV Reduction | | | | |

The distributed chunking used three identical networked machines. Dataset = 9GC9CG_9AT9TA (1600 feature vectors). SVM Parameters: Absdiff kernel (a Razor Kernel, with sigma = .5, C = 10, Epsilon = .001, Tolerance = .001. For chunking methods: Pass 90% of support vectors, Starting chunk size = 400, maxChunks = 2. For SV Reduction methods: Alpha cut off value = .15.

To further enhance processing speed, one can not only perform distributed processing as indicated, but also to boost thread-processing speed on a given computer via use of GPU processing. This has already been undertaken, where distributed chunks of SVM training data were processed using a CPU/GPU that, at marginal added cost (a graphics card), provided as much as a 32-fold speedup on the channel current blockade classification. We intend to incorporate the GPU usage into the main SVM package and do a similar GPU speed enhancements to the other machine learning algorithms.

### III.E SSA Protocol Signal Acquisition—FSA-Based

A method for acquisition of localizable signals involving ‘holistic’ tuning and ‘emergent grammar’ tuning is implemented in (Sec. II). A holistic engine of multiply connected variables/states/interactions is used to acquire localizable signals. The engine is finite-state automaton (FSA) based on the examples described in Sec. I & II, where running-time scales as O(L), where L is the length of the sequence data. For acquisition we seek minimal feature identification comprising identification of signal beginnings and ends (and thus durations as well).

The holistic tuning can be based on identifying anomalously long-duration signals or signal regions, for example. Signal ‘fishing’ methods are used in conjunction with this, for example, where FSA constraints on valid ‘starts’ that are weak and constraints on valid ‘ends’ that are strong are used so as to favor consideration of entire signals (at ‘ends’ have seen entire supposed signal) in the acquisition. In the latter example, we bias so as to admit signals of interest with greater likelihood (e.g., a boost to stronger sensitivity), even though this typically allows more noise, or decoy, signals as well. Weaker specificity is not a problem if further stages of signal processing are employed and this can be repaired, otherwise stricter tuning for both high sensitivity and specificity is used. An example of topological structure identification is given in Sec. III.

Feature identification may also be employed for simultaneous feature extraction, for example, identification of sharply localizable ‘spike’ behavior may be used in any parameter of the ‘complete’ (non-lossy, reversibly transformable) classic EE signal representation domains available: raw time-domain, Fourier transform domain, wavelet domain, etc. An example methodology for spike detection is shown applied to the time-domain in Sec. I. An example tFSA Flow Topology is shown in Sec. I. An example tFSA Flowchart implementation of the Flow Topology is shown in the Meta-HMM Patent.

### Part IV. Optional Features

1. A device implementation involving a single-modulated-channel, in sealed aperture, where the nanometer-scale (‘nanopore’) channel is the only conductance path across the sealed aperture membrane that separates two chambers of buffer under an applied potential, and where the channel has modulations with stationary statistics (or approximately stationary statistics) via physical blockade by a single (typically non-translocating) molecule, together with algorithms and data-schemas for learning and/or identifying the signal modulations observed.

2. An implementation where the aperture is cusp-like, conical, or any other shape aperture that can be functionalizable (sealed in particular) with thin film/membrane placement.

3. An implementation where the aperture is typically in the 0.1 to 100 micrometer range, where the aperture may be multiple (multi-holed), but with total area in the 1 to 100 square micrometer range.

4. An implementation where the apertures are produced by using a thermoplastic material (“heat shrink”, examples: polyolefin, fluoropolymer, PVC, neoprene, silicone elastomer, Viton, PVDF, FEP, to name a non-exhaustive set), that is then mounted on PTFE tubing using a shrink, slice, withdraw protocol.

5. An implementation where the apertures are produced by other means (solid state, etc.), in the 0.1 to 100 micrometer range, possibly with multiple coat procedures to make the device function most efficiently (not too hydrophobic or hydrophilic, etc.).

6. An implementation where the nanopore is typically in the 0.1 to 10 nm range, where the importance of the size constraint is that a single molecular-complex, molecule, or appendage thereof, can be drawn into said nanopore and have a tight steric fit, such that a bistable interaction can be sought with stationary statistics, to thereby obtain single-molecule-coherent statistics. This effectively restricts the size of the nanopore to that of the single molecule transduction coupler that is employed (for the alpha hemolysin channel, dsDNA modulators are sized along these lines).

7. An implementation where the membrane ranges from 2 nm to 20 micrometers.

8. An implementation where we induce a membrane S-layer scaffolding (as can occur with lipid-bilayer based membranes) as a shielding structure for purposes of increased device robustness (device hardening).

9. An implementation where we use signal processing protocols, data structures, and data schemas related to known buffer solutions containing application-specific engineered molecules or substrates to provide reporting on device status.

10. An implementation where we use specialty buffers, or kit constructs (including machined parts), or special carrier-reference control molecules.

11. An implementation where a ‘kit-user’ can run experiments with signals generated from use of buffer and controls, and the analysis of that data would be used to calibrate. A service site could be used to calibrate the kit NTD machines in this process as well as to perform on-line calibrations, as well as to utilize analysis services with the server/provider.

12. A method for molecular transduction analysis comprising the steps of:
Positioning a membrane with at least one nanopore channel opening adjacent a solution containing a molecule to be identified,
Establishing a distinguishable ionic current flow through that nanopore (such as an ion flow under an applied potential).
Implementing a means to perform direct molecular capture on molecular species present in solution (via electrophoresis, for example), for observing the nanopore blockade signal classes produced by the various molecular capture configurations, or molecular mixtures, or for observing the nanopore blockade signal classes produced by detection of particular molecular signals.
Introducing transduction molecules to the nanopore (via electrophoresis, for example), where a transduction molecule comprises the following:
   A transduction molecule is engineered to be bifunctional in that one end is meant to be captured, and modulate the channel current, while the other, extra-channel-exposed end, is engineered to have different states according to the event detection, or event-reporting, of interest. I.e., the bi-functional molecule includes a first portion which extends within the channel and a second portion which does not extend within the channel. (Event reporting could consist of covalently linking a channel modulator to a study molecule of interest, for example, to observe its interaction kinetics; or consist of covalently linking to an antibody or aptamer to observe target binding and thereby, for example, have biosensing on that target.)
   A transduction molecule is typically engineered to be a single-molecule capture at a single-nanopore in order to thereby produce a coherent stationary statistics signal according to that single molecule's interaction with the channel (where translocation is typically prevented by steric constraints). Multiple-analyte translocation methods, or polymer translocation methods do not have single-molecule statistical coherence. The channel-modulators are typically designed to have extended duration blockade signals, with the molecule “rattling around” in the pore according to its distinctive stationary statistical blockade signal in a given state.
Drawing an engineered transducer molecule into a channel by electrophoretic means, where the channel has inner diameter at the scale of that molecule, or one of its molecular-complexes. The transducer molecule, or transducer-complex is typically sized such that the channel is too small to translocate through, instead the transducer molecule is designed to enter the channel part-way and get stuck in a ‘capture’ configuration that modulates the ion-flow in a distinctive way, for lengthy blockade durations.
Establishing direct-molecular (or sub-molecular component) capture or transducer capture for the timescale of interest (via electrophoresis, for example), and the computational means to perform signal processing and pattern recognition on the signals observed.
Analyzing the electrical signal to indicate the characteristics of the molecule under consideration.
Releasing or ejecting the molecule under consideration, typically without the molecule translocating through the nanopore channel opening.
Releasing or ejecting captured molecules or transducer molecules, and resetting nanopore operation (via reversal of applied voltage in electrophoretic setup in nanopore detector, for instance).

13. An implementation for transduction analysis wherein the sampling steps are repeated, ejecting/resetting according to some fixed duty cycle (passive sampling mode), or according to an active-response, or test condition, or via eject on recognition of signal with sufficient confidence.

14. An implementation for transduction analysis wherein the bi-functional molecule has a biotin binding moiety.

15. An implementation for transduction analysis where the transducer binding target is streptavidin.

16. An implementation for transduction analysis wherein one molecule under consideration is a dsDNA molecule.

17. An implementation for transduction analysis wherein one molecule under consideration is a dsDNA molecule and a second molecule under consideration is a second dsDNA molecule, wherein the system differentiates one dsDNA molecule from another dsDNA molecule based on the channel current blockade signal.

18. An implementation for transduction analysis wherein the membrane includes a plurality of channels and the system includes a plurality of sensing capabilities via monitoring a sequence of single-channel blockade signals using a local (approximately single-channel) coupled modulator.

19. An implementation for transduction analysis where trace-detection biosensing on highly toxic biodefense controlled substances is done via use of aptamer-based binding moieties, and MIP matrices.

20. An implementation for transduction analysis where orientation selection (primitive nanomanipulation) is used for direct antibody utilization as transducer and binding moiety, offers a biosensing set-up solution that enables an ‘oriented capture’ phase before operation—this could be significantly cheaper than methods involving linkers to channel modulators. This could also be a useful nanomanipulation ‘shortcut’ for DNA-enzyme orienting for possible direct DNA sequencing efforts.

21. An implementation for transduction analysis where transducers are used that are trifunctional (or multi-functional), via external modulator coupling, for example. Have affinity gain if binding sites homogeneous, for example, for which there is a complementary gain from multichannel situations. Could use to examine enzyme multi-cofactor activity, enzyme substrate population dynamics, enzyme study in general, or multi-component interactions of other biomolecules.

22. An implementation for transduction analysis where protein conformational change activity/pathways, w/wo chaperones, are transduced to statistical phases in channel blockade observations.

23. An implementation for transduction analysis where Y-shaped nucleic acid molecules are introduced for direct, annealed to modulator, reporting on SNPs and single-point mutations. The modulator conformation may be engineered to only exist after proper annealing on the ‘template’ of surrounding DNA to target base (validation) together with discerning which base is present at the target site (SNP variant, for example).

24. An implementation for transduction analysis where small DNA/RNA nanopore-aptamer switches (and their synthetic variants, LNA, for example) might be possible with many biomolecules of interest, especially for DNA-binding signal detection.

25. An implementation for transduction analysis where other assay-type mixtures of probes, not necessarily DNA/RNA based (PNA-based, for example), are used as transducer ‘switches’ to signal the presence of a particular target.

26. An implementation for transduction analysis where a joint nanopore modulator epitope/target-binding epitope is selected in a modified SELEX.

27. An implementation for transduction analysis where a DNA sequencing capability is established when a DNA enzyme is an exonuclease, lamba exonuclease, for example, where the exonuclease activity releases a nucleotide. That nucleotide can then drawn to the channel itself, due to the charge in the electrophoretic forces applied, thus offering a possible coincidence event, and one that might even have some distinguishability (between nucleotide types) in its own right.

28. An implementation for transduction analysis where a DNA sequencing capability is established when a DNA enzyme is an endonuclease, where the population of nucleotide substrates can be engineered to provide a weak form of nucleotide-identity according to reaction speeds for distinguishing base-type, which can strengthen these signals via choice of concentrations on the dNTP substrates.

29. An implementation for transduction analysis where a DNA sequencing capability is established when only two groups of nucleotides are discernible in one buffer/test-condition, repeated sequencings with other buffer/test-conditions may resolve the remaining information to arrive at the necessary 4-element decoding alphabet.

30. An implementation for transduction analysis where DNA sequencing is performed with a Sanger-sequencing type mixture, where copy terminations are designed to proved a blunt-ended DNA molecule. The blunt-ended DNA is then identified by its terminal base-pair and length, via nanopore detector measurements, to arrive at information usable, if complete, to determine the parent sequence.

31. An implementation for transduction analysis where nanopore transduction detection is used for direct channel-interaction nanopore detector-to-target assays, on post-translational protein modifications (glycations, glycosylations, nitrosilations, etc.), for example.

32. An implementation for transduction analysis where nanopore transduction detection is used to assay the population of hemoglobin modifications, as well as a collection of other biomarker measurements, to provide the basis for a broad, rapid, multi-target assay.

33. An implementation for transduction analysis where nanopore transduction detection is used to assay the population of glycoprotein modifications, and other protein modifications.

34. An implementation for transduction analysis where capillary electrophoresis is used for initial separation, followed by direct and indirect molecular cluster identification. In this way, a nanopore can be easily coupled to capillary electrophoresis geometries, for a new hybrid separation/clustering apparatus built from capillary and nanopore.

35. An implementation for transduction analysis where nanopore transduction detection is used with PRI sampling to realize a probe-boosting gain on PRI-sampling on minority species.

36. An implementation for transduction analysis where nanopore transduction detection is used with signal stabilization protocols introduced via use of carrier references.

37. A stochastic signal analysis (SSA) protocol for the discovery, characterization, and classification of localizable, approximately-stationary, statistical signal structures in stochastic sequential data, and changes between such structures, comprising the steps of:
Identifying signal regions (the signal acquisition), where HMM-based methods can be used if there is signal acquisition trouble or a small dataset, but FSA-based methods will typically suffice with high accuracy and with much less computational time, where ‘holistic’ tuning and ‘emergent grammar’ tuning can be used, where running time typically scales as O(L), where L is the length of the sequence data. The holistic tuning can be based on identifying anomalously long-duration signals or signal regions, for example. Signal ‘fishing’ methods are typically used in the FSA as well, for example, where FSA constraints on valid ‘starts’ are used that are weak and constraints on valid ‘ends’ are used that are strong, so as to favor consideration of entire signals in the acquisition.
Extracting features from the identified signal regions, where a generalized clique HMM analysis is typically used, where the observation sequence in the clique can involve bulk, zonal, and positional HMM emission statistics, where those statistical representations are typically interpolated to highest order having sufficient statistical support given the training data, and further comprising use of gap-interpolated Markov models and hash-interpolated Markov models in the different bulk zonal, and positional regions.
Classifying the extracted feature vectors corresponding to the blockade signals, where SVM-based methods are typically used, but HMM-based methods can be used with multiple HMM ‘templates’ tested at the feature extraction stage. The latter approach may be advantageous in some situations, and allows for purely HMM-based signal processing with the protocol in some situations.
Depending on application, may also proceed with clustering on extracted feature vectors, where SVM-based methods are typically used with this method.

38. An application of the SSA protocol or methods where the holistic signal-acquisition approach is also used as the basis for a holistic feature extraction method. In particular, O(L) feature identification may also be employed for feature extraction on sharply localizable ‘spike’ behavior, which may occur in any parameter of the ‘complete’ (non-lossy, reversibly transformable) classic EE signal representation domains presented for analysis: raw time-domain, Fourier transform domain, wavelet domain, etc.

39. An application of the SSA protocol or methods where an adaptive self-tuning explicit hidden Markov model with Duration process is coded on a computer, microprocessor, or integrated circuit, and used to accomplish HMMD computations at comparable order to the standard HMM (the HMMBD algorithm), where the order of computation is O(TN²+TND*), where D* can typically be less than 50, T is the period of observations, and N is the number of states. The adaptive reduction in computational expense is accomplished at no appreciable loss in accuracy over the explicit (exact) HMMD, and also provides a generalization to arbitrarily large intervals of state self-transitions (where Dₘₐₓ>>D).

40. An application of the SSA protocol or methods comprising use of HMM with EVA projection.

41. An application of the SSA protocol or methods comprising use of HMM with Emission

Inversion feature extraction.

42. An application of the SSA protocol or methods comprising performing a hidden Markov model (HMM) based analysis process, or topological structure identification process, on genomic DNA data, channel current data, or other sequentially represented data with recognized statistical structures and regions, where positionally dependent Markov models (pMMs) are used to describe statistical regions and transitions in those statistical regions, or some other sufficiently stable statistical profiling where a fixed number of terms is used to describe the different statistical regions and their transitions. The pMM terms (or some other collection of profiling terms) can be used in a typical sum over log likelihood approach (effectively implementing a profile HMM local sensor), or the pMM terms can be vectorized and used in an SVM classifier (trained with such data). The SVM approach will also recover information lost in the profile-HMM independence assumption on the local-signal recognition, so will typically offer improved performance. The scoring returned by the SVM (via confidence value), with appropriate regularization, can be used in place of the log-likelihood summation value to provide improved HMM structure identification with pMM/SVM sensor detection of local structure with highly anomalous statistics.

43. An application of the SSA protocol or methods comprising use of an HMM or HMMBD with Martingale/SVM, where a Martingale feature vector extraction is employed. The HMM's LLR product as more sequence data is seen, for example, is a Martingale.

44. An application of the SSA protocol or methods comprising use of HMMBD with pMM or pMM/SVM or Martingale/SVM, with or without use of EVA or Emission Inversion.

45. An application of the SSA protocol or methods comprising use of higher-order HMM states, or a windowed collection of HMM state primitives, where a concrete example is a higher order HMM (HOHMM). The fully general clique HOHMM, with base window as well as state window, is referred to as the meta-HMM in this method. The implementation of the meta-HMM can be done efficiently with direct table lookup (with tables pre-loaded in fast Memory) on the ratio of terms involved in the log likelihood ratios

46. An application of the SSA protocol or methods comprising use of a meta-HMM with sufficiently large footprint that contrast resolution is strengthened at the start of self-transition regions.

47. An application of the SSA protocol or methods comprising use of a meta-HMM with sufficiently large footprint that heavy-tail resolution is strengthened at the end of self-transition regions.

48. An application of the SSA protocol or methods comprising use of HMMD extensions to modeling to capture length distribution details of the same state transitions, where HMMBD can be employed for HMM speed and HMMD modeling capability (where HMMBD is compatible with the other single-pass HMM algorithms, including Viterbi and EM via linear HMM implementation).

49. An application of the SSA protocol or methods comprising use of HMMD extensions to capture side-information. In the HMMD extension, length distribution side-information is introduced into the HMM table computation via a ratio of length probability cumulants. This also provides the basis for any side-information to similarly ‘mesh’ with the HMM table computation's column-by-column ‘argmax’ optimizations. The HMMD method developed, with its ratio of cumulants factoring, provides the mechanism whereby other side information can be incorporated by a similar local-statistics ratio of cumulants decomposition, including extrinsic genomic data (from BLAST hits on homologous genes or on EST data, for example), and use of SVM classification scoring on vectorized, HMM-derived, subsequences of likelihood ratios.

50. An application of the SSA protocol or methods comprising use of a generalized clique hidden Markov model (HMM) analysis process, where the observation sequence in the clique involves bulk, zonal, and positional HMM emission statistics, where those statistical representations are interpolated to highest order having sufficient statistical support given the training data. Where use of HMMD modeling as well, meta-HMMBD, provides the means for a position dependent emission model to be developed. Where this can be taken to be used as the means to have a ‘fuzzy’ footprint model, where not just position, but zonal statistics are isolated, extracted, and modeled. Also have optional use of gap and sequence-specific (hash) interpolated Markov models, in place of standard Markov models at fixed order, where it is beneficial to do so. One such application, a non-exhaustive list, involves use of gap-interpolated Markov models (gIMMs) to latch onto transcription factor binding site recognition which often have gapped motifs. Thus, have methods for meta-HMMBD comprising use of gIMMs and/or hash-interpolated Markov models (hIMMs) in the different bulk, zonal, and positional regions.

51. An application of the SSA protocol or methods comprising use of a bootstrap, ab initio, adaptive refinement (typically multiply iterated) approach to high-confidence HMM gene-structure predictions, followed by statistical learning based on those high-confidence predictions, with subsequent relaxation to lower-confidence predictions on a larger, trusted, training dataset. Once the intrinsic refinements stop improving, extrinsic information can be brought in to drive further rounds of adaptive refinement in the model. In use in full-genome decoding, can provide automated discovery of cis- and trans-regulatory motifs.

52. An application of the SSA protocol or methods comprising repetitive use of gene-structure methods in prior items listed, to first identify structure, then characterize newly defined zones. In gene-structure identification this is the basis for a growing ‘scaffolding’ of annotation from some central, well-characterized, coding region to nearby untranslated regions and out to nearby non-coding, but regulatory, regions.

53. An application of the SSA protocol or methods comprising use of clustering methods for knowledge discovery, where SVM clustering methods are used in the pMM/SVM and Martingale/SVM approaches, where instead of SVM classification we now perform SVM clustering on a collection of data. Thereby have method for clustering to perform structure (or motif) discovery on the positional and zonal statistical data resulting from each iteration in the discovery process. If use of pMM employed, then specific application of pMM/SVM methods enable clustering in the SVM setting (e.g., SVM-based clustering).

54. An application of the SSA protocol or methods comprising use tuning on the sizes and placement of bulk, zonal, and positional regions in models. Thereby establish joint HMM-based/hIMM-based gene-structure/motif-structure identification. Tuning the size of a zonal region, as a non-exhaustive example, could be the basis of a motif-netting procedure or a procedure to discover fixed-position structures.

55. An application of the SSA protocol or methods comprising multi-track HMM emissions, where a specific example is given in terms of genomic data with multiple gene annotations where those multiple annotations are written, predominantly, to two tracks (so only two track model implemented in code). The method simply generalizes the states and transitions to the two track annotation that results. What is established is an alt-splice structure identifier, and associated transcription factor binding site motif identifier.

56. An application of the SSA protocol or methods comprising distributed HMM processing (with Viterbi or Baum-Welch algorithms, for example) in single-pass table-processing, via segment-join tests. It is possible to linearize and distribute HMM computations by stitching together independently computed overlapping segments of dynamic programming table where their respective Viterbi paths come into agreement can be accomplished with minimal constraints, even though all segments but the first have improperly initialized first columns. The Viterbi most probable path calculation that guides its own segmentation rejoining can also be used to guide the Expectation/Maximization (EM) calculation, in the linear memory implementation. This leverages the Markov approximation of limited memory. By this means the computational time can be reduced by approximately the number of computational nodes in use.

57. An application of the SSA protocol or methods comprising use of an adaptive null-state binning for HMM with O(LN) or O(L). When O(LN) merged with Dist. HMM, have processing that is at speed the order of merely handling the data since data copy is O(L). Method might be able to obtain O(TN²)→O(TNn) via learned max-path evaluations to a given state, for example, where the max-path evaluation and the ‘n’ nearest to max transitions are learned and tested according to their max-ordering. If the max-ordering evaluations are consistent with their indicated ordering, further evaluations than the n saved are not pursued; otherwise a reset to a full column calculation is performed.

58. An application of the SSA protocol or methods comprising HMM analysis on 2D data that is converted to 1D data via point-rastered 1D sweep of 2D data.

59. An application of the SSA protocol or methods comprising HMM analysis on 2D data that is converted to 1D data via tile-rastered 1D sweep of 2D data, which could comprise parallel or holographic sequential data. An example of parallel data, a non-exhaustive list, is 2-D image tracking (non-rastered) such as with 24×24 pixel image tiles.

60. An application of the SSA protocol or methods where HMMD modeling is used on data strongly exhibiting non-geometric length profiles, such as for modulated device data in NTD experiments engineered for this ‘encoding’. This is a specific form of the stochastic carrier wave communication that occurs in natural settings (e.g., is as pervasive as 1/f noise).

61. An application of the SSA protocol or methods where HMMD-based stochastic carrier wave communications (encode/decode) are performed. The “stochastic carrier wave” approach can provide a hidden-carrier based communication, enabling security and making signal jamming much more difficult.

62. An application of the SSA protocol or methods where HMM template-match is done with meta-HMMBD variants and other feature extraction and modeling methods. In some cases, the meta-HMMBD approach may guide the selection/tuning of a faster template methods, such as Neural Net (NN) variants. Multiplicative update NN's, for example, can be used in real-time stock market analysis. In the template match methods, the signal is passed through each of the signal processing templates and scored. The stronger the template match, the stronger the likelihood that the signal examined is of the type indicated by that template. If the HMM-templates or NN-templates were for local sinusoidal wave packets at particular frequency, for example, the basis for wave-packet decompositions and Fourier transform (frequency) analysis could be recovered.

63. An application of the SSA protocol or methods where a Modified Adaboost algorithm is used for feature selection and data fusion.

64. An application of the SSA protocol or methods where SVM kernels are chosen to be complimentary to feature vector attributes, including feature vectors comprising probability vectors, or concatenations of such; or where the feature vectors are “Martingale vectors' such as found for HMM LLR evaluations that instead of summed (in log space) are ‘vectorized’ and presented as a SVM feature vector. If possible, the statistical construct (a discrete probability vector for feature vector, for example) should be paired with its natural kernel counterpart. In the case of discrete probability vectors, the natural measure of comparison, with unbiased statistics and no other information, is the symmetrized Kullback-Leibler Divergence, while for cases with more structure, the class of symmetrized Renyi divergences might provide natural kernels when symmetrized.

65. An application of the SSA protocol or methods with SVM classification learning: bag training, occurs for example, in bootstrap signal processing and model-learning. With bag training can drop common/deadzone data (the more weakly classified data), according to the SVM's confidence parameter on each classification, and arrive at a stable core, for more trusted learning in further learning iterations, for example.

66. An application of the SSA protocol or methods with distributed learning on SVMs that can be accomplished by breaking the training set into smaller chunks, running separate SVM processes on each of those chunks, and pooling the information that is ‘learned’, e.g., the support vectors (SVs) identified as well as nearby (in terms of confidence value) training data vectors and outliers. SV-Reduction is done by continued KKT processing designed to minimize the SV set. Pure SV-passing is known to fail, so more care in tuning/training/chunking of data, and in winnowing data in chunk learning (some non-SV must often be passed as well) is done.

67. An application of the SSA protocol or methods with SVM recognition of signal statistics phase transitions: classification-bias or clustering learning: mixed-bag training,with the nanopore transduction analysis we are concerned with observing changes in stationary statistics (associated with binding—for biosensing applications among other things). For this circumstance HMM feature extraction on a shifting window, with SVM clustering or SVM ‘jackknife’ classification, is used to identify transitions in stationary statistics. The clustering projects the decision hyperplane onto the sequential observations to identify the transition. The SVM jackknife classification assumes a transition and extracts feature vectors before and after that transition, associates them with before/after training data, and if a highly separable SVM training solution obtained (via accuracy on testing on training data), then a transition is identified.

68. An application of the SSA protocol or methods with stationary statistics locked loop (SSLL) signal processing analogous to PLL in standard EE, where the SSLL is enabled via real-time PRI capability. Have similar parallel methods for other standard EE methodologies in the SCW formalism. General power signal applications, via statistical learning, encompasses standard EE methodologies (the simpler, typically deterministic, static models and transforms (FFT, etc.), are encompassed in the more complex stationary models, learning could arrive at recognition of standard EE signals, if present, or more complex SCW signaling).

69. An application of the SSA protocol or methods with SVM clustering with multiple convergence results (minimally two) used prior to any re-label/re-train operation (minimum of two provides for line-segment field on conf)

70. An application of the SSA protocol or methods with SVM clustering with SWH multiclass SVM using label flipping, tuning, and possible multiple convergences

71. An application of the SSA protocol or methods for use in the discovery, characterization, and classification of localizable, approximately-stationary, statistical signal structures in stochastic sequential data, and changes between such structures, as outlined in FIGS. 20-23.

72. An application of the SSA protocol or methods where localized modulations are injected into the device generating the data being analyzed, thereby allowing ‘carrier references’ to be introduced that allow device state to be tracked and used in a feed-forward (open) control loop. This allows various forms of stabilization.

73. An application of the SSA protocol or methods where refinement on the protocol application is rolled into the overall device optimization & refinement design cycle, this helps to select which modulators are ‘good’.

74. An application of the SSA protocol or methods where the stages used in the CCC Protocol are shuffled around, and in some cases used internally to other stages as needed for optimal solution of whatever task (e.g., EVA/HMMD→tFSA processing in kinetic feature extraction, for example). The EVA-projected/HMMD processing, for example, offers a hands-off (minimal tuning) method for extracting the mean dwell times for various blockade states (the core kinetic information on the blockading molecule's channel interactions)

75. An application of the SSA protocol or methods where data structures, related data schemas, and databases are used to implement various tasks in the data acquisition, feature extraction, selection, calibration, classification and classification methods in the SSA methods and protocols in above features. Since the FSA, HMM, and SVM methods are machine learning methods that typically perform better the more data, there is a tendency to have a significant amount of data, thus a significant database need or complication, in exchange for a more accurate performance with the machine learning method.

76. An application of the SSA protocol or methods where real time data management constructs, device control, and local data storage, for the data acquisition, feature extraction, selection, calibration, classification and classification methods in the SSA methods, data management constructs, and protocols in above.

77. An application of the SSA protocol or methods where signal processing protocols, data structures, and data schemas related to known data injection scenarios or system modulation scenarios can be used in some implementations. The designed modulation/data-injection thus evokes a more informative, or independently informative, observation capability. Real-time, possibly input-modulation triggered, observations can be performed and operation of machine learning methods with their data management constructs established accordingly.

78. An application of the SSA protocol or methods where local data storage structures, data schemas, and data transfer protocols to enable the transfer of data to a data warehouse repository. In networked research activity, access, and contribution to, client service-oriented data repository usage.

79. An application of the SSA protocol or methods where any SSA or CCC Database is established with a hub-and-spoke arrangement—e.g., central data control

80. An application of the SSA protocol or methods where data visualization tools, data mining tools, and data analysis interfaces to the myriad of signal processing methods indicated in above. Web-interface tools also provide analysis of client data in a data warehouse repository, as well as other data that might be shared (example data, for example), accessible through a WWW-based directory.

81. An application of the SSA protocol or methods (FIGS. 20-23), that can be coded, implemented, or imbedded on a computer, microprocessor, or integrated circuit, where the HMMBD improvements to the signal processing alone will allow for reduced signal processing overhead, thereby reducing power usage. This directly impacts satellite communications where a minimal power footprint is critical, and cell phone construction, where a low-power footprint allows for smaller cell phones, or cell phones with smaller battery requirements, or cell phones with less expensive power system methodologies. We, thus, claim, significant utility of the SSA Protocol and Algorithms for systems performing signal processing where power constraints are critical, or where signal processing efficiency is critical.

82. An application of the SSA protocol or methods (FIGS. 20-23), that can be coded, implemented, or imbedded on a computer, microprocessor, or integrated circuit, that will allow for improved real-time signal processing. The SSA Protocol, and Algorithms, signal processing process and/or system, depending on specific implementation, permits much more accurate signal resolution and signal de-noising than current methods. This impacts real-time operational systems such as voice recognition hardware implementations, over-the-horizon radar detection systems, sonar detection systems, and receiver systems for streamlining low-power digital signal broadcasts (e.g., such an enhancement improves receiver capabilities on various high-definition radio and TV broadcasts).

83. An application of the SSA protocol or methods involving an improved signal resolution process that can be coded, implemented, or imbedded on a computer, microprocessor, or integrated circuit, that will allow for improved batch (off-line) signal resolution. The SSA Protocol and Algorithms signal processing process operating on a computer, network of computers, or supercomputer, allows for significantly improved gene-structure resolution in genomic data, biological channel current characterization, and extraction of binding/conformational kinetic feature extraction involving molecular interactions observed by nanopore detector devices, to list a non-exhaustive set of batch processing scenarios.

84. An application of the SSA protocol or methods involving an improved signal resolution process that can be coded, implemented, or imbedded on a computer, microprocessor, or integrated circuit, that will allow for improved scientific and engineering signal processing endeavors in general, where there is any data analysis that can be related to a sequence of measurements or observations (e.g., 1-D data). The SSA Protocol and Algorithms' signal processing process and/or system provides a means for improved signal resolution and speed of signal processing of 1-D data. This includes instances of 2-D and higher order dimensional data, however, such as 2-D images, where the information can be reduced to a 1-D sequence of measurements via a rastering process, or via some other manipulation, as has been done with HMM methods in the past. Thus, multivariate and higher-dimensional data analysis can also be directly enhanced via the SSA Protocol and Algorithms' signal processing process and/or system that is coded, implemented, or imbedded on a computer, microprocessor, or integrated circuit.

85. An application of the SSA protocol or methods involving processes or systems for data analysis, data mining, or pattern recognition or any other information manipulation or knowledge discovery method that make use of the SSA Protocol and Algorithms when encoded, implemented, or imbedded on a computer, microprocessor, or integrated circuit.

The foregoing description of the preferred embodiment of the present invention has been made with some specificity without implying that all features described have to be used in connection with practicing the present invention. It will also be understood that some of the features may be used without the corresponding use of other features. For example, S-layer buffer, PEG-shift buffer, direct-probe, cleaved-substrate-probe, . . . have been described in the preferred embodiment but are not required in all practical applications of the present invention. Further, it will be appreciated that the present invention may be modified by the substitution of one element for that which has been described in connection with the preferred embodiment. For example, the channel-modulator material covalently attached to a molecule of interest has been mentioned with some specificity, and its interaction with the channel via a non-covalent binding interactions. The use of a cleavable (UV or enzyme, for example) bonding attachment between channel-modulator and, in this example, an interaction moiety, is also possible, and the choice of the material being bonded is also subject to substitution or to the use of additional bonding materials, as desired. Also, the size of the pores has been described as ideally relating to the modulator molecule (or molecular complex) under consideration to provide a signal which tracks the single-molecule transient binding kinetics of the modulator-molecule's channel interactions. Part of the strong signal coherence used in the method is because a single-molecule is truly interacting with the channel, thereby producing a coherent stationary statistics signal according to that molecules interaction with the channel (where translocation is prevented by choice of modulator). Multiple-analyte translocation methods, or polymer translocation methods do not have (or rapidly lose) such single-molecule statistical coherence. The channel-modulators are also typically designed to have extended duration blockade signals, as the molecule(s) “rattle around” in the pore. It may be possible to create this rattling around, or extended-duration signal, in other ways, such as by providing a different electromechanical signal on the sensor to drive a similar ‘coherent rattling’ electrical signal while the molecule is within (or even passing through) the pore. As another possible variation, it is possible that the sensor can allow the molecule(s) or at least some of the molecules under consideration, to pass through the pore instead of being captured and measured before being discharged without passing through the pore. Additionally, the present invention has been described as a single pore filter, while it may be possible to have a plurality of pores to process multiple molecules through the multiple pores. Some, but not all, of the possible alternatives and substitutions have been suggested in the foregoing text, but others will be apparent to those who work in the relevant art. Some of the features of the present invention have also been identified, directly or inferentially, as optional, but those who work in the art will recognize that other elements are optional, and the advantages of portions of the present invention can be obtained without the corresponding use of other features, even though those other features have also been described in this document.

The present invention can be used to detect various kinds of molecules, and molecules of varying sizes. For example, DNA can be analyzed using the system and method the present invention, but this system and method are not limited to analyzing DNA molecules. The present invention has also been discussed in the context of using one or more specific carrier molecules, but obviously, other carrier molecules can be used in the present system and method to advantage without departing from the spirit of the present invention.

According, those skilled in the art will recognize that the preferred embodiment of the present invention which has been described with some particularity in the foregoing material is merely illustrative of the principles of the present invention and is not intended in limitation of the present invention which is defined solely by the claims which follow. Also, it will be understood that many modifications and adaptation of the present invention are possible without departing from the sprit of the present invention. Those skilled in the art will also recognize that the kit described in the present description and the material and statistical techniques for identifying patterns are representative of tools which can be used to advantage in analyzing the data and are not required for practicing the present invention.

Having thus described the invention, what is claimed is:

1. A device for identifying at least one molecule, the device comprising two chambers of buffer separated by a membrane over an aperture having at least one nanometer-scale nanopore channel in the membrane, with an applied potential applied between the two chambers, a single blockade molecule that enters the nanopore channel but does not pass immediately therethrough, remaining in the nanopore channel for a period of time and modulating the nanopore channel, a sensor generating electrical signals associated with the blockading molecule and at least one processor using an algorithm for analyzing the electrical signal to characterize the blockade molecule.

2. The device according to claim 1, wherein the membrane includes a plurality of nanopore-scale nanopore channels.

3. The device according to claim 1 further including a system to externally excite the nanopore-scale nanopore channel.

4. The device according to claim 1 further including a sensor for identifying a binding event in the blockade molecule.

5. The device according to claim 2 further including a selector to read one nanopore channel at a selected time.

6. The device, according to claim 1 further including signal processing calibration protocols, data structures, and data schemas for reference molecules.

7. A method for analysis of at least one molecule comprising the steps of:
Positioning a membrane with at least one nanopore channel opening adjacent a solution containing a molecule to be analyzed, with size of transducer molecule and channel chosen such that channel inner-diameter and blockading-molecular width are comparable, such that the molecule to be analyzed has some portion interacting within the channel for an extended period;
Establishing an ionic current flow through that nanopore channel;
Capturing from the solution, within the nanopore channel, at least one molecular portion to be identified;
Introducing at least one bifunctional transduction molecule into the solution, said transduction molecule having one end which can be captured in the channel and modulate the channel current while rattling around in the channel for an extended period of time, while the other, extra-channel-exposed end has information for event detection.
Using electrophoresis to draw at least one bifunctional transducer molecule into the nanopore channel to modulate the ionic current flow through the nanopore channel;
Generating an electrical signal of the ionic current flow based on the state of the transducer molecule captured by the nanopore channel;
Analyzing the electrical signal using computational methods and pattern recognition to characterize the molecule; and
Releasing the captured molecule and resetting the nanopore channel for capture of another molecule.

8. The method according to claim 7 wherein the method is repeated to identify different types of molecules in the solution to determine a relationship between the different types of molecules.

9. The method according to claim 7 further including introducing a biosensing sensitivity gain into the system using a molecular-capture matrix comprising at least one of an antibody-capture matrix, an aptamer-capture matrix, and a molecularly-imprinted polymer capture matrix.

10. The method according to claim 7 further including introducing a biosensing sensitivity gain into the system using an enzyme acting on a substrate.

11. The method according to claim 7 further including introducing a biosensing sensitivity gain using an enzyme turn-over rate and real-time signal tracking.

12. The method, according to claim 7, where the membrane includes multiple channels and the method includes processing signals from the multiple channels.

13. The method according to claim 7 further including producing standard biochemistry sample-analysis gel-analogs from observations with buffer-shift population measurements.

14. The method according to claim 7 further including using orientation selection for direct antibody utilization as transducer and binding moiety.

15. The method according to claim 7 further including establishing a chemical computation device with parallelized, ‘chemical’ computation loaded with choice of buffer and changes in that buffer, and sampling the output for CCC analyte recognition and SSA program/data processing.

16. The method according to claim 7 further including the step of introducing Y-shaped nucleic acid molecules into the solution for direct, annealed to modulator, reporting on SNPs and single-point mutations.

17. The method, according to claim 7 further including the step of transducing a DNA enzyme signal by channel current observation involving at least one of direct observation of enzyme-channel interactions and indirect transduction of enzyme state when linked to a channel modulator to establish a DNA sequencing capability.

18. The method according to claim 7, further including using nanopore transduction detection for direct channel-interaction nanopore detector-to-target assays and in combination with indirect channel-interaction NTD-to-target assays via transducer molecule intervening between channel and target.

19. The method, according to claim 7 further including performing active multichannel signal processing with HMMD heavy-tail encoding modulation.

20. A method of identifying a molecule by analyzing electrical signals from a nanopore transducer blockade molecule that is producing stochastic sequential data by using training data, the method comprising the steps of:
Identifying signal regions in the stochastic sequential data using at least one of HMM-based methods and FSA-based methods;
Extracting feature vectors from the identified signal regions using at least one of a generalized clique HMM analysis, gap-interpolated and hash-interpolated Markov models, and HMM-with-binned-duration models;
Classifying the extracted feature vectors using training data and at least one of SVM-based methods and HMM-based methods to identify the molecule; and
Clustering the extracted features in instances where there is no training data to reference, using at least one of SVM-based-methods, and clustering methods including kernel k-means.

21. The method according to claim 20 further including using a holistic signal-acquisition approach for extracting features.

22. The method according to claim 20 further including the steps of coding an adaptive self-tuning explicit hidden Markov model with Duration process is coded on a data processing apparatus and accomplishing HMMD computations like the standard HMM computations.

23. The method according to claim 20 further including the step of using at least one of an HMM with pMM/SVM sensors, an HMM with Martingale/SVM sensors, an HMMBD with pMM/SVM sensors, and an HMMBD with Martingale/SVM sensors.

24. The method according to claim 20 further including the step of using at least one of an HMM with EVA, an HMM with Emission Inversion, an HMMBD with EVA, and an HMMBD with Emission Inversion.

25. The method according to claim 20 further including the step of using a meta-HMM with a footprint sufficient to strengthen contrast resolution at the start of self-transition regions and heavy-tail resolution at the end of self-transition regions.

26. The method according to claim 20 further including the step of using HMMD extensions to capture side-information.

27. The method according to claim 20 further including the step of using multi-track HMM emissions.

28. The method according to claim 20 further including the step of performing distributed HMM processing in single-pass table-processing, via segment-join tests.

29. The method according to claim 20 further including the step of using HMMD modeling on data exhibiting non-geometric length profiles.

30. The method according to claim 20 further including the step of performing HMMD-based stochastic carrier wave communications.

31. The method according to claim 20 further including the step of choosing SVM kernels complimentary to feature vector attributes, including feature vectors comprising probability vectors and including Martingale vectors.

32. The method according to claim 20 further including the step of using SVM clustering with at least two convergence results prior to re-label/re-train operations using the convergence results.

33. The method according to claim 20 further including the step of using SVM clustering with multiclass SVM using at least one of label flipping, tuning, and multiple convergences.

34. The method according to claim 20 further including the step of using at least one of data structures, related data schemas, and databases to implement at least some of the tasks including data acquisition, feature extraction, selection, calibration, classification and classification methods using the SSA methods and protocols.

35. The method according to claim 20 further including the step of using the SSA Protocol on a data processing apparatus for improving real-time signal processing.

36. The method according to claim 20 further including the step of using an SSA Protocol and Algorithms' signal processing process.
